(19) United States
(12) Patent Application Publication
(10) Pub. No.: US 2026/0222756 A1
(43) Pub. Date: Jul. 30, 2026

(54) LOCALIZED AUDIO

(71) Applicant: Apple Inc., Cupertino, CA (US)

(72) Inventors: Peter W. MASH, Half Moon Bay, CA (US); Hanns W. TAPPEINER, Orinda, CA (US); Paul R. ALURI, Mountain View, CA (US)

(21) Appl. No.: 19/442,761

(22) Filed: Jan. 7, 2026

Related U.S. Application Data
(60) Provisional application No. 63/751,039, filed on Jan. 29, 2025.
(60) Provisional application No. 63/819,319, filed on Jun. 6, 2025.

(51) Int. Cl. H04S 7/00; G06F 3/16; H04S 3/00

(52) U.S. Cl. CPC H04S 7/303; G06F 3/165; H04S 3/008; H04S 7/307; H04S 2400/01; H04S 2400/11

(57) ABSTRACT

The present disclosure generally relates to using different devices. Some techniques are for altering output of audio content based on initiating device in accordance with some embodiments. Other techniques are for altering output of audio content based on positioning of devices in accordance with some embodiments. Other techniques are for remotely generating a depth map in accordance with some embodiments. Other techniques are for re-creating an image in accordance with some embodiments.

### CROSS-REFERENCE TO RELATED APPLICATIONS

This application claims priority to U.S. Provisional Patent Application Ser. No. 63/751,039, entitled “LOCALIZED AUDIO” filed Jan. 29, 2025, and U.S. Provisional Patent Application Ser. No. 63/819,319, entitled “LOCALIZED AUDIO,” filed Jun. 6, 2025. The content of these applications are hereby incorporated by reference in their entirety.

### BACKGROUND

Homes are becoming increasingly populated with electronic devices. For example, home theater rooms are often made up of multiple devices including a set of speakers, a TV, and a remote control. Optimizing an experience (e.g., audio and/or visual playback) made up of such devices is difficult and can be tedious as additional devices are added. Accordingly, there is a need to improve techniques for using different devices.

### SUMMARY

Current techniques for using different devices are generally ineffective and/or inefficient. For example, some techniques require users to individually manipulate each speaker of a set of speakers when changing an aspect of an environment (e.g., movement of a user or furniture) or a speaker setup (e.g., adding or moving of a speaker). This disclosure provides more effective and/or efficient techniques for using different devices using examples of a resident device adjusting a set of external devices (e.g., speakers). It should be recognized that other types of electronic devices can be used with techniques described herein. For example, a personal device can facilitate the altering of the output of audio content by adjusting the set of external devices using techniques described herein. In addition, techniques optionally complement or replace other techniques for using different devices.

Some techniques are described herein for configuring content based on initiating device. For example, a resident device can adjust audio content output by multiple output devices depending on which device within an environment initiated the playback of the audio content. Other techniques are described herein for using different devices based on adding a new output device within an area. For example, a resident device can adjust audio content output by one or more output devices based on positioning of the one or more output devices and the new output device.

In some embodiments, a method that is performed at a resident device is described. In some embodiments, the method comprises: receiving, from a respective device, an input corresponding to a request to initiate playback of audio content; and in response to receiving the input corresponding to the request to initiate playback of the audio content: in accordance with a determination that a first set of one or more criteria is satisfied, wherein the first set of one or more criteria includes a criterion that is satisfied when the respective device is a first device, outputting, via multiple output devices, the audio content in a first manner; and in accordance with a determination that a second set of one or more criteria is satisfied, wherein the second set of one or more criteria includes a criterion that is satisfied when the respective device is a second device, outputting, via the multiple output devices, the audio content in a second manner different from the first manner, wherein the second device is different from the first device, and wherein the second set of one or more criteria is different from the first set of one or more criteria.

In some embodiments, a non-transitory computer-readable storage medium storing one or more programs configured to be executed by one or more processors of a resident device is described. In some embodiments, the one or more programs includes instructions for: receiving, from a respective device, an input corresponding to a request to initiate playback of audio content; and in response to receiving the input corresponding to the request to initiate playback of the audio content: in accordance with a determination that a first set of one or more criteria is satisfied, wherein the first set of one or more criteria includes a criterion that is satisfied when the respective device is a first device, outputting, via multiple output devices, the audio content in a first manner; and in accordance with a determination that a second set of one or more criteria is satisfied, wherein the second set of one or more criteria includes a criterion that is satisfied when the respective device is a second device, outputting, via the multiple output devices, the audio content in a second manner different from the first manner, wherein the second device is different from the first device, and wherein the second set of one or more criteria is different from the first set of one or more criteria.

In some embodiments, a transitory computer-readable storage medium storing one or more programs configured to be executed by one or more processors of a resident device is described. In some embodiments, the one or more programs includes instructions for: receiving, from a respective device, an input corresponding to a request to initiate playback of audio content; and in response to receiving the input corresponding to the request to initiate playback of the audio content: in accordance with a determination that a first set of one or more criteria is satisfied, wherein the first set of one or more criteria includes a criterion that is satisfied when the respective device is a first device, outputting, via multiple output devices, the audio content in a first manner; and in accordance with a determination that a second set of one or more criteria is satisfied, wherein the second set of one or more criteria includes a criterion that is satisfied when the respective device is a second device, outputting, via the multiple output devices, the audio content in a second manner different from the first manner, wherein the second device is different from the first device, and wherein the second set of one or more criteria is different from the first set of one or more criteria.

In some embodiments, a resident device is described. In some embodiments, the resident device comprises one or more processors and memory storing one or more programs configured to be executed by the one or more processors. In some embodiments, the one or more programs includes instructions for: receiving, from a respective device, an input corresponding to a request to initiate playback of audio content; and in response to receiving the input corresponding to the request to initiate playback of the audio content: in accordance with a determination that a first set of one or more criteria is satisfied, wherein the first set of one or more criteria includes a criterion that is satisfied when the respective device is a first device, outputting, via multiple output devices, the audio content in a first manner; and in accordance with a determination that a second set of one or more criteria is satisfied, wherein the second set of one or more criteria includes a criterion that is satisfied when the respective device is a second device, outputting, via the multiple output devices, the audio content in a second manner different from the first manner, wherein the second device is different from the first device, and wherein the second set of one or more criteria is different from the first set of one or more criteria.

In some embodiments, a resident device is described. In some embodiments, the resident device comprises means for performing each of the following steps: receiving, from a respective device, an input corresponding to a request to initiate playback of audio content; and in response to receiving the input corresponding to the request to initiate playback of the audio content: in accordance with a determination that a first set of one or more criteria is satisfied, wherein the first set of one or more criteria includes a criterion that is satisfied when the respective device is a first device, outputting, via multiple output devices, the audio content in a first manner; and in accordance with a determination that a second set of one or more criteria is satisfied, wherein the second set of one or more criteria includes a criterion that is satisfied when the respective device is a second device, outputting, via the multiple output devices, the audio content in a second manner different from the first manner, wherein the second device is different from the first device, and wherein the second set of one or more criteria is different from the first set of one or more criteria.

In some embodiments, a computer program product is described. In some embodiments, the computer program product comprises one or more programs configured to be executed by one or more processors of a resident device. In some embodiments, the one or more programs include instructions for: receiving, from a respective device, an input corresponding to a request to initiate playback of audio content; and in response to receiving the input corresponding to the request to initiate playback of the audio content: in accordance with a determination that a first set of one or more criteria is satisfied, wherein the first set of one or more criteria includes a criterion that is satisfied when the respective device is a first device, outputting, via multiple output devices, the audio content in a first manner; and in accordance with a determination that a second set of one or more criteria is satisfied, wherein the second set of one or more criteria includes a criterion that is satisfied when the respective device is a second device, outputting, via the multiple output devices, the audio content in a second manner different from the first manner, wherein the second device is different from the first device, and wherein the second set of one or more criteria is different from the first set of one or more criteria.

In some embodiments, a method that is performed at a resident device is described. In some embodiments, the method comprises: outputting, via one or more devices, audio content in a first manner within an area; while outputting the audio content in the first manner, detecting a new device in the area; and in response to detecting the new device in the area: in accordance with a determination that a first set of one or more criteria is satisfied, wherein the first set of one or more criteria includes a criterion that is satisfied based on a position of the one or more devices and a position of the new device, outputting the audio content in a second manner different from the first manner; and in accordance with a determination that a second set of one or more criteria is satisfied, wherein the second set of one or more criteria includes a criterion that is satisfied based on the position of the one or more devices and the position of the new device, outputting the audio content in a third manner different from the second manner, wherein the second set of one or more criteria is different from the first set of one or more criteria.

In some embodiments, a non-transitory computer-readable storage medium storing one or more programs configured to be executed by one or more processors of a resident device is described. In some embodiments, the one or more programs includes instructions for: outputting, via one or more devices, audio content in a first manner within an area; while outputting the audio content in the first manner, detecting a new device in the area; and in response to detecting the new device in the area: in accordance with a determination that a first set of one or more criteria is satisfied, wherein the first set of one or more criteria includes a criterion that is satisfied based on a position of the one or more devices and a position of the new device, outputting the audio content in a second manner different from the first manner; and in accordance with a determination that a second set of one or more criteria is satisfied, wherein the second set of one or more criteria includes a criterion that is satisfied based on the position of the one or more devices and the position of the new device, outputting the audio content in a third manner different from the second manner, wherein the second set of one or more criteria is different from the first set of one or more criteria.

In some embodiments, a transitory computer-readable storage medium storing one or more programs configured to be executed by one or more processors of a resident device is described. In some embodiments, the one or more programs includes instructions for: outputting, via one or more devices, audio content in a first manner within an area; while outputting the audio content in the first manner, detecting a new device in the area; and in response to detecting the new device in the area: in accordance with a determination that a first set of one or more criteria is satisfied, wherein the first set of one or more criteria includes a criterion that is satisfied based on a position of the one or more devices and a position of the new device, outputting the audio content in a second manner different from the first manner; and in accordance with a determination that a second set of one or more criteria is satisfied, wherein the second set of one or more criteria includes a criterion that is satisfied based on the position of the one or more devices and the position of the new device, outputting the audio content in a third manner different from the second manner, wherein the second set of one or more criteria is different from the first set of one or more criteria.

In some embodiments, a resident device is described. In some embodiments, the resident device comprises one or more processors and memory storing one or more programs configured to be executed by the one or more processors. In some embodiments, the one or more programs includes instructions for: outputting, via one or more devices, audio content in a first manner within an area; while outputting the audio content in the first manner, detecting a new device in the area; and in response to detecting the new device in the area: in accordance with a determination that a first set of one or more criteria is satisfied, wherein the first set of one or more criteria includes a criterion that is satisfied based on a position of the one or more devices and a position of the new device, outputting the audio content in a second manner different from the first manner; and in accordance with a determination that a second set of one or more criteria is satisfied, wherein the second set of one or more criteria includes a criterion that is satisfied based on the position of the one or more devices and the position of the new device, outputting the audio content in a third manner different from the second manner, wherein the second set of one or more criteria is different from the first set of one or more criteria.

In some embodiments, a resident device is described. In some embodiments, the resident device comprises means for performing each of the following steps: outputting, via one or more devices, audio content in a first manner within an area; while outputting the audio content in the first manner, detecting a new device in the area; and in response to detecting the new device in the area: in accordance with a determination that a first set of one or more criteria is satisfied, wherein the first set of one or more criteria includes a criterion that is satisfied based on a position of the one or more devices and a position of the new device, outputting the audio content in a second manner different from the first manner; and in accordance with a determination that a second set of one or more criteria is satisfied, wherein the second set of one or more criteria includes a criterion that is satisfied based on the position of the one or more devices and the position of the new device, outputting the audio content in a third manner different from the second manner, wherein the second set of one or more criteria is different from the first set of one or more criteria.

In some embodiments, a computer program product is described. In some embodiments, the computer program product comprises one or more programs configured to be executed by one or more processors of a resident device. In some embodiments, the one or more programs include instructions for: outputting, via one or more devices, audio content in a first manner within an area; while outputting the audio content in the first manner, detecting a new device in the area; and in response to detecting the new device in the area: in accordance with a determination that a first set of one or more criteria is satisfied, wherein the first set of one or more criteria includes a criterion that is satisfied based on a position of the one or more devices and a position of the new device, outputting the audio content in a second manner different from the first manner; and in accordance with a determination that a second set of one or more criteria is satisfied, wherein the second set of one or more criteria includes a criterion that is satisfied based on the position of the one or more devices and the position of the new device, outputting the audio content in a third manner different from the second manner, wherein the second set of one or more criteria is different from the first set of one or more criteria.

In some embodiments, a method that is performed at a first device that is in communication with one or more input components is described. In some embodiments, the method comprises: capturing, via the one or more input components, an image of an environment; in response to capturing the image of the environment: processing the image to generate a first representation of the environment; and sending, to a second device separate from the first device, the first representation of the environment; after sending the first representation of the environment, receiving, from the second device, a second representation of the environment different from the first representation of the environment; and in response to receiving the second representation of the environment, performing, based on the second representation of the environment, one of more operations.

In some embodiments, a non-transitory computer-readable storage medium storing one or more programs configured to be executed by one or more processors of a first device that is in communication with one or more input components is described. In some embodiments, the one or more programs includes instructions for: capturing, via the one or more input components, an image of an environment; in response to capturing the image of the environment: processing the image to generate a first representation of the environment; and sending, to a second device separate from the first device, the first representation of the environment; after sending the first representation of the environment, receiving, from the second device, a second representation of the environment different from the first representation of the environment; and in response to receiving the second representation of the environment, performing, based on the second representation of the environment, one of more operations.

In some embodiments, a transitory computer-readable storage medium storing one or more programs configured to be executed by one or more processors of a first device that is in communication with one or more input components is described. In some embodiments, the one or more programs includes instructions for: capturing, via the one or more input components, an image of an environment; in response to capturing the image of the environment: processing the image to generate a first representation of the environment; and sending, to a second device separate from the first device, the first representation of the environment; after sending the first representation of the environment, receiving, from the second device, a second representation of the environment different from the first representation of the environment; and in response to receiving the second representation of the environment, performing, based on the second representation of the environment, one of more operations.

In some embodiments, a first device configured to communicate with one or more input components is described. In some embodiments, the first device comprises one or more processors and memory storing one or more programs configured to be executed by the one or more processors. In some embodiments, the one or more programs includes instructions for: capturing, via the one or more input components, an image of an environment; in response to capturing the image of the environment: processing the image to generate a first representation of the environment; and sending, to a second device separate from the first device, the first representation of the environment; after sending the first representation of the environment, receiving, from the second device, a second representation of the environment different from the first representation of the environment; and in response to receiving the second representation of the environment, performing, based on the second representation of the environment, one of more operations.

In some embodiments, a first device configured to communicate with one or more input components is described. In some embodiments, the first device comprises means for performing each of the following steps: capturing, via the one or more input components, an image of an environment; in response to capturing the image of the environment: processing the image to generate a first representation of the environment; and sending, to a second device separate from the first device, the first representation of the environment; after sending the first representation of the environment, receiving, from the second device, a second representation of the environment different from the first representation of the environment; and in response to receiving the second representation of the environment, performing, based on the second representation of the environment, one of more operations.

In some embodiments, a computer program product is described. In some embodiments, the computer program product comprises one or more programs configured to be executed by one or more processors of a first device that is in communication with one or more input components. In some embodiments, the one or more programs include instructions for: capturing, via the one or more input components, an image of an environment; in response to capturing the image of the environment: processing the image to generate a first representation of the environment; and sending, to a second device separate from the first device, the first representation of the environment; after sending the first representation of the environment, receiving, from the second device, a second representation of the environment different from the first representation of the environment; and in response to receiving the second representation of the environment, performing, based on the second representation of the environment, one of more operations.

In some embodiments, a method that is performed at a first device is described. In some embodiments, the method comprises: receiving, from a second device separate from the first device, a first representation of an environment; in response to receiving the first representation of the environment: generating, based on the first representation of the environment, an image of the environment; and generating, based on the image of the environment, a depth map of the environment; and after generating the depth map of the environment, sending, to one or more devices, the depth map of the environment.

In some embodiments, a non-transitory computer-readable storage medium storing one or more programs configured to be executed by one or more processors of a first device is described. In some embodiments, the one or more programs includes instructions for: receiving, from a second device separate from the first device, a first representation of an environment; in response to receiving the first representation of the environment: generating, based on the first representation of the environment, an image of the environment; and generating, based on the image of the environment, a depth map of the environment; and after generating the depth map of the environment, sending, to one or more devices, the depth map of the environment.

In some embodiments, a transitory computer-readable storage medium storing one or more programs configured to be executed by one or more processors of a first device is described. In some embodiments, the one or more programs includes instructions for: receiving, from a second device separate from the first device, a first representation of an environment; in response to receiving the first representation of the environment: generating, based on the first representation of the environment, an image of the environment; and generating, based on the image of the environment, a depth map of the environment; and after generating the depth map of the environment, sending, to one or more devices, the depth map of the environment.

In some embodiments, a first device is described. In some embodiments, the first device comprises one or more processors and memory storing one or more programs configured to be executed by the one or more processors. In some embodiments, the one or more programs includes instructions for: receiving, from a second device separate from the first device, a first representation of an environment; in response to receiving the first representation of the environment: generating, based on the first representation of the environment, an image of the environment; and generating, based on the image of the environment, a depth map of the environment; and after generating the depth map of the environment, sending, to one or more devices, the depth map of the environment.

In some embodiments, a first device is described. In some embodiments, the first device comprises means for performing each of the following steps: receiving, from a second device separate from the first device, a first representation of an environment; in response to receiving the first representation of the environment: generating, based on the first representation of the environment, an image of the environment; and generating, based on the image of the environment, a depth map of the environment; and after generating the depth map of the environment, sending, to one or more devices, the depth map of the environment.

In some embodiments, a computer program product is described. In some embodiments, the computer program product comprises one or more programs configured to be executed by one or more processors of a first device. In some embodiments, the one or more programs include instructions for: receiving, from a second device separate from the first device, a first representation of an environment; in response to receiving the first representation of the environment: generating, based on the first representation of the environment, an image of the environment; and generating, based on the image of the environment, a depth map of the environment; and after generating the depth map of the environment, sending, to one or more devices, the depth map of the environment.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1A is a block diagram illustrating a compute system in accordance with some embodiments.

FIGS. 1B-1G illustrate the use of Application Programming Interfaces (APIs) to perform operations in accordance with some embodiments.

FIG. 2 is a block diagram illustrating a device with interconnected subsystems in accordance with some embodiments.

FIGS. 3A-3J illustrate exemplary user interfaces for altering audio content based on activity within an environment in accordance with some embodiments.

FIG. 4 is a flow diagram illustrating a process for altering output of audio content based on initiating device in accordance with some embodiments.

FIG. 5 is a flow diagram illustrating a process for altering output of audio content based on positioning of devices in accordance with some embodiments.

FIG. 6 is a swim-lane diagram of a process for performing an operation based on a generated depth map without requiring an image of an environment in accordance with some embodiments.

FIGS. 7A-7D illustrate different representations of an environment in accordance with some embodiments.

FIG. 8 is a flow diagram illustrating a process for remotely generating a depth map in accordance with some embodiments.

FIG. 9 is a flow diagram illustrating a process for re-creating an image in accordance with some embodiments.

### DETAILED DESCRIPTION

The following description sets forth exemplary processes, parameters, and the like. It should be recognized, however, that such description is not intended as a limitation on the scope of the present disclosure but is instead provided as a description of exemplary embodiments.

Processes described herein can include one or more steps that are contingent upon one or more conditions being satisfied. It should be understood that a process can occur over multiple iterations of the same process with different steps of the process being satisfied in different iterations. For example, if a process requires performing a first step upon a determination that a set of one or more criteria is met and a second step upon a determination that the set of one or more criteria is not met, a person of ordinary skill in the art would appreciate that the steps of the process are repeated until both conditions, in no particular order, are satisfied. Thus, a process described with steps that are contingent upon a condition being satisfied can be rewritten as a process that is repeated until each of the conditions described in the process are satisfied. This, however, is not required of system or computer readable medium claims where the system or computer readable medium claims include instructions for performing one or more steps that are contingent upon one or more conditions being satisfied. Because the instructions for the system or computer readable medium claims are stored in one or more processors and/or at one or more memory locations, the system or computer readable medium claims include logic that can determine whether the one or more conditions have been satisfied without explicitly repeating steps of a process until all of the conditions upon which steps in the process are contingent have been satisfied. A person having ordinary skill in the art would also understand that, similar to a process with contingent steps, a system or computer readable storage medium can repeat the steps of a process as many times as needed to ensure that all of the contingent steps have been performed.

Although the following description uses terms “first,” “second,” etc. to describe various elements, these elements should not be limited by the terms unless explicitly stated with an order and/or that they are separate and/or different. In some embodiments, these terms are used to distinguish one element from another. For example, a first subsystem could be termed a second subsystem, and, similarly, a second subsystem device or a subsystem device could be termed a first subsystem device, without departing from the scope of the various described embodiments. In some embodiments, the first subsystem and the second subsystem are two separate references to the same subsystem. In some embodiments, the first subsystem and the second subsystem are both subsystems, but they are not the same subsystem or the same type of subsystem.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when,” “upon,” “in response to determining,” “in response to detecting,” or “in accordance with a determination that” depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” or “in accordance with a determination that [the stated condition or event]” depending on the context.

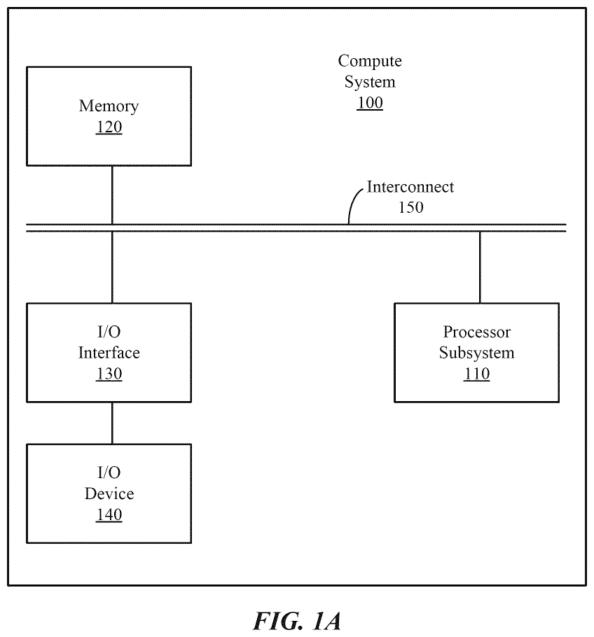

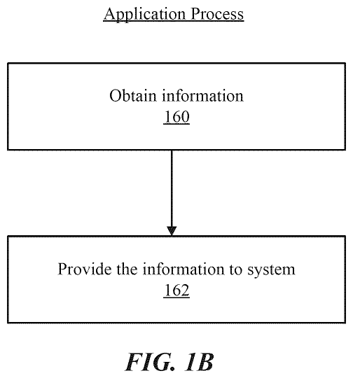

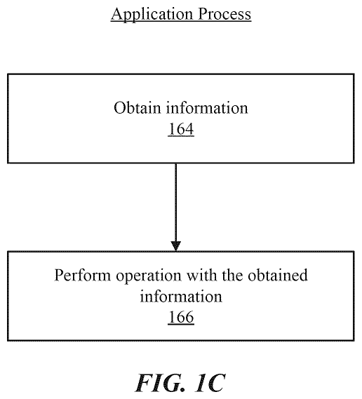

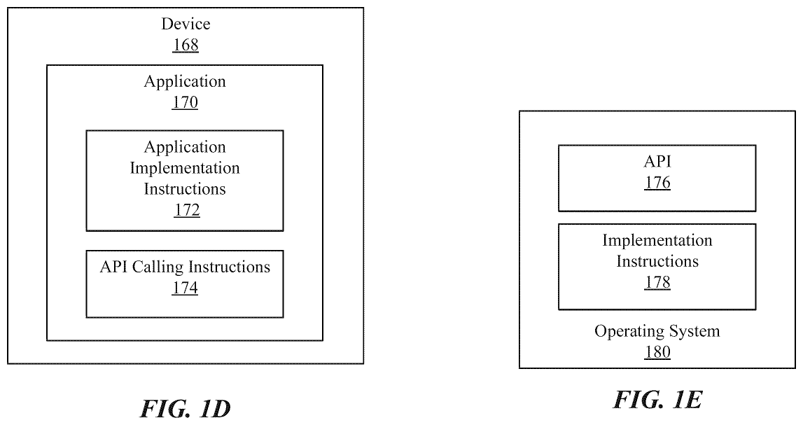

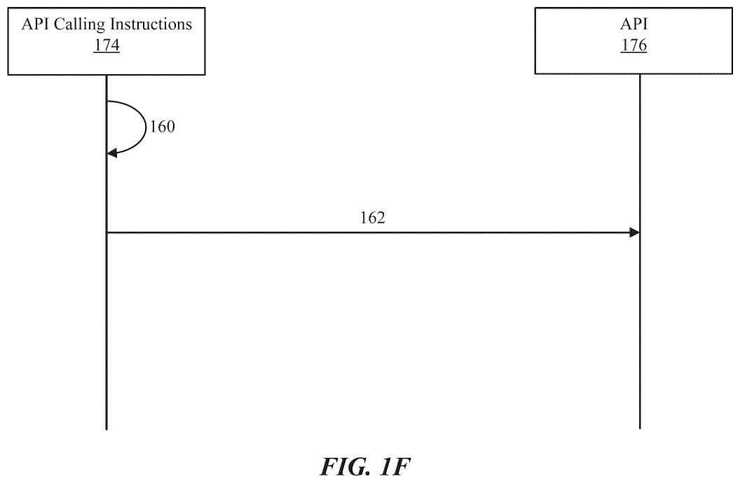

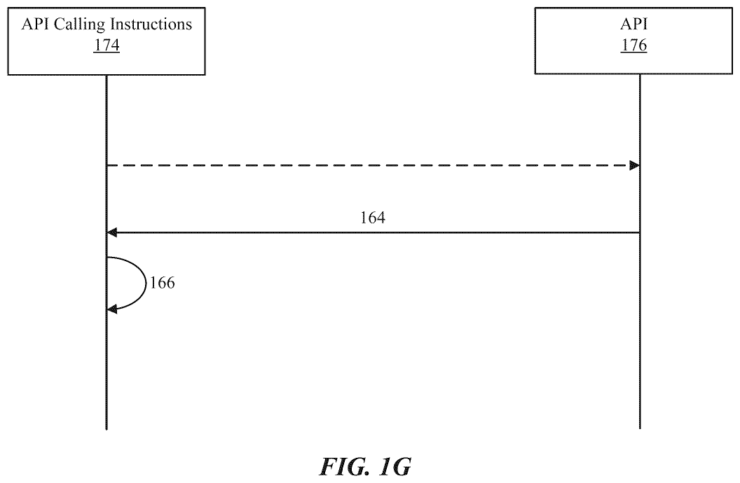

Turning to FIG. 1A, a block diagram of compute system 100 is illustrated. Compute system 100 is a non-limiting example of a compute system that can be used to perform functionality described herein. It should be recognized that other computer architectures of a compute system can be used to perform functionality described herein.

In the illustrated example, compute system 100 includes processor subsystem 110 communicating with (e.g., wired or wirelessly) memory 120 (e.g., a system memory) and I/O interface 130 via interconnect 150 (e.g., a system bus, one or more memory locations, or other communication channel for connecting multiple components of compute system 100). In addition, I/O interface 130 is communicating with (e.g., wired or wirelessly) to I/O device 140. In some embodiments, I/O interface 130 is included with I/O device 140 such that the two are a single component. It should be recognized that there can be one or more I/O interfaces, with each I/O interface communicating with one or more I/O devices. In some embodiments, multiple instances of processor subsystem 110 can be communicating via interconnect 150.

Compute system 100 can be any of various types of devices, including, but not limited to, a system on a chip, a server system, a personal computer system (e.g., a smartphone, a smartwatch, a wearable device, a tablet, a laptop computer, and/or a desktop computer), a sensor, or the like. In some embodiments, compute system 100 is included or communicating with a physical component for the purpose of modifying the physical component in response to an instruction. In some embodiments, compute system 100 receives an instruction to modify a physical component and, in response to the instruction, causes the physical component to be modified. In some embodiments, the physical component is modified via an actuator, an electric signal, and/or algorithm. Examples of such physical components include an acceleration control, a break, a gear box, a hinge, a motor, a pump, a refrigeration system, a spring, a suspension system, a steering control, a pump, a vacuum system, and/or a valve. In some embodiments, a sensor includes one or more hardware components that detect information about a physical environment in proximity to (e.g., surrounding) the sensor. In some embodiments, a hardware component of a sensor includes a sensing component (e.g., an image sensor or temperature sensor), a transmitting component (e.g., a laser or radio transmitter), a receiving component (e.g., a laser or radio receiver), or any combination thereof. Examples of sensors include an angle sensor, a chemical sensor, a brake pressure sensor, a contact sensor, a non-contact sensor, an electrical sensor, a flow sensor, a force sensor, a gas sensor, a humidity sensor, an image sensor (e.g., a camera sensor, a radar sensor, and/or a LiDAR sensor), an inertial measurement unit, a leak sensor, a level sensor, a light detection and ranging system, a metal sensor, a motion sensor, a particle sensor, a photoelectric sensor, a position sensor (e.g., a global positioning system), a precipitation sensor, a pressure sensor, a proximity sensor, a radio detection and ranging system, a radiation sensor, a speed sensor (e.g., measures the speed of an object), a temperature sensor, a time-of-flight sensor, a torque sensor, and an ultrasonic sensor. In some embodiments, a sensor includes a combination of multiple sensors. In some embodiments, sensor data is captured by fusing data from one sensor with data from one or more other sensors. Although a single compute system is shown in FIG. 1A, compute system 100 can also be implemented as two or more compute systems operating together.

In some embodiments, processor subsystem 110 includes one or more processors or processing units configured to execute program instructions to perform functionality described herein. For example, processor subsystem 110 can execute an operating system, a middleware system, one or more applications, or any combination thereof.

In some embodiments, the operating system manages resources of compute system 100. Examples of types of operating systems covered herein include batch operating systems (e.g., Multiple Virtual Storage (MVS)), time-sharing operating systems (e.g., Unix), distributed operating systems (e.g., Advanced Interactive executive (AIX), network operating systems (e.g., Microsoft Windows Server), and real-time operating systems (e.g., QNX). In some embodiments, the operating system includes various procedures, sets of instructions, software components, and/or drivers for controlling and managing general system tasks (e.g., memory management, storage device control, power management, or the like) and for facilitating communication between various hardware and software components. In some embodiments, the operating system uses a priority-based scheduler that assigns a priority to different tasks that processor subsystem 110 can execute. In such examples, the priority assigned to a task is used to identify a next task to execute. In some embodiments, the priority-based scheduler identifies a next task to execute when a previous task finishes executing. In some embodiments, the highest priority task runs to completion unless another higher priority task is made ready.

In some embodiments, the middleware system provides one or more services and/or capabilities to applications (e.g., the one or more applications running on processor subsystem 110) outside of what the operating system offers (e.g., data management, application services, messaging, authentication, API management, or the like). In some embodiments, the middleware system is designed for a heterogeneous computer cluster to provide hardware abstraction, low-level device control, implementation of commonly used functionality, message-passing between processes, package management, or any combination thereof. Examples of middleware systems include Lightweight Communications and Marshalling (LCM), PX4, Robot Operating System (ROS), and ZeroMQ. In some embodiments, the middleware system represents processes and/or operations using a graph architecture, where processing takes place in nodes that can receive, post, and multiplex sensor data messages, control messages, state messages, planning messages, actuator messages, and other messages. In such examples, the graph architecture can define an application (e.g., an application executing on processor subsystem 110 as described above) such that different operations of the application are included with different nodes in the graph architecture.

In some embodiments, a message sent from a first node in a graph architecture to a second node in the graph architecture is performed using a publish-subscribe model, where the first node publishes data on a channel in which the second node can subscribe. In such examples, the first node can store data in memory (e.g., memory 120 or some local memory of processor subsystem 110) and notify the second node that the data has been stored in the memory. In some embodiments, the first node notifies the second node that the data has been stored in the memory by sending a pointer (e.g., a memory pointer, such as an identification of a memory location) to the second node so that the second node can access the data from where the first node stored the data. In some embodiments, the first node would send the data directly to the second node so that the second node would not need to access a memory based on data received from the first node.

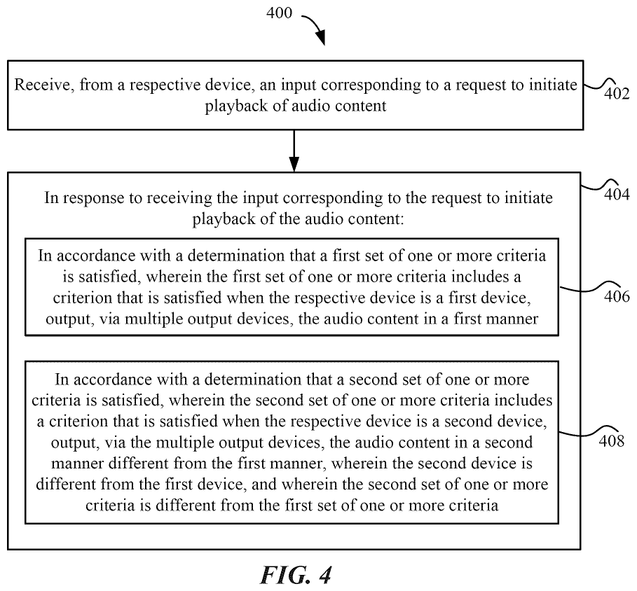

Memory 120 can include a computer readable medium (e.g., non-transitory or transitory computer readable medium) usable to store (e.g., configured to store, assigned to store, and/or that stores) program instructions executable by processor subsystem 110 to cause compute system 100 to perform various operations described herein. For example, memory 120 can store program instructions to implement the functionality associated with processes 400, 500, 800, and 900 (FIGS. 4, 5, 8, and 9) described below.

Memory 120 can be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, or the like), read only memory (PROM, EEPROM, or the like), or the like. Memory in compute system 100 is not limited to primary storage such as memory 120. Compute system 100 can also include other forms of storage such as cache memory in processor subsystem 110 and secondary storage on I/O device 140 (e.g., a hard drive, storage array, etc.). In some embodiments, these other forms of storage can also store program instructions executable by processor subsystem 110 to perform operations described herein. In some embodiments, processor subsystem 110 (or each processor within processor subsystem 110) contains a cache or other form of on-board memory.

I/O interface 130 can be any of various types of interfaces configured to communicate with other devices. In some embodiments, I/O interface 130 includes a bridge chip (e.g., Southbridge) from a front-side bus to one or more back-side buses. I/O interface 130 can communicate with one or more I/O devices (e.g., I/O device 140) via one or more corresponding buses or other interfaces. Examples of I/O devices include storage devices (hard drive, optical drive, removable flash drive, storage array, SAN, or their associated controller), network interface devices (e.g., to a local or wide-area network), sensor devices (e.g., camera, radar, LiDAR, ultrasonic sensor, GPS, inertial measurement device, or the like), and auditory or visual output devices (e.g., speaker, light, screen, projector, or the like). In some embodiments, compute system 100 is communicating with a network via a network interface device (e.g., configured to communicate over Wi-Fi, Bluetooth, Ethernet, or the like). In some embodiments, compute system 100 is directly or wired to the network.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, software modules, and/or components.

Implementations within the scope of the present disclosure include a computer-readable storage medium that encodes instructions organized as an application (e.g., application 170) that, when executed by one or more processing units, control an electronic device (e.g., device 168) to perform the process of FIG. 1B, the process of FIG. 1C, and/or one or more other processes and/or processes described herein.

It should be recognized that application 170 (e.g., illustrated in FIG. 1D) can be any suitable type of application, including, for example, one or more of: a browser application, an application that functions as an execution environment for plug-ins, widgets, or other applications, a fitness application, a health application, an accessory management application, a home application, a digital payments application, a media application, a social network application, a messaging application, and/or a maps application. In some embodiments, application 170 is an application that is pre-installed on device 168 at purchase (e.g., a first party application). In some embodiments, application 170 is an application that is provided to device 168 via an operating system update file (e.g., a first party application or a second party application). In other embodiments, application 170 is an application that is provided via an application store. In some embodiments, the application store can be an application store that is pre-installed on device 168 at purchase (e.g., a first party application store). In some embodiments, the application store is a third-party application store (e.g., an application store that is provided by another application store, downloaded via a network, and/or read from a storage device).

Referring to FIG. 1B and FIG. 1F, application 170 obtains information (e.g., 160). In some embodiments, at 160, information is obtained from at least one hardware component of device 168. In some embodiments, at 160, information is obtained from at least one software module (e.g., a set of one more instructions) of device 168. In some embodiments, at 160, information is obtained from at least one hardware component external to device 168 (e.g., a peripheral device, an accessory device, and/or a server). In some embodiments, the information obtained at 160 includes positional information, time information, notification information, user information, environment information, electronic device state information, weather information, media information, historical information, event information, hardware information, and/or motion information. In some embodiments, in response to and/or after obtaining the information at 160, application 170 provides the information to system (e.g., 162).

In some embodiments, the system (e.g., 180 as illustrated in FIG. 1E) is an operating system hosted on device 168. In some embodiments, the system (e.g., 180 as illustrated in FIG. 1E) is an external device (e.g., a server, a peripheral device, an accessory, and/or a personal computing device) that includes an operating system.

Referring to FIG. 1C, application 170 obtains information (e.g., 164). In some embodiments, the information obtained at 164 includes positional information, time information, notification information, user information, environment information electronic device state information, weather information, media information, historical information, event information, hardware information and/or motion information. In response to and/or after obtaining the information at 164, application 170 performs an operation with the information (e.g., 166). In some embodiments, the operation performed at 166 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 180 based on the information.

In some embodiments, one or more steps of the process of FIG. 1B and/or the process of FIG. 1C is performed in response to a trigger. In some embodiments, the trigger includes detection of an event, a notification received from system 180, a user input, and/or a response to a call to an API provided by system 180.

In some embodiments, the instructions of application 170, when executed, control device 168 to perform the process of FIG. 1B and/or the process of FIG. 1C by calling an application programming interface (API) (e.g., API 176) provided by system 180. In some embodiments, application 170 performs at least a portion of the process of FIG. 1B and/or the process of FIG. 1C without calling API 176.

In some embodiments, one or more steps of the process of FIG. 1B and/or the process of FIG. 1C includes calling an API (e.g., API 176) using one or more parameters defined by the API. In some embodiments, the one or more parameters include a constant, a key, a data structure, an object, an object class, a variable, a data type, a pointer, an array, a list or a pointer to a function or a process, and/or another way to reference a data or other item to be passed via the API.

Referring to FIG. 1D, device 168 is illustrated. In some embodiments, device 168 is a personal computing device, a smart phone, a smart watch, a fitness tracker, a head mounted display (HMD) device, a media device, a communal device, a speaker, a television, and/or a tablet. Device 168 includes application 170 and an operating system (not shown) (e.g., system 180 as illustrated in FIG. 1E). Application 170 includes application implementation instructions 172 and API calling instructions 174. System 180 includes API 176 and implementation instructions 178. It should be recognized that device 168, application 170, and/or system 180 can include more, fewer, and/or different components than illustrated in FIGS. 1D and 1E.

In some embodiments, application implementation instructions 172 is a software module that includes a set of one or more computer-readable instructions. In some embodiments, the set of one or more computer-readable instructions correspond to one or more operations performed by application 170. For example, when application 170 is a messaging application, application implementation instructions 172 can include operations to receive and send messages. In some embodiments, application implementation instructions 172 communicates with API calling instructions to communicate with system 180 via API 176 (e.g., as illustrated in FIG. 1E).

In some embodiments, API calling instructions 174 is a software module that includes a set of one or more computer-executable instructions.

In some embodiments, implementation instructions 178 is a software module that includes a set of one or more computer-executable instructions.

In some embodiments, API 176 is a software module that includes a set of one or more computer-executable instructions. In some embodiments, API 176 provides an interface that allows a different set of instructions (e.g., API calling instructions 174) to access and/or use one or more functions, processes, procedures, data structures, classes, and/or other services provided by implementation instructions 178 of system 180. For example, API calling instructions 174 can access a feature of implementation instructions 178 through one or more API calls or invocations (e.g., embodied by a function call, a method call, or a process call) exposed by API 176 and can pass data and/or control information using one or more parameters via the API calls or invocations. In some embodiments, API 176 allows application 170 to use a service provided by a Software Development Kit (SDK) library. In some embodiments, application 170 incorporates a call to a function or process provided by the SDK library and provided by API 176 or uses data types or objects defined in the SDK library and provided by API 176. In some embodiments, API calling instructions 174 makes an API call via API 176 to access and use a feature of implementation instructions 178 that is specified by API 176. In such embodiments, implementation instructions 178 can return a value via API 176 to API calling instructions 174 in response to the API call. The value can report to application 170 the capabilities or state of a hardware component of device 168, including those related to aspects such as input capabilities and state, output capabilities and state, processing capability, power state, storage capacity and state, and/or communications capability. In some embodiments, API 176 is implemented in part by firmware, microcode, or other low level logic that executes in part on the hardware component.

In some embodiments, API 176 allows a developer of API calling instructions 174 (which can be a third-party developer) to leverage a feature provided by implementation instructions 178. In such embodiments, there can be one or more sets of API calling instructions (e.g., including API calling instructions 174) that communicate with implementation instructions 178. In some embodiments, API 176 allows multiple sets of API calling instructions written in different programming languages to communicate with implementation instructions 178 (e.g., API 176 can include features for translating calls and returns between implementation instructions 178 and API calling instructions 174) while API 176 is implemented in terms of a specific programming language. In some embodiments, API calling instructions 174 calls APIs from different providers such as a set of APIs from an OS provider, another set of APIs from a plug-in provider, and/or another set of APIs from another provider (e.g., the provider of a software library) or creator of the another set of APIs.

Examples of API 176 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments the sensor API is an API for accessing data associated with a sensor of device 168. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation instructions 178 is a system (e.g., an operating system and/or a server system) software module (e.g., a collection of computer-readable instructions) that is constructed to perform an operation in response to receiving an API call via API 176. In some embodiments, implementation instructions 178 is constructed to provide an API response (via API 176) as a result of processing an API call. By way of example, implementation instructions 178 and API calling instructions 174 can each be any one of an operating system, a library, a device driver, an API, an application program, or other module. It should be understood that implementation instructions 178 and API calling instructions 174 can be the same or different type of software module from each other. In some embodiments, implementation instructions 178 is embodied at least in part in firmware, microcode, or other hardware logic.

In some embodiments, implementation instructions 178 returns a value through API 176 in response to an API call from API calling instructions 174. While API 176 defines the syntax and result of an API call (e.g., how to invoke the API call and what the API call does), API 176 might not reveal how implementation instructions 178 accomplishes the function specified by the API call. Various API calls are transferred via the one or more application programming interfaces between API calling instructions 174 and implementation instructions 178. Transferring the API calls can include issuing, initiating, invoking, calling, receiving, returning, and/or responding to the function calls or messages. In other words, transferring can describe actions by either of API calling instructions 174 or implementation instructions 178. In some embodiments, a function call or other invocation of API 176 sends and/or receives one or more parameters through a parameter list or other structure.

In some embodiments, implementation instructions 178 provides more than one API, each providing a different view of or with different aspects of functionality implemented by implementation instructions 178. For example, one API of implementation instructions 178 can provide a first set of functions and can be exposed to third party developers, and another API of implementation instructions 178 can be hidden (e.g., not exposed) and provide a subset of the first set of functions and also provide another set of functions, such as testing or debugging functions which are not in the first set of functions. In some embodiments, implementation instructions 178 calls one or more other components via an underlying API and thus be both an API calling instructions and an implementation instructions. It should be recognized that implementation instructions 178 can include additional functions, processes, classes, data structures, and/or other features that are not specified through API 176 and are not available to API calling instructions 174. It should also be recognized that API calling instructions 174 can be on the same system as implementation instructions 178 or can be located remotely and access implementation instructions 178 using API 176 over a network. In some embodiments, implementation instructions 178, API 176, and/or API calling instructions 174 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

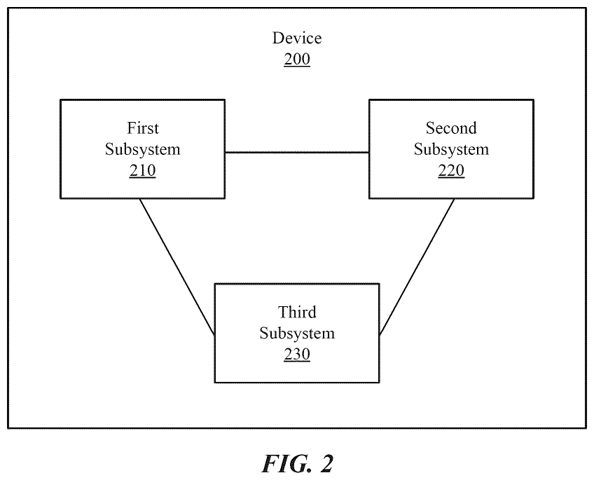

FIG. 2 illustrates a block diagram of device 200 with interconnected subsystems. In the illustrated example, device 200 includes three different subsystems (i.e., first subsystem 210, second subsystem 220, and third subsystem 230) communicating with (e.g., wired or wirelessly) each other, creating a network (e.g., a personal area network, a local area network, a wireless local area network, a metropolitan area network, a wide area network, a storage area network, a virtual private network, an enterprise internal private network, a campus area network, a system area network, and/or a controller area network). An example of a possible computer architecture of a subsystem as included in FIG. 2 is described in FIG. 1A (i.e., compute system 100). Although three subsystems are shown in FIG. 2, device 200 can include more or fewer subsystems.

In some embodiments, some subsystems are not connected to other subsystem (e.g., first subsystem 210 can be connected to second subsystem 220 and third subsystem 230 but second subsystem 220 cannot be connected to third subsystem 230). In some embodiments, some subsystems are connected via one or more wires while other subsystems are wirelessly connected. In some embodiments, messages are set between the first subsystem 210, second subsystem 220, and third subsystem 230, such that when a respective subsystem sends a message the other subsystems receive the message (e.g., via a wire and/or a bus). In some embodiments, one or more subsystems are wirelessly connected to one or more compute systems outside of device 200, such as a server system. In such examples, the subsystem can be configured to communicate wirelessly to the one or more compute systems outside of device 200.

In some embodiments, device 200 includes a housing that fully or partially encloses subsystems 210-230. Examples of device 200 include a home-appliance device (e.g., a refrigerator or an air conditioning system), a robot (e.g., a robotic arm or a robotic vacuum), and a vehicle. In some embodiments, device 200 is configured to navigate (with or without user input) in a physical environment.

In some embodiments, one or more subsystems of device 200 are used to control, manage, and/or receive data from one or more other subsystems of device 200 and/or one or more compute systems remote from device 200. For example, first subsystem 210 and second subsystem 220 can each be a camera that captures images, and third subsystem 230 can use the captured images for decision making. In some embodiments, at least a portion of device 200 functions as a distributed compute system. For example, a task can be split into different portions, where a first portion is executed by first subsystem 210 and a second portion is executed by second subsystem 220.

Attention is now directed towards techniques for altering output of audio content. Such techniques are described in the context of a resident device adjusting one or more output devices. It should be recognized that other types of electronic devices can be used with techniques described herein. For example, a personal device can adjust one or more output devices using techniques described herein. In addition, techniques optionally complement or replace other techniques for altering output of audio content.

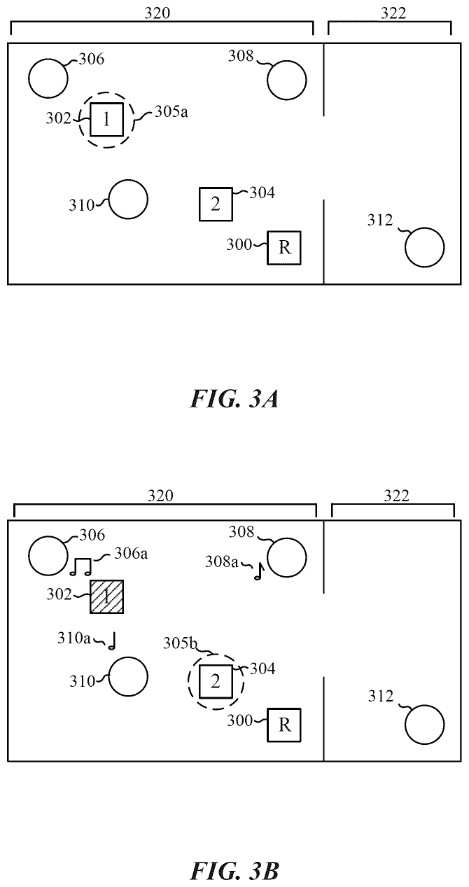

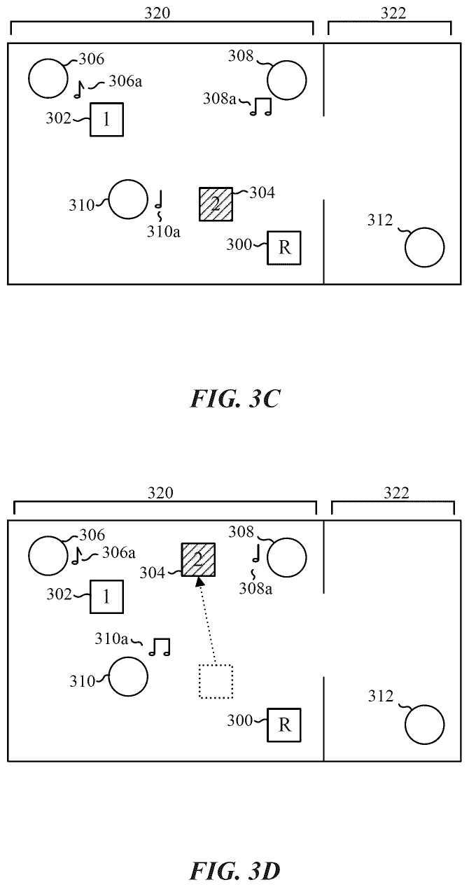

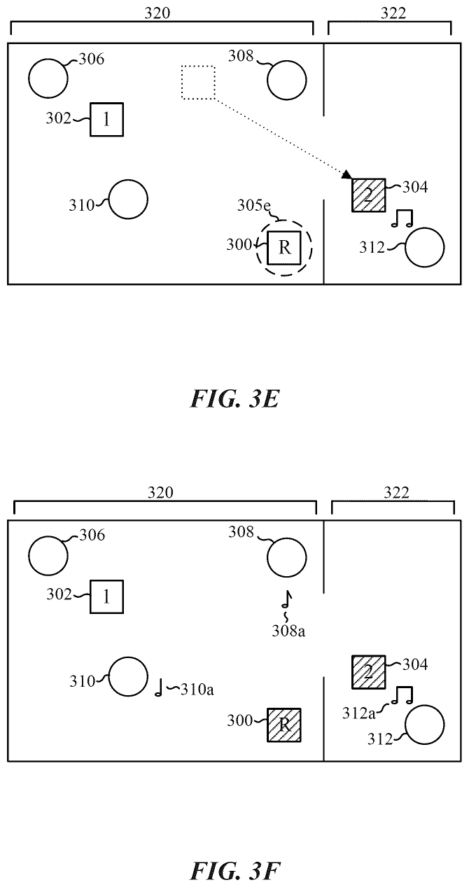

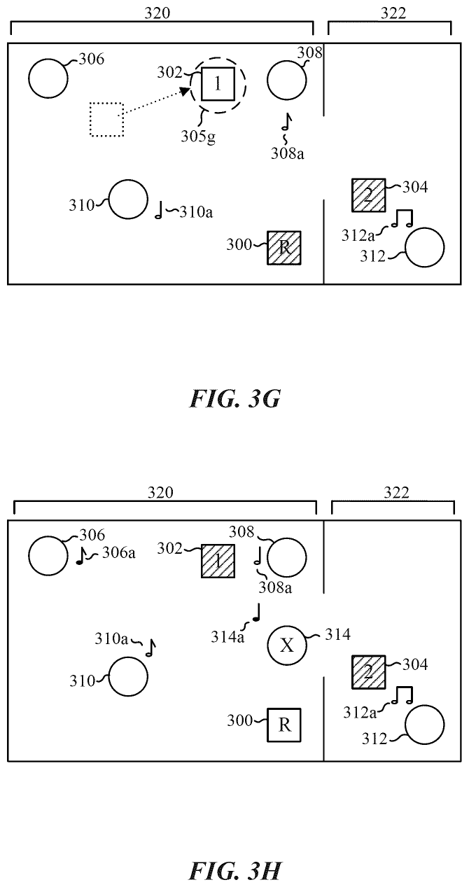

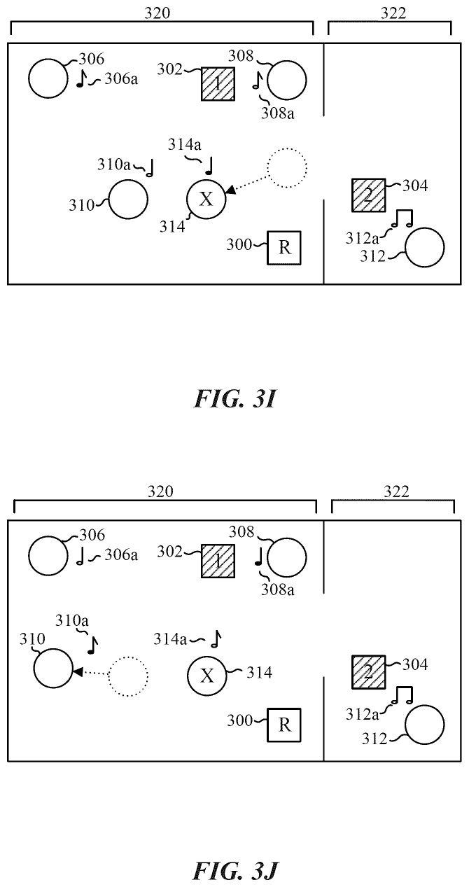

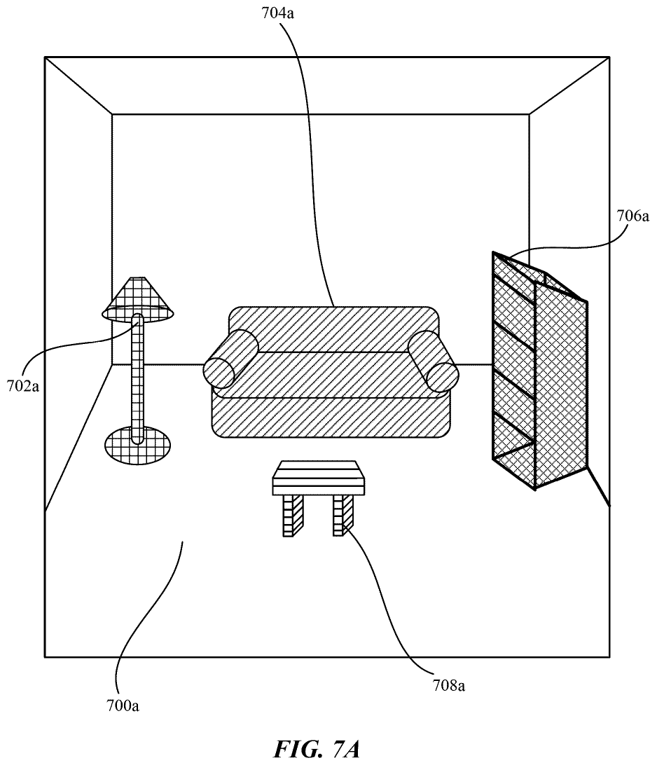

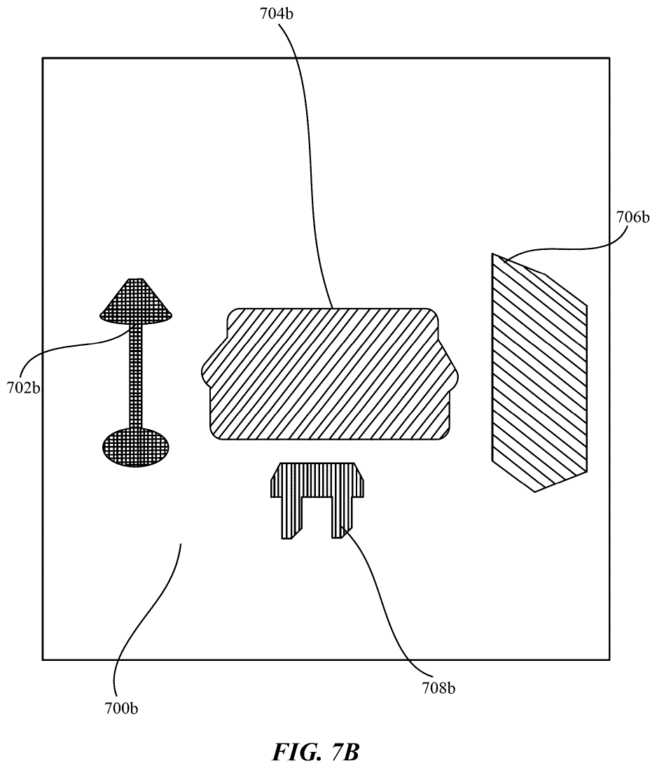

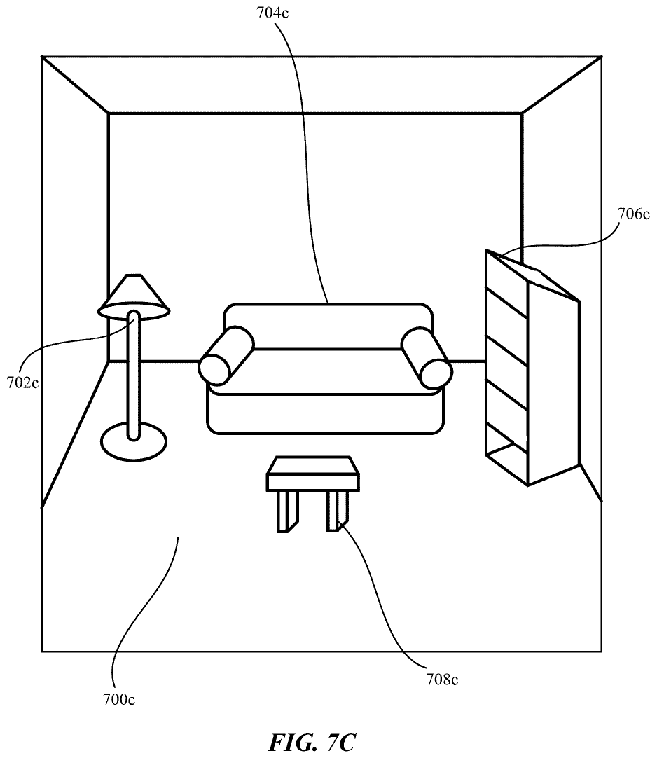

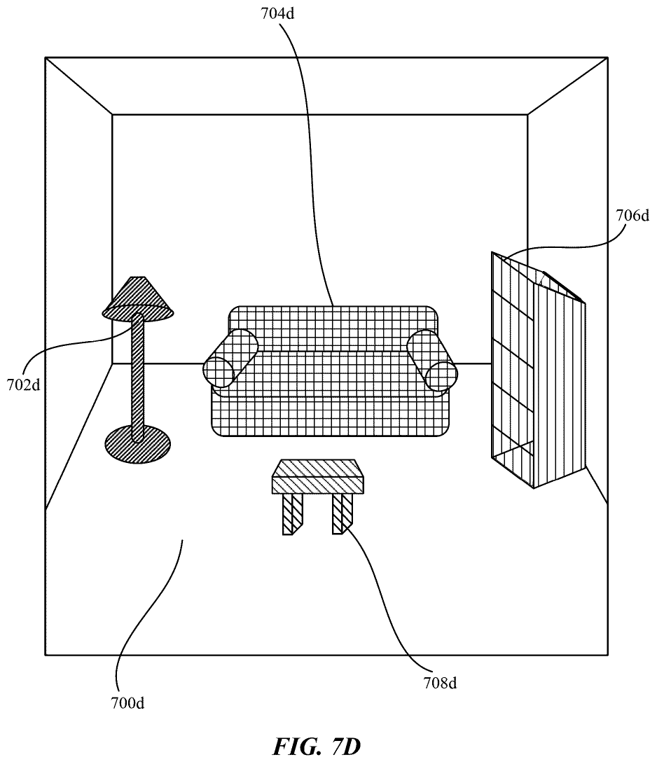

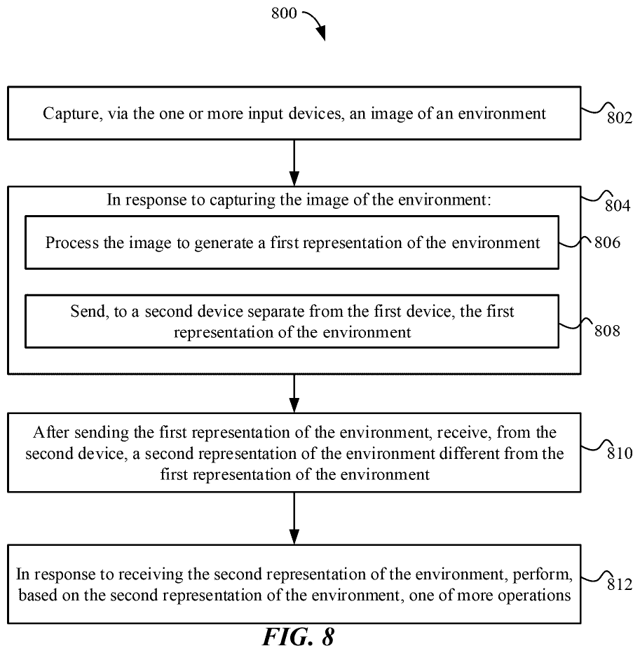

FIGS. 3A-3J illustrate an exemplary environment to illustrate techniques for adjusting audio content in accordance with some embodiments. The environment in these figures is used to illustrate the processes described below, including the processes in FIGS. 7 and 8.

FIGS. 3A-3J illustrate the environment split between two separate rooms (e.g., room 320 and room 322). As illustrated in FIGS. 3A-3J, the environment includes multiple different devices such as speakers (e.g., speaker 306, speaker 308, speaker 310, speaker 312, and eventually speaker 314), controlling devices (e.g., controlling device 302 and controlling device 304), and resident device 300. In some embodiments, a speaker (e.g., speaker 306, speaker 308, speaker 310, speaker 312, and/or speaker 314) is a device capable of outputting audio content and/or detecting inputs (e.g., for transmitting to resident device 300) and/or changes within the environment, as discussed further below. In some embodiments, a controlling device (e.g., controlling device 302 and/or controlling device 304) is a device that can initiate playback of audio content to a set of output devices (e.g., speaker 306, speaker 308, speaker 310, speaker 312, and/or speaker 314) through direct control and/or through another device (e.g., resident device 300), as discussed further below. In some embodiments, a resident device (e.g., resident device 300) is a device positioned and/or affixed to an object positioned within the environment (e.g., mounted to a countertop and/or cabinet). In some embodiments, a resident device (e.g., resident device 300) can control and/or initiate playback of audio content via a set of connected speakers and/or can facilitate the communication of a controlling device with the connected speakers (e.g., via a network and/or network of devices), as discussed further below.

While discussed further below as speakers, controlling devices, and resident devices, it should be recognized that such devices within the environment can be all the same type of devices and/or a different arrangement of different types of devices. For example, resident device 300 can be another controlling device (e.g., a controlling device positioned within room 320). In some embodiments, devices within the environment can include one or more similar components such as one or more input devices (e.g., a sensor, a camera, a lidar detector, a motion sensor, an infrared sensor, a touch-sensitive surface, a physical input mechanism, and/or a microphone) and/or one or more output devices (e.g., a display screen, a projector, a touch-sensitive display, and/or a speaker). In some embodiments, resident device 300 includes one or more components and/or features described above in relation to compute system 100 and/or electronic device 200.

While the examples in FIGS. 3A-3J include resident device 300 detecting one or more inputs, it should be recognized that such inputs are merely for explanatory purposes and that such inputs can be detected by other devices and/or such inputs can be other types of inputs such as voice inputs via one or more microphones, touch inputs via one or more touch-sensitive surfaces, physical inputs via one or more physical input mechanisms, and/or hand-gesture inputs via one or more cameras.

In some embodiments, devices within the environment are part of and/or in communication with a network. In such embodiments, the network can include a wireless network (e.g., a home Wi-Fi network) and/or a device-to-device communication network (e.g., Bluetooth and/or Thread). In some embodiments, the network is a combination of different types of networks based on which device is communicating. For example, controlling device 302 can communicate to resident device 300 through Wi-Fi, and resident device 300 can communicate to speaker 306, speaker 308, and/or speaker 310 through Thread to facilitate playback of audio content initialized by controlling device 302. For another example, controlling device 302 can be a part of a Thread network with speaker 306, speaker 308, and/or speaker 310 and controlling device 302 can directly initialize playback of audio content without requiring resident device 300.

In some embodiments, the network includes all devices within the environment (e.g., room 320 and/or room 322), including speakers (e.g., speaker 306, speaker 308, speaker 310, speaker 312, and eventually speaker 314), controlling devices (e.g., controlling device 302 and controlling device 304), and resident device 300. In some embodiments, all devices within the network facilitate playback of audio content. For example, controlling device 302 can send a request to resident device 300 to initiate playback and/or controlling device 302 can initiate playback via speakers (e.g., speaker 306, speaker 308, and/or speaker 310) without resident device 300 (e.g., directly sending audio content and/or channels of audio content to certain speakers with room 320). In some embodiments, utilizing resident device 300 to initiate playback of the audio content provides controlling device 302 additional functionality. For example, sending a request to resident device 300 to initiate playback of content enables differing playback of the audio content based on context of the environment (e.g., position of controlling device 302, number of speakers within room 320, position of the speakers within room 320, subjects within room 320, and/or objects within room 320), as discussed further below.

In some embodiments, the network only includes certain devices, such as speakers (e.g., speaker 306, speaker 308, speaker 310, speaker 312, and speaker 314) and resident device 300. In some embodiments, devices outside of the network can communicate to devices within the network via resident device 300. For example, controlling device 302 can initiate playback of audio content within room 320 by sending a request to resident device 300 to initiate playback, and resident device 300 can output, via speaker 306, speaker 308, and/or speaker 310, the audio content with certain audio characteristics on behalf of controlling device 302, as discussed further below.

In some embodiments, devices within the environment are self-localizing devices. For example, speakers (e.g., speaker 306, speaker 308, speaker 310, speaker 312, and/or speaker 314) within the environment (e.g., room 320 and/or room 322) can find and/or track their positioning and/or locality within the environment as the speakers are moved (e.g., as discussed below with respect to FIGS. 3H-3J) and/or context of the environment changes (e.g., a repositioning of controlling devices, a change in number of speakers within room 320, a repositioning of other speakers within room 320, and/or movement of subjects and/or objects within room 320). In some embodiments, speakers (e.g., speaker 306, speaker 308, speaker 310, speaker 312, and/or speaker 314) within the environment (e.g., room 320 and/or room 322) can self-localize on their own. For example, speaker 306, speaker 308, and speaker 310 can determine their positions within room 320 on their own (e.g., without resident device 300) and/or through sending positional data back and forth to each other. In some embodiments, devices require and/or utilize resident device 300 to self-localize. For example, speaker 306, speaker 308, and speaker 310 send positional information (e.g., images, audio, depth, and/or other inputs from devices discussed above) to resident device 300, and resident device 300 sends and/or identifies assignments and/or a mapping of the devices for playback of audio content. For another example, speaker 306, speaker 308, and speaker 310 can send positional information (e.g., images, audio, depth, and/or other inputs from devices discussed above) to resident device 300, and resident device 300 can output, via speaker 306, speaker 308, and speaker 310, audio content without sending any positional information back to the speakers (e.g., resident device 300 sends different audio channels based on positional information). As further discussed below, such positional awareness of devices can allow the devices and/or resident device 300 to alter playback of audio content via speakers (e.g., speaker 306, speaker 308, and/or speaker 310) within room 320.

In some embodiments, devices within the environment utilize one or more input devices, as discussed above, to take in information about the environment to enable self-localizing. For example, speakers (e.g., speaker 306, speaker 308, and/or speaker 310) can continuously and/or at a specified time take images of room 320 via one or more cameras to provide image information for self-localizing. For another example, speakers (e.g., speaker 306, speaker 308, and/or speaker 310) can continuously and/or while outputting audio content take in audio information (e.g., one or more characteristics of the audio content such as directionality, clarity, channel, and/or volume level) about the audio content output within room 320 for self-localizing. In some embodiments, the audio information is based on audible and/or inaudible frequencies (e.g., to a subject within room 320) output by the devices (speaker 306, speaker 308, and/or speaker 310). For example, while outputting audio content, speaker 306, speaker 308, and/or speaker 310 can output an inaudible frequency and triangulate each other's position within room 320 based on the inaudible frequency.

In some embodiments, devices within the environment utilize the network, as discussed above, to self-localize. In some embodiments, resident device 300 compiles from the devices (e.g., speaker 306, speaker 308, and/or speaker 310) positional information, sent via the network, and generates a mapping and/or locality of the devices for tailoring playback of audio content to different situations. As discussed further below, resident device 300 can adjust playback of audio content based on changes within the environment (e.g., room 320 and/or room 322), such adjustments can be based on information sent, via the network, by the speakers (e.g., speaker 306, speaker 308, speaker 310, speaker 312, and eventually speaker 314) and/or a mapping of devices generated by resident device 300 from information sent by the speakers (e.g., via the network to resident device 300). In some embodiments, resident device 300 updates such mapping of devices in response to receiving, via the network, information (e.g., audio and/or image) that the environment has changed (e.g., devices move, subjects move, devices are added, and/or devices are removed).

As illustrated in FIG. 3A, room 320 includes an initial layout of devices including three speakers (e.g., speaker 306, speaker 308, and speaker 310), two devices (e.g., controlling device 302 and controlling device 304), and resident device 300. At FIG. 3A, speaker 306, speaker 308, and speaker 310 are not outputting any audio content (e.g., as indicated by a lack of music notes radiating from the speakers, as compared to audio output 306a, audio output 308a, and/or audio output 310a in FIG. 3B). As also illustrated in FIG. 3A, room 322 includes speaker 312. Similarly to the speakers within room 320, speaker 312 is not outputting any audio content.

In some embodiments, speaker 306, speaker 308, and speaker 310 have self-localized within the initial layout as described above. For example, after the speakers (e.g., speaker 306, speaker 308, and speaker 310) were positioned within room 320, the speakers sent information (e.g., image information) to resident device 300 for mapping an initial locality of the speakers with room 320. In some embodiments, resident device 300 continuously tracks and/or updates localities of devices (e.g., speaker 306, speaker 308, speaker 310, controlling device 302, and/or controlling device 304) within room 320 and/or room 322 based on information received from the devices within room 320 and/or room 322. In some embodiments, as context of the environment (e.g., room 320 and/or room 322) changes, as discussed further below, resident device 300 compares new information (e.g., image and/or audio) received from devices within room 320 and/or room 322 against the initial mapping of the devices to determine how to adjust to differing situations (e.g., altering audio content based on a new device, movement of a device, and/or a repositioning of an initiating device).

At FIG. 3A, while no audio content is output, resident device 300 detects input 305a. In some embodiments, input 305a is an input to initiate playback of audio content within room 320. For example, input 305a can be a tap input on controlling device 302, such as an input interacting with a user interface and/or application on controlling device 302 that can initiate playback of the audio content within room 320. In such an example, resident device 300 detects input 305a in response to receiving a notification of input 305a from controlling device 302. It should be recognized that input 305a is an example of one type of input but can be other inputs, such as a verbal input (e.g., voice command and/or voice request). For example, input 305a can be a verbal input (e.g., “Play my favorite show in the home theater”) within room 320 requesting playback of the audio content within room 320 that is detected by controlling device 302 and/or by one or more devices within room 320 (e.g., speaker 306, speaker 308, and/or speaker 310) and determined (e.g., by resident device 300) to be closest to controlling device 302.

As illustrated in FIG. 3B, in response to detecting input 305a, resident device 300 outputs, via speaker 306, speaker 308, and speaker 310, audio content. As illustrated in FIG. 3B, audio output 306a, audio output 308a, and audio output 310a radiate from speaker 306, speaker 308, and speaker 310 respectively. In some embodiments, resident device 300, controlling device 302, and/or controlling device 304 are included within the devices outputting the audio content. For example, in response to controlling device 302 initiating playback of the audio content, controlling device 304 and/or resident device 300 output the audio content along with speaker 306, speaker 308, and speaker 310. In some embodiments, resident device 300, controlling device 302, and/or controlling device 304 are not included within the devices outputting the audio content. For example, resident device 300, controlling device 302, and/or controlling device 304 do not output the audio content along with speaker 306, speaker 308, and speaker 310. In some embodiments, the audio content output via a set of speakers (e.g., speaker 306, speaker 308, and speaker 310) is synchronized playback of the same audio content.

As illustrated in FIG. 3B, audio output 306a, audio output 308a, and audio output 310a center on controlling device 302. In some embodiments, the audio content is centered on controlling device 302 due to controlling device 302's locality within room 320 and/or controlling device 302 being the device that initiated playback of audio content (e.g., via input 305a). In some embodiments, the audio content is centered on controlling device 302 due to a positional difference between controlling device 302 and speaker 306, speaker 308, and speaker 310. For example, resident device 300 centers the audio content based on information (e.g., image information) received from the speakers (e.g., speaker 306, speaker 308, and speaker 310) to determine a positional relationship shared by the speakers and controlling device 302. Similarly, as indicated by difference in music notes of audio output 306a, audio output 308a, and/or audio output 310a, each speaker can output the same audio content with a different set of audio characteristics. For example, audio output 310a of speaker 310 and audio output 308a of speaker 308 can be different due to a difference in device type, a difference in position within room 320 (e.g., controlling device 302's locality within room 320 and/or controlling device 302's relationship with speaker 306, speaker 308, and/or speaker 310), and/or a difference in distance to controlling device 302 (e.g., in relation to resident device 300, controlling device 304, and/or speaker 306, speaker 308, and/or speaker 310).

In some embodiments, audio output 306a, audio output 308a, and/or audio output 310a indicate a difference in assignment (e.g., dynamically via self-localization and/or user defined) within a predefined configuration. For example, a configuration can include splitting different audio channels, surround channels, and/or speaker balances between speakers within room 320 (e.g., assigning speaker 306 a left surround channel and speaker 308 a right surround channel and/or splitting portions of frequencies to speaker 306 such as a percentage of a low, mid, and/or high audio frequency). In some embodiments, while illustrated as different notes, speaker 306, speaker 308, and speaker 310 output the audio content the same (e.g., a common audio output across all speakers to provide a common experience across all locations with the environment).

In some embodiments, audio output 306a, audio output 308a, and/or audio output 310a indicate a difference in audio output due to the speakers (e.g., speaker 306, speaker 308, and speaker 310) self-localization. As discussed above, while controlling device 302 initiates playback of the audio content (e.g., sending a request to resident device 300 and/or a network of devices including resident device 300) within room 320, resident device 300 configures the output of the audio content based on information received from the speakers (e.g., speaker 306, speaker 308, and speaker 310). As mentioned above, before outputting the audio content, resident device 300 can assign different audio characteristics (e.g., as indicated by the difference in music notes of audio output 306a, audio output 308a, and/or audio output 310a) to the speakers (e.g., speaker 306, speaker 308, and speaker 310) based on the speakers' locality in room 320. For example, resident device 300 utilizes positional information sent by the speakers (e.g., speaker 306, speaker 308, and speaker 310) to assign directionality to each speaker (e.g., centering on controlling device 302).

Additionally, at FIG. 3B, speaker 312 does not output any audio (e.g., as indicated by the lack of an audio output radiating from speaker 312). In some embodiments, speaker 312 does not output any audio due to speaker 312 being in a separate room (e.g., room 322) than room 320 (e.g., sperate room than where controlling device 302 initiates playback of audio content). For example, room 320 is defined as a first locality (e.g., a home theater system and/or living room) which outputs audio content separately from room 322 due to room 322 being a second locality (e.g., a bedroom and/or a separate room). In some embodiments, speaker 312 does not output any audio due to speaker 312 being assigned to a separate group of devices than speaker 306, speaker 308, and speaker 310. For example, each room (e.g., room 320 and/or room 322) can be assigned a group of speakers, and resident device 300 can output audio content to each room separately or across all rooms by outputting to different groups of speakers. In some embodiments, all speakers (e.g., speaker 306, speaker 308, speaker 310, and speaker 312) are part of the network, as discussed above, and through the network, resident device 300 can manipulate speaker assignments (e.g., assigned to particular rooms, localities, and/or groups of devices).

At FIG. 3B, while outputting the audio content via speaker 306, speaker 308, and speaker 310, resident device 300 detects input 305b. In some embodiments, input 306b is a tap input on controlling device 302. For example, input 305b can be an input interacting with a user interface and/or application on controlling device 304 that can initiate playback of the audio content within room 320. In such an example, resident device 300 detects input 305b in response to receiving a notification of input 305b from controlling device 304. Similarly to above, it should be recognized that input 305b can be other types of inputs. For example, input 305b can be a verbal input (e.g., “Play my favorite song”) requesting playback of the audio content within room 320 that is detected by controlling device 302 and/or by one or more devices within room 320 (e.g., speaker 306, speaker 308, and speaker 310) and determined (e.g., by resident device 300) to be closest to controlling device 304.

As illustrated in FIG. 3C, in response to detecting input 305b, resident device 300 alters output of the audio content (e.g., as indicated by the difference in audio output 306a, audio output 308a, and audio output 310a between FIGS. 3B and 3C). In some embodiments, resident device 300 alters the output of the audio content by providing differing audio characteristics to each speaker (e.g., speaker 306, speaker 308, and/or speaker 310). For example, as discussed above, resident device 300 can send different audio channels, surround channels, and/or speaker balances to speaker 306, speaker 308, and/or speaker 310 to provide different audio experiences.

As illustrated in FIG. 3C, controlling device 304 is positioned differently within room 320 than controlling device 302. For example, controlling device 302 is within a home theater system (e.g., made up of speaker 306, speaker 308, and/or speaker 310) and controlling device 304 is outside of the home theater system (e.g., behind a rear channel of the home theater system). Also, at FIG. 3C, speaker 306, speaker 308, and/or speaker 310 output the audio content differently than in FIG. 3B (e.g., as indicated by the movement and/or alteration of audio output 306a, audio output 308a, and audio output 310a), as discussed further below.

In some embodiments, resident device 300 tailors the output of the audio content based on the audio content. In some embodiments, the audio content initiated by controlling device 304 is new audio content that is different from the audio content played back by controlling device 302. For example, controlling device 302 initiated playback of movie content, which requires surround sound channels to be sent to different speakers (e.g., speaker 306, speaker 308, and/or speaker 310), and controlling device 304 initiates playback of music content, which can be outputted similarly across the different speakers (e.g., only altering volume level, speaker balancing, and/or speaker tuning rather than splitting the audio content into different channels). In some embodiments, the audio content is the same audio content but reinitiated by controlling device 304 (e.g., to modify the positioning of the output of the audio content).

In some embodiments, resident device 300 tailors the output of the audio content based on a locality of devices within room 320. As discussed above, speaker 306, speaker 308, and/or speaker 310 can localize their positions within room 320 to provide resident device 300 information for optimally playing back the audio content based on positioning of devices, subjects, and/or objects within room 320. At FIG. 3C, resident device 300 centers the audio content on controlling device 304. In some embodiments, the audio content is centered on controlling device 304 due to controlling device 304's locality within room 320 and/or controlling device 304 being the device that initiated playback of audio content (e.g., via input 305b). As discussed above, the locality of controlling device 304 can be determined based on information sent to resident device 300 by speakers within room 320 (e.g., speaker 306, speaker 308, and/or speaker 310) and/or based on information sent by controlling device 304 to resident device 300 and/or the speakers.

Similarly, as discussed above, no audio content is output within room 322. At FIG. 3C, in response to determining that controlling device 304 is within room 320 with controlling device 302, resident device 300 continues to not output audio content within room 322 (e.g., by speaker 312). In some embodiments, resident device 300 outputs audio content across multiple rooms (e.g., room 320 and/or room 322) based on information within an input, as discussed above.

As illustrated in FIG. 3D, while outputting the audio content centered on controlling device 304 (e.g., as illustrated in FIG. 3C), controlling device 304 is moved across room 320. In some embodiments, the movement of controlling device 304 is detected by detecting that controlling device 304 is at a new position (e.g., as illustrated in FIG. 3D) that is different from a previous position (e.g., as illustrated in FIG. 3C). In some embodiments, the movement of controlling device 304 is detected during transit of controlling device 304 and includes an end position of controlling device 304. In some embodiments, the movement of controlling device 304 is detected by controlling device 304 and relayed to resident device 300, detected by speaker 306, speaker 310, and/or speaker 308 (e.g., through one or more input devices of one or more of the speakers), and/or detected by resident device 300 (e.g., through one or more input devices of resident device 300 and/or through a change in signal strength between controlling device 304 and resident device 300). As discussed above, controlling device 304 can be a self-localizing device. In some embodiments, resident device 300 determines a position of controlling device 304 due to information received from speaker 306, speaker 310, and/or speaker 308, as discussed above. In some embodiments, controlling device 304 and/or resident device 300 inform a network of devices within room 320 that controlling device 304 has been repositioned, as discussed above.

As illustrated in FIG. 3D, in response to detecting the movement of controlling device 304 within room 320, resident device 300 adjusts the output of the audio content (e.g., as indicated by the difference in audio output 306a, audio output 308a, and audio output 310a between FIGS. 3C and 3D). At FIG. 3D, the output of the audio content is centered on the new location of controlling device 304 (e.g., as indicated by the positioning of audio output 306a, audio output 308a, and audio output 310a). As well, similarly to above, resident device 300 alters one or more audio characteristics of each speaker (e.g., as indicated by the change in music notes of audio output 306a, audio output 308a, and audio output 310a). In some embodiments, resident device 300 alters the output of the audio content due to controlling device 304 moving within a configuration of speakers (e.g., speaker 306, speaker 308, and/or speaker 310 assigned as channels within a home theater system). Similarly to above, resident device 300's adjustment of the output of the audio content can include adjusting volume levels, speaker balances (e.g., levels of low, mid, and/or high frequencies), and/or channel assignments (e.g., left, right, rear, and/or bass surround sound channels). Similarly, as discussed above, resident device 300 continues to not output the audio content within room 322 (e.g., by speaker 312).

As illustrated in FIG. 3E, while outputting the audio content centered on controlling device 304, controlling device 304 is moved from room 320 to room 322. As discussed above, room 320 and room 322 are separate rooms within an environment (e.g., a home) and/or separate localities within the environment (e.g., separate assignments of devices and/or separate virtual boundaries within a home). As discussed above, movement of controlling device 304 can be detected by controlling device 304, resident device 300, and/or speaker 306, speaker 308, speaker 310, and/or speaker 312. Further, as discussed above, detection can be communicated through the network to resident device 300 to provide resident device 300 information needed for optimizing the output of the audio content.

In some embodiments, room 320 and room 322 correspond to separate networks (and/or separate subsections of a network). In some embodiments, resident device 300 is a part of and/or controls both networks (e.g., for room 320 and room 322). In some embodiments, the movement of controlling device 304 can be detected through a change in networks (and/or subsections of a network). For example, as controlling device 304 is moved from room 320 to room 322, controlling device 304 is dropped from a network associated with room 320 (e.g., speaker 306, speaker 308, speaker 310, and resident device 300) and picked up by a network associated with room 322 (e.g., speaker 312 and resident device 300).

As illustrated in FIG. 3E, in response to detecting the movement of controlling device 304 from room 320 to room 322, resident device 300 adjusts the output of the audio content (e.g., as indicated by the lack of audio output 306a, audio output 308a, and audio output 310a within FIG. 3E and/or audio output 312a within room 322 at FIG. 3E). At FIG. 3E, resident device 300 ceases output of the audio content within room 320 (e.g., via speaker 306, speaker 308, and/or speaker 310) due to controlling device 304 no longer being within room 320. Further, at FIG. 3E, resident device 300 outputs the audio content within room 322, via speaker 312, due to controlling device 304 being within room 322. In some embodiments, as part of adjusting the output of the audio content, resident device 300 outputs, via speaker 306, speaker 308, speaker 310, and speaker 312, across both room 320 and room 322. In some embodiments, resident device 300 forgoes adjusting the output of the audio content. For example, in response to detecting the movement of controlling device 304 from room 320 to room 322, resident device 300 continues to output, via speaker 306, speaker 308, and/or speaker 310, within room 320 (and/or not within room 322 via speaker 312).

At FIG. 3E, while outputting the audio content via speaker 312, resident device 300 detects input 305e. In some embodiments, input 305e is a tap input on resident device 300. For example, input 305e can be an input interacting with a user interface and/or control on resident device 300 that can initiate playback of the audio content within room 320. Similarly to above, it should be recognized that input 305e can be other types of inputs. For example, input 305e can be a verbal input (e.g., “Play today's top hits radio”) requesting playback of the audio content within room 320 that is detected by one or more devices within room 320 (e.g., speaker 306, speaker 308, and speaker 310) and determined to be closest to resident device 300.

As illustrated in FIG. 3F, in response to detecting input 305e, resident device 300 outputs, via speaker 308 and speaker 310, audio content within room 320 (e.g., as indicated by audio output 308a and audio output 310a). In some embodiments, resident device 300 outputs the audio content via speaker 308 and speaker 310 due to resident device 300's locality. As discussed above, the locality of resident device 300 can be based on resident device 300's position within the environment (e.g., position within room 320) and/or in relation to one or more other devices (e.g., speaker 306, speaker 308, and/or speaker 310). As illustrated in FIG. 3F, resident device 300 does not output any audio content via speaker 306 (e.g., as indicated by the lack of a music note radiating away from speaker 306). In some embodiments, resident device 300 does not output any audio content via speaker 306 due to a distance to resident device 300 being greater than a threshold. In some embodiments, resident device 300 does not output any audio content via speaker 306 due to a predefined configuration. For example, speaker 308 and speaker 310 are assigned as default speakers for resident device 300 (e.g., in addition to and/or in place of resident device 300's one or more output devices). In some embodiments, resident device 300 does not output any audio content via speaker 306 due to the audio content's type. For example, the audio content initiated by input 305e on resident device 300 is a different type than the audio content initiated by controlling device 304.

Further, as illustrated in FIG. 3F, speaker 312 continues to output the audio content initiated by controlling device 304. In some embodiments, the audio content in room 322 continues to be output by speaker 312 due to being in a sperate locality and/or room than resident device 300. In some embodiments, the output of the audio content initiated by controlling device 304 is unaffected by the output of audio content within room 320. For example, the output of the audio content is linked to an initiating device (e.g., controlling device 302, controlling device 304, and/or resident device 300) and the room the initiating device is within (e.g., room 320 and/or room 322) regardless of other audio content playback within other rooms. In some embodiments, the audio content initiated by controlling device 304 is no longer output due to the output of the audio content initiated by resident device 300. For example, resident device 300 only outputs one instance of audio content and/or resident device 300 outputs audio content across both rooms.

As illustrated in FIG. 3G, while outputting, via speaker 308 and speaker 310, the audio content centered on resident device 300, controlling device 302 is moved across room 320. As discussed above, the movement of controlling device 302 can be detected by controlling device 302, resident device 300, and/or speaker 306, speaker 308, and/or speaker 310. Further, due to speaker 306, speaker 308, and speaker 310 being self-localizing devices, resident device 300 receives information from speaker 306, speaker 308, and speaker 310 and can detect the movement of controlling device 302 (e.g., change in locality within room 320) without receiving information from controlling device 302. As discussed above, resident device 300 is able to receive the information from speaker 306, speaker 308, and speaker 310 due to being connected to and/or managing the network of devices.

As illustrated in FIG. 3G, in response to detecting the movement of controlling device 302, resident device 300 does not adjust the output of the audio content. In some embodiments, resident device 300 does not adjust the output of the audio content due to controlling device 302 not being the initiator of the audio content and/or controlling device not actively playing back audio content within room 320.

At FIG. 3G, after controlling device 302 is moved across room 320, resident device 300 detects input 305g. In some embodiments, input 305g is an input initiating playback of audio content within room 320. For example, input 305g is a tap input on controlling device 302, such as an input interacting with a user interface and/or application on controlling device 302 that can initiate playback of the audio content within room 320. In such an example, resident device 300 detects input 305g in response to receiving a notification of input 305g from controlling device 302. Similarly to above, it should be recognized that input 305g can be other types of inputs. For example, input 305g can be a verbal input requesting playback of the audio content within room 320 that is detected by one or more devices within room 320 (e.g., speaker 306, speaker 308, and speaker 310) and determined to be closest to controlling device 302. In some embodiments, input 305g is an input to adjust the output of the audio content (e.g., adjusting positionality of the audio content and/or one or more audio characteristics of the audio content but not changing the audio content). For example, input 305g directed to controlling device 302 is an input to move the output of the audio content to a different configuration of speakers within room 320 (e.g., a home theater system made up of speaker 306, speaker 308, and/or speaker 310).

As illustrated in FIG. 3H, in response to detecting input 305g, resident device 300 adjusts, via speaker 306, speaker 308, and speaker 310, the output of the audio content (e.g., as indicated by audio output 306a, audio output 308a, and audio output 310a centered on controlling device 302 and altered music notes as compared to FIG. 3G). As well, as compared to FIG. 3G, speaker 306 is reactivated. In some embodiments, speaker 306 is added back to the set of outputting speakers due to proximity to controlling device 302, due to a speaker configuration (e.g., home theater system and/or network of speakers), and/or due to previously outputting (e.g., previously outputting by an initiation from controlling device 302 as illustrated in FIG. 3B).

While outputting the audio content, via speaker 306, speaker 308, and speaker 310, speaker 314 is added to room 320. At FIG. 3H, similar to detecting movement of a device within room 320 and/or room 322, the presence of speaker 314 can be detected by resident device 300 (e.g., detecting a signal from a new and/or unknown device), controlling device 302, and/or one or more of the speakers with room 320 (e.g., speaker 306, speaker 308, and speaker 310). In some embodiments, as part of being added to room 320, speaker 314 sends to resident device 300 (e.g., directly and/or via a network) identification information (e.g., information about speaker 314 including unique identifiers, model numbers, and/or communication identifiers), positional information (e.g., image information, audio information, depth mapping, and/or locality information such as proximity to certain items and/or devices within room 320), and/or capabilities (e.g., configuration capabilities, output capabilities, and/or communication protocol capabilities).

In some embodiments, speaker 314 is a self-localizing device, as discussed above. As discussed above, due to being a self-localizing device, speaker 314 by itself (e.g., through one or more input devices of speaker 314 such as one or more cameras and/or one or more microphones) and/or with resident device 300 determines a locality associated with speaker 314. For example, resident device 300 utilizes image and/or audio information received from speaker 314 (and/or information received from speaker 306, speaker 308, and/or speaker 310) to determine speaker 314's position with room 320 and/or speaker 314's relationship to one or other devices within room 320 (e.g., speaker 306, speaker 308, and/or speaker 310. In some embodiments, as part of being added to room 320, speaker 314 initiates a setup process for being added to a network (e.g., as discussed above) and/or a configuration of devices (e.g., adding a new audio channel to an existing home theater system).

As illustrated in FIG. 3H, in response to detecting the presence of speaker 314 in room 320, resident device 300 adjusts the output of the audio content to include speaker 314 (e.g., as indicated by audio output 314a). At FIG. 3H, resident device 300 synchronizes the output of the audio content across all speakers within room 320 (e.g., speaker 306, speaker 308, speaker 310, and/or speaker 314). Further, resident device 300 alters the output of the audio content by speaker 306, speaker 308, and speaker 310 to, in some embodiments, provide an optimal audio experience with the inclusion of speaker 314. In some embodiments, resident device 300 alters the output of the audio content based on speaker 314's locality (e.g., as discussed above) within room 320. For example, resident device 300 alters the output of the audio content due to speaker 314 being too close to a wall and/or occluded behind an object within room 320. In some embodiments, resident device 300 alters the output of the audio content based on a relationship of speaker 314 to the other devices within room 320 (e.g., speaker 306, speaker 308, and/or speaker 310). For example, resident device 300 alters the output of the audio content due to speaker 314 being too close to speaker 308. In some embodiments, resident device 300 adjusts the output of the audio content to include speaker 314 by altering existing audio channels. For example, resident device can split a rear channel between a rear left channel for speaker 310 and a rear right channel for speaker 314. In some embodiments, resident device 300 adjusts the output of the audio content to include speaker 314 by adding new audio channels. For example, resident device 300 can assign a height surround sound channel and/or a subwoofer surround channel to speaker 314 (e.g., depending on speaker 314's capabilities). In some embodiments, resident device 300 adjusting the output of the audio content to include speaker 314 by adjusting directionality of the audio content (e.g., as indicated by the different positions of audio output 310a and audio output 308a between FIG. 3G and FIG. 3H).

In some embodiments, additional speakers can be added to room 320 and/or room 322 in a similar fashion. Similar to above, in response to detecting presence of another speaker within room 322, resident device 300 adjusts the output of audio content within room 322 (e.g., similarly to the adjustments within room 320 due to speaker 314). For example, resident device 300 can split the audio output of speaker 312 into two channels by providing a first channel to speaker 312 and a second channel to the new speaker within room 322.

In some embodiments, removal of speakers can cause resident device 300 to adjust the output of the audio content. Similar to above, in response to detecting removal of speaker 314 from room 320 (and/or movement of speaker 314 from room 320 to room 322), resident device 300 adjusts the output of the audio content within room 320. For example, resident device 300 reverts the output of the audio content within room 320 to its previous configuration when room 320 only included speaker 306, speaker 308, and speaker 310.

At FIG. 3H, while outputting via speaker 306, speaker 308, speaker 310, and speaker 314, resident device 300 determines that the speakers (e.g., speaker 306, speaker 308, speaker 310, and speaker 314) are not in an optimal configuration and/or that there is a better configuration. In some embodiments, resident device 300 determines that the speakers are not in an optimal configuration and/or that there is a better configuration based on an input to optimize the speakers within room 320. For example, in response to detecting an input directed to a speaker placement control (e.g., a user-interface element on resident device 300 that enables speaker optimization and/or reconfiguration), resident device 300 determines that the speakers are not in an optimal configuration. In some embodiments, resident device 300 determines that a speaker is not in an optimal configuration and/or that there is a better configuration upon the speaker completing an initial setup and/or pairing. For example, after a speaker is placed within room 320 and paired with resident device 300, resident device 300 determines that the speaker and/or speakers are not in an optimal configuration. In some embodiments, resident device 300 determines that the speakers are not in an optimal configuration and/or that there is a better configuration due to the speakers being self-localizing devices, as discussed above. In some embodiments, resident device 300 utilizes image information and/or audio information received from the speakers to (e.g., as discussed above) determine that the speakers are not in an optimal configuration and/or that there is a better configuration. For example, resident device 300 generates a mapping of the speakers within room 320 (e.g., from image and/or audio information received from speaker 306, speaker 308, speaker 310 and/or speaker 314) and utilizes the mapping along with information about the output of the audio content from each speaker to determine that one or more speakers are not outputting optimally and/or that there is a better configuration (e.g., one or more speakers are occluded by an object and/or one or more speakers are not properly spaced to provide different surround sound channels). In some embodiments, resident device 300 utilizes information received from the speakers along with predefined guidelines and/or configurations to determine that the speakers are not in an optimal configuration and/or that there is a better configuration. For example, a guideline can include that left and right surround channels should be a threshold distance away from each other and/or channels should be a certain distance from each other based on room 320's size.

At FIG. 3H, in response to determining that the speakers are not in an optimal configuration and/or that there is a better configuration, resident device 300 outputs a prompt (e.g., visually and/or audibly) recommending a repositioning of speaker 314. In some embodiments, outputting the prompt includes resident device 300 displaying a mapping (e.g., an interactive recreation) of room 320 including the recommended repositioning of speaker 314. Similarly to the determination that the speakers are not in an optimal orientation and/or positioning, resident device 300 utilizes information from speaker 306, speaker 308, speaker 310, and/or speaker 314 to determine a recommended repositioning of speaker 314. In some embodiments, resident device 300 determines the repositioning based on speaker 314 (e.g., based on image and/or audio information received from speaker 314). For example, resident device 300 can recommend different positions within room 320 based on speaker type, such as a first positioning due to speaker 314 being a subwoofer or a second positioning due to speaker 314 being a satellite speaker. For another example, resident device 300 can recommend a repositioning of speaker 314 due to an object within and/or feature of room 320, such as moving speaker 314 out from behind an object and/or away from a wall. In some embodiments, resident device 300 determines the repositioning based on speaker 314's relationship with speaker 306, speaker 308, and/or speaker 310. For example, resident device 300 recommends repositioning speaker 314 a certain distance away from speaker 308 and/or speaker 310 to provide better surround sound channel separation (e.g., provide better clarity between left and right channels and/or front and rear channels).

As illustrated in FIG. 3I, after outputting the prompt recommending the repositioning of speaker 314, speaker 314 is moved across room 320 to a recommended location. Similar to the movement of devices discussed above, the movement of speaker 314 can be detected by speaker 314 (e.g., sent to resident device 300), resident device 300, and/or speaker 306, speaker 308, and/or speaker 310.

At FIG. 3I, in response to detecting the movement of speaker 314, resident device 300 adjusts, via speaker 306, speaker 308, speaker 310, and speaker 314, the output of the audio content (e.g., as indicated by audio output 306a, audio output 308a, audio output 310a, and audio output 312a as compared to FIG. 3H). Similar to the adjustments of the output of the audio content discussed above, resident device 300 can alter volume levels, assigned channels, speaker balancing, and/or directionality of the speakers (e.g., speaker 306, speaker 308, speaker 310, and/or speaker 312). Further, due to the inclusion of speaker 314, resident device 300 considers speaker 314 within the determination on how to adjust the output of the audio content.

At FIG. 3I, while outputting in the new arrangement, resident device 300 detects a further optimization of the output of the audio content (e.g., as discussed above), and outputs a prompt recommending a repositioning of speaker 310 within room 320. Similarly to the repositioning of speaker 314, resident device 300 can determine the recommended repositioning of speaker 310 based on speaker 310 (e.g., speaker type and/or environment factor corresponding to speaker 310 such as being occluded by an object) and/or speaker 310's relationship with one or more other speakers within room 320 (e.g., distance from speaker 314 and/or misalignment of speaker 310 as compared to a speaker configuration including speaker 306, speaker 308, and speaker 314). Notably, resident device 300 recommends repositioning of an existing speaker (e.g., speaker 310) as compared to repositioning a new speaker (e.g., speaker 314) due to already repositioning the new speaker and/or determining that the positioning of the new speaker is more optimal than the positioning of the existing speaker. Alternatively, resident device 300 can determine that multiple optimizations are required and provides the repositioning of each speaker serially.

As illustrated in FIG. 3J, after outputting the prompt recommending a repositioning of speaker 310, speaker 310 is moved across room 320. Similar to the movement of devices discussed above, the movement of speaker 310 can be detected by speaker 310 (e.g., sent to resident device 300), resident device 300, and/or speaker 306, speaker 308, and/or speaker 314. As discussed above, resident device 300 can receive information from speaker 310, via the network of devices, and determine speaker 310's new position within room 320 and/or in relation to speaker 306, speaker 308, and speaker 314. Similarly, the other speakers within room 320 (e.g., speaker 306, speaker 308, and/or speaker 314) can send information to resident device 300 due to the other speakers being self-localizing devices, and resident device 300 can utilize the information to determine speaker 310's new position within room 320.

As illustrated in FIG. 3J, in response to detecting the movement of speaker 310, resident device 300 adjusts, via speaker 306, speaker 308, speaker 310, and speaker 312, the output of the audio content (e.g., as indicated by audio output 306a, audio output 308a, audio output 310a, and audio output 312a as compared to FIG. 3I). Similar to the adjustments of the output of the audio content discussed above, resident device 300 can alter volume levels, assigned channels, speaker balancing, and/or directionality of the speakers (e.g., speaker 306, speaker 308, speaker 310, and/or speaker 312).

In some embodiments, while FIGS. 3I-3J discuss prompting movement of speakers within the environment to optimize the playback of the audio content, it should be recognized that detecting certain audio characteristics after playing back audio content can cause adjustment of the audio content. In some embodiments, after adjusting and/or while outputting, via speaker 306, speaker 308, speaker 310, speaker 312, and/or speaker 314, audio content, resident device 300 detects a need for optimizing the output of the audio content with room 320 and/or room 322. For example, while outputting, via speaker 306, speaker 308, speaker 310, and speaker 314, the audio content, resident device 300 can determine (e.g., based on image information and/or audio information from speaker 306, speaker 308, speaker 310, and/or speaker 314) that speaker 310's output is muffled due to being occluded behind an object, and in response, resident device 300 can alter the output, from the other speakers (e.g., speaker 306, speaker 308, and/or speaker 314), of the audio content to compensate for the occlusion of speaker 310.

FIG. 4 is a flow diagram illustrating a process (e.g., process 400) for altering output of audio content based on initiating device in accordance with some embodiments. Some operations in process 400 are, optionally, combined, the orders of some operations are, optionally, changed, and some operations are, optionally, omitted.

As described below, process 400 provides an intuitive way for altering output of audio content based on initiating device. Process 400 reduces the cognitive burden on a user, thereby creating a more efficient human-machine interface. For battery-operated computing devices, enabling a user to interact with such devices faster and more efficiently conserves power and increases the time between battery charges.

In some embodiments, process 400 is performed at a resident device (e.g., 300) (e.g., a device that is permanently installed within a location and/or is part of a connected network at the location, a device that is actively connected to a network at a location and/or consistently part of a network at a location, an always-on device at a location, a permanent device, a connected-home device, a smart-home fixture, a core device, a home-hub device, a persistent device, a network device, an in-home node, an active device, a connected node, a local device, a resident node, a device that communicates with one or more accessory devices on behalf of one or more controller devices, a home-based device, a fixed-location device and/or a device). In some embodiments, the resident device is a computer system, a watch, a phone, a tablet, a fitness tracking device, a processor, a head-mounted display (HMD) device, a communal device, a media device, a speaker, a television, an electronic device, and/or a personal computing device.

The resident device receives (402), from a respective device (e.g., 302 and/or 304), an input (e.g., 305a and/or 305b) corresponding to a request to initiate playback of audio content (e.g., as discussed above with respect to FIG. 3B) (e.g., a song, a movie, a podcast, and/or an audio recording). In some embodiments, the respective device is the resident device. In some embodiments, the respective device is separate from the resident device. In some embodiments, the input corresponding to the request to initiate playback of the audio content includes an identification of the audio content. In some embodiments, the input corresponding to the request to initiate playback of the audio content includes an identification of a position (e.g., location and/or orientation) of the respective device.

In response to (404) receiving the input corresponding to the request to initiate playback of the audio content, in accordance with a determination that a first set of one or more criteria is satisfied (e.g., as discussed above with respect to FIG. 3A), wherein the first set of one or more criteria includes a criterion that is satisfied when the respective device is a first device (e.g., 302) (e.g., a first type of device, a device at a first position, a device with a first relationship with the resident device, a device with a first relationship with one or more accessory devices, and/or a device with a first relationship with one or more external devices), the resident device outputs (406), via multiple output devices (e.g., 306, 308, 310, 312, and/or 314), the audio content in a first manner (e.g., as indicated by 306a, 308a, and/or 310a at FIG. 3B) (e.g., with a first set of one or more audio characteristics and/or with a first set of one or more content characteristics). In some embodiments, outputting the audio content in the first manner includes altering one or more audio characteristics (e.g., volume, channel, frequence, directionality, EQ, and/or surround type) of output of the audio content. In some embodiments, the multiple output devices include a first output device and a second output device external to the first output device. In some embodiments, the multiple output devices include a speaker, a smart speaker, a home theater system, a soundbar, a headphone, an earphone, an earbud, a television speaker, an augmented reality headset speaker, an audio jack, an optical audio output, a Bluetooth audio output, and/or an HDMI audio output. In some embodiments, the first output device is a speaker, a smart speaker, a home theater system, a soundbar, a headphone, an earphone, an earbud, a television speaker, an augmented reality headset speaker, an audio jack, an optical audio output, a Bluetooth audio output, or an HDMI audio output.

In response to (404) receiving the input corresponding to the request to initiate playback of the audio content, in accordance with a determination that a second set of one or more criteria is satisfied, wherein the second set of one or more criteria includes a criterion that is satisfied when the respective device is a second device (e.g., 304) (e.g., a second type of device different from the first type of device, a device at a second position different from the first position, a device with a second relationship with the resident device different from the first relationship with the resident device, a device with a second relationship with the one or more accessory devices different from the first relationship with the one or more accessory devices, and/or a device with a second relationship with the one or more external devices different from the first relationship with the one or more external devices), the resident device outputs (408), via the multiple output devices, the audio content in a second manner (e.g., as indicated by 306a, 308a, and/or 310a at FIG. 3C) (e.g., with a second set of one or more audio characteristics and/or with a second set of one or more content characteristics) different from the first manner, wherein the second device is different (e.g., different in type of device, different in locality of device, difference in relationship to the resident device, different in relationship with the one or more accessory devices, and/or different in relationship with the one or more external devices) from the first device, and wherein the second set of one or more criteria is different from the first set of one or more criteria. In some embodiments, the second output device is a speaker, a smart speaker, a home theater system, a soundbar, a headphone, an earphone, an earbud, a television speaker, an augmented reality headset speaker, an audio jack, an optical audio output, a Bluetooth audio output, or a HDMI audio output. In some embodiments, outputting the audio content in the second manner includes maintaining output of the audio content (e.g., forgoing alteration of output of the audio content) and/or altering one or more audio characteristics (e.g., volume, channel, frequence, directionality, EQ, and/or surround type) of the output of the audio content.

In some embodiments, before (and/or while) receiving the input corresponding to the request to initiate playback of the audio content, the resident device receives, from the multiple output devices, visual media (e.g., as discussed above with respect to FIG. 3A) (e.g., from cameras of the multiple output devices). In some embodiments, the visual media includes image data, video data, raw image data, processed image data such as depth information, key point information, object recognition information, and/or location recognition information. In some embodiments, after (and/or while) receiving the visual media, the resident device identifies, based on the visual media, a respective locality (e.g., as discussed above with respect to FIG. 3A) (e.g., a layout within an area, a relative position, and/or a relative positioning) corresponding to (e.g., of associated with, pertaining to, and/or for) the multiple output devices, wherein the first set of one or more criteria includes a criterion that is satisfied based on the respective locality corresponding to the multiple output devices (and/or when the respective locality corresponding to the multiple output devices aligns with a predefined configuration). In some embodiments, the respective locality corresponding to the multiple output devices is a mapping of devices (e.g., location within 3D space and/or relative position within an environment) included in the multiple output devices in relation to each other, the resident device, and/or key points within an environment (e.g., walls, furniture, other devices, and/or temporary objects). In some embodiments, the resident device identifies the respective locality corresponding to the multiple output devices by compiling and/or processing the visual media (e.g., building a 3D mapping of the multiple devices within an environment, recognizing positional relationships between devices, resident device, and/or objects within the environment, and/or mapping depth through a combination of image information). In some embodiments, in response to receiving the input corresponding to the request to initiate playback of the audio content, in accordance with a determination that a third set of one or more criteria is satisfied, wherein the third set of one or more criteria includes a criterion that is satisfied when the respective locality corresponding to the multiple output devices is a first locality (e.g., as discussed above with respect to FIG. 3B), the resident device outputs, via the multiple output devices, the audio content in a third manner (e.g., as indicated by 306a, 308a, and/or 310a) (e.g., with a second set of one or more audio characteristics and/or with a second set of one or more content characteristics) different from the first manner. In some embodiments, outputting the audio content in the third manner includes altering one or more audio characteristics (e.g., volume, channel, frequence, directionality, EQ, and/or surround type) of output of the audio content. In some embodiments, the third set of one or more criteria includes the first set of one or more criteria or the second set of one or more criteria. In some embodiments, in response to receiving the input corresponding to the request to initiate playback of the audio content, in accordance with a determination that a fourth set of one or more criteria is satisfied, wherein the fourth set of one or more criteria includes a criterion that is satisfied when the respective locality corresponding to the multiple output devices is a second locality (e.g., as discussed above with respect to FIG. 3C), the resident device outputs, via the multiple output devices, the audio content in a fourth manner (e.g., as indicated by 306a, 308a, and/or 310a) (e.g., with a third set of one or more audio characteristics and/or with a third set of one or more content characteristics) different from the third manner, wherein the third set of one or more criteria is different from the fourth set of one or more criteria, and wherein the second locality is different from the first locality. In some embodiments, outputting the audio content in the fourth manner includes maintaining output of the audio content (e.g., forgoing alteration of output of the audio content) and/or altering one or more audio characteristics (e.g., volume, channel, frequence, directionality, EQ, and/or surround type) of the output of the audio content. In some embodiments, the fourth set of one or more criteria includes the first set of one or more criteria or the second set of one or more criteria.

In some embodiments, before (and/or while) receiving the input corresponding to the request to initiate playback of the audio content, the resident device receives, from the multiple output devices, audio media (e.g., as discussed above with respect to FIG. 3A) (e.g., detected by one or more of the multiple output devices), wherein the third set of one or more criteria includes a criterion that is satisfied when the audio media aligns with a first audio pattern (e.g., as discussed above with respect to FIG. 3A), and wherein the fourth set of one or more criteria includes a criterion that is satisfied when the audio media aligns with a second audio pattern (e.g., as discussed above with respect to FIG. 3A) different from the first audio pattern. In some embodiments, the resident device utilizes both the audio media and the visual media to identify the locality corresponding to the multiple output devices (e.g., using a magnitude of volume and/or a volume reference to determine distance to an output device, using audio patterns to determine characteristics of objects within the environment such as material, and/or using the audio media and/or the visual media to check and/or correct missing information from the audio media and/or the visual media).

In some embodiments, in response to receiving the input corresponding to the request to initiate playback of the audio content, in accordance with a determination that a fifth set of one or more criteria is satisfied, wherein the fifth set of one or more criteria includes a criterion that is satisfied when a respective locality (e.g., as discussed above with respect to FIG. 3A) of the respective device (e.g., the first device and/or the second device) within an area is a first locality (e.g., as discussed above with respect to FIG. 3B), the resident device outputs, via the multiple output devices, the audio content in a fifth manner (e.g., as indicated by 306a, 308a, and/or 310a) different from the first manner. In some embodiments, outputting the audio content in the fifth manner includes altering one or more audio characteristics (e.g., volume, channel, frequence, directionality, EQ, and/or surround type) of output of the audio content. In some embodiments, the fifth set of one or more criteria includes the first set of one or more criteria, the second set of one or more criteria, the third set of one or more criteria, or the fourth set of one or more criteria. In some embodiments, in response to receiving the input corresponding to the request to initiate playback of the audio content, in accordance with a determination that a sixth set of one or more criteria is satisfied, wherein the sixth set of one or more criteria includes a criterion that is satisfied when the respective locality of the respective device (e.g., the first device and/or the second device) within the area is a second locality (e.g., as discussed above with respect to FIG. 3C), the resident device outputs, via the multiple output devices, the audio content in a sixth manner (e.g., as indicated by 306a, 308a, and/or 310a) different from the fifth manner, wherein the fifth set of one or more criteria is different from the sixth set of one or more criteria, and wherein the second locality is different from the first locality. In some embodiments, the respective locality is a mapping of the respective device (e.g., location within 3D space and/or relative position within an environment) in relation to the resident device, one or more of the multiple devices, and/or key points within an environment (e.g., walls, furniture, other devices, and/or temporary objects). In some embodiments, outputting the audio content in the sixth manner includes maintaining output of the audio content (e.g., forgoing alteration of output of the audio content) and/or altering one or more audio characteristics (e.g., volume, channel, frequence, directionality, EQ, and/or surround type) of the output of the audio content. In some embodiments, the sixth set of one or more criteria includes the first set of one or more criteria, the second set of one or more criteria, the third set of one or more criteria, or the fourth set of one or more criteria.

In some embodiments, the respective locality of the respective device within the area is the first locality when a relationship (e.g., as discussed above with respect to FIG. 3A) between the respective device and the multiple output devices aligns with a first relationship (e.g., as discussed above with respect to FIG. 3B). In some embodiments, the respective locality of the respective device within the area is the second locality when the relationship between the respective device and the multiple output device aligns with a second relationship (e.g., as discussed above with respect to FIG. 3C) different from the first relationship. In some embodiments, the relationship between the respective device and the multiple output devices is a positional relationship based on a difference in position within the area of the resident device and the respective device.

In some embodiments, in response to receiving the input corresponding to the request to initiate playback of the audio content, in accordance with a determination that a seventh set of one or more criteria is satisfied, wherein the seventh set of one or more criteria includes a criterion that is satisfied when a respective locality (e.g., as discussed above with respect to FIG. 3A) of the resident device is a first locality (e.g., as discussed above with respect to FIG. 3B), the resident device outputs, via the multiple output devices, the audio content in a seventh manner (e.g., as indicated by 306a, 308a, and/or 310a) different from the first manner. In some embodiments, outputting the audio content in the seventh manner includes altering one or more audio characteristics (e.g., volume, channel, frequence, directionality, EQ, and/or surround type) of output of the audio content. In some embodiments, the seventh set of one or more criteria includes the first set of one or more criteria, the second set of one or more criteria, the third set of one or more criteria, the fourth set of one or more criteria, the fifth set of one or more criteria, or the sixth set of one or more criteria. In some embodiments, in response to receiving the input corresponding to the request to initiate playback of the audio content, in accordance with a determination that an eighth set of one or more criteria is satisfied, wherein the eighth set of one or more criteria includes a criterion that is satisfied when the respective locality of the resident device is a second locality (e.g., as discussed above with respect to FIG. 3C), the resident device outputs via the multiple output devices, the audio content in an eighth manner (e.g., as indicated by 306a, 308a, and/or 310a) different from the seventh manner, wherein the seventh set of one or more criteria is different from the eighth set of one or more criteria, and wherein the second locality is different from the first locality. In some embodiments, the respective locality of the resident device is the resident device's position within an environment and/or relative positioning of the resident device in comparison to the respective device and/or one or more of the multiple output devices. In some embodiments, the respective locality of the resident device is a mapping of the resident device's relationship with key points and/or locations within an environment (e.g., boundaries, walls, furniture, and/or other devices). In some embodiments, outputting the audio content in the eighth manner includes maintaining output of the audio content (e.g., forgoing alteration of output of the audio content) and/or altering one or more audio characteristics (e.g., volume, channel, frequence, directionality, EQ, and/or surround type) of the output of the audio content. In some embodiments, the eighth set of one or more criteria includes the first set of one or more criteria, the second set of one or more criteria, the third set of one or more criteria, the fourth set of one or more criteria, the fifth set of one or more criteria, or the sixth set of one or more criteria.

In some embodiments, in response to receiving the input corresponding to the request to initiate playback of the audio content, in accordance with a determination that a ninth set of one or more criteria is satisfied, wherein the ninth set of one or more criteria includes a criterion that is satisfied when a total number of devices (e.g., as discussed above with respect to FIG. 3A) (e.g., including the resident device, the respective device, and/or the multiple output devices) within an area is greater than a threshold number of devices (e.g., as discussed above with respect to FIG. 3A), the resident device outputs, via the multiple output devices, the audio content in a ninth manner (e.g., as indicated by 306a, 308a, and/or 310a) different from the first manner. In some embodiments, outputting the audio content in the ninth manner includes altering one or more audio characteristics (e.g., volume, channel, frequence, directionality, EQ, and/or surround type) of output of the audio content. In some embodiments, the ninth set of one or more criteria includes the first set of one or more criteria, the second set of one or more criteria, the third set of one or more criteria, the fourth set of one or more criteria, the fifth set of one or more criteria, the sixth set of one or more criteria, the seventh set of one or more criteria, or the eighth set of one or more criteria. In some embodiments, in response to receiving the input corresponding to the request to initiate playback of the audio content, in accordance with a determination that a tenth set of one or more criteria is satisfied, wherein the tenth set of one or more criteria includes a criterion that is satisfied when the total number of devices within the area is less than the threshold number of devices (e.g., as discussed above with respect to FIG. 3A), the resident device outputs, via the multiple output devices, the audio content in a tenth manner (e.g., as indicated by 306a, 308a, and/or 310a) different from the ninth manner, wherein the ninth set of one or more criteria is different from the tenth set of one or more criteria. In some embodiments, the total number of devices within the area depends on a configuration of the devices within the area (e.g., an arrangement within a sound system and/or home theater system and/or categorization of the devices within groupings within the area such as theater devices and/or music devices). In some embodiments, outputting the audio content in the tenth manner includes maintaining output of the audio content (e.g., forgoing alteration of output of the audio content) and/or altering one or more audio characteristics (e.g., volume, channel, frequence, directionality, EQ, and/or surround type) of the output of the audio content. In some embodiments, the tenth set of one or more criteria includes the first set of one or more criteria, the second set of one or more criteria, the third set of one or more criteria, the fourth set of one or more criteria, the fifth set of one or more criteria, the sixth set of one or more criteria, the seventh set of one or more criteria, or the eighth set of one or more criteria.

In some embodiments, in response to receiving the input corresponding to the request to initiate playback of the audio content, in accordance with a determination that an eleventh set of one or more criteria is satisfied, wherein the eleventh set of one or more criteria includes a criterion that is satisfied when the respective device is a first type of device (e.g., as discussed above with respect to FIG. 3B), the resident device outputs, via the multiple output devices, the audio content in an eleventh manner (e.g., as indicated by 306a, 308a, and/or 310a) different from the first manner. In some embodiments, outputting the audio content in the eleventh manner includes altering one or more audio characteristics (e.g., volume, channel, frequence, directionality, EQ, and/or surround type) of output of the audio content. In some embodiments, the eleventh set of one or more criteria includes the first set of one or more criteria, the second set of one or more criteria, the third set of one or more criteria, the fourth set of one or more criteria, the fifth set of one or more criteria, the sixth set of one or more criteria, the seventh set of one or more criteria, the eighth set of one or more criteria, the ninth set of one or more criteria, or the tenth set of one or more criteria. In some embodiments, in response to receiving the input corresponding to the request to initiate playback of the audio content, in accordance with a determination that a twelfth set of one or more criteria is satisfied, wherein the twelfth set of one or more criteria includes a criterion that is satisfied when the respective device is a second type of device (e.g., as discussed above with respect to FIG. 3C), the resident device outputs, via the multiple output devices, the audio content in an twelfth manner (e.g., as indicated by 306a, 308a, and/or 310a) different from the eleventh manner, wherein the eleventh set of one or more criteria is different from the twelfth set of one or more criteria, and wherein the second type of device is different from the first type of device. In some embodiments, the type of device corresponds to assignment (e.g., included within a home theater system, only for a certain type of media, and/or only for a certain user and/or subject), audio channel (e.g., left, right, center, bass, mid, and/or high) and/or configuration (e.g., an equalizer setting for a device and/or a balance setting for a device), number of speakers within the device, type of speaker, and/or capability of the device (e.g., processing capabilities, connected input devices, and/or communication capabilities). In some embodiments, outputting the audio content in the twelfth manner includes maintaining output of the audio content (e.g., forgoing alteration of output of the audio content) and/or altering one or more audio characteristics (e.g., volume, channel, frequence, directionality, EQ, and/or surround type) of the output of the audio content. In some embodiments, the twelfth set of one or more criteria includes the first set of one or more criteria, the second set of one or more criteria, the third set of one or more criteria, the fourth set of one or more criteria, the fifth set of one or more criteria, the sixth set of one or more criteria, the seventh set of one or more criteria, the eighth set of one or more criteria, the ninth set of one or more criteria, or the tenth set of one or more criteria.

In some embodiments, in response to receiving the input corresponding to the request to initiate playback of the audio content, in accordance with a determination that a thirteenth set of one or more criteria is satisfied, wherein the thirteenth set of one or more criteria includes a criterion that is satisfied when the audio content is a first type of content (e.g., as discussed above with respect to FIG. 3B), the resident device outputs, via the multiple output devices, the audio content in a thirteenth manner (e.g., as indicated by 306a, 308a, and/or 310a) different from the first manner. In some embodiments, outputting the audio content in the thirteenth manner includes altering one or more audio characteristics (e.g., volume, channel, frequence, directionality, EQ, and/or surround type) of output of the audio content. In some embodiments, the thirteenth set of one or more criteria includes the first set of one or more criteria, the second set of one or more criteria, the third set of one or more criteria, the fourth set of one or more criteria, the fifth set of one or more criteria, the sixth set of one or more criteria, the seventh set of one or more criteria, the eighth set of one or more criteria, the ninth set of one or more criteria, the tenth set of one or more criteria, the eleventh set of one or more criteria, or the twelfth set of one or more criteria. In some embodiments, in response to receiving the input corresponding to the request to initiate playback of the audio content, in accordance with a determination that a fourteenth set of one or more criteria is satisfied, wherein the fourteenth set of one or more criteria includes a criterion that is satisfied when the audio content is a second type of content (e.g., as discussed above with respect to FIG. 3C), the resident device outputs, via the multiple output devices, the audio content in a fourteenth manner (e.g., as indicated by 306a, 308a, and/or 310a) different from the thirteenth manner, wherein the thirteenth set of one or more criteria is different from the fourteenth set of one or more criteria, and wherein the second type of content is different from the first type of content. In some embodiments, the type of content corresponds to a type of media (e.g., music, visual entertainment, and/or speech from a voice assistant) and/or audio channel (e.g., left, right, center, bass, mid, and/or high). In some embodiments, outputting the audio content in the fourteenth manner includes maintaining output of the audio content (e.g., forgoing alteration of output of the audio content) and/or altering one or more audio characteristics (e.g., volume, channel, frequence, directionality, EQ, and/or surround type) of the output of the audio content. In some embodiments, the fourteenth set of one or more criteria includes the first set of one or more criteria, the second set of one or more criteria, the third set of one or more criteria, the fourth set of one or more criteria, the fifth set of one or more criteria, the sixth set of one or more criteria, the seventh set of one or more criteria, the eighth set of one or more criteria, the ninth set of one or more criteria, the tenth set of one or more criteria, the eleventh set of one or more criteria, or the twelfth set of one or more criteria.

In some embodiments, outputting the audio content in the first manner includes separating the audio content into a first audio channel (e.g., as discussed above with respect to FIG. 3A) (e.g., left, right, center, bass, mid, and/or high) and a second audio channel (e.g., as discussed above with respect to FIG. 3A) separate (and/or different) from the first audio channel (e.g., left, right, center, bass, mid, and/or high). In some embodiments, the difference between the first audio channel and the second audio channel corresponds to different apportionments of one or more audio channels (e.g., outputting a percentage of a right channel and a percentage of a bass channel) and/or completely different assignments of audio channels.

In some embodiments, the multiple output devices are configured as (e.g., a part of and/or belong to) a multi-channel audio system (e.g., as discussed above with respect to FIG. 3A) (e.g., surround sound system, home theater system, and/or multi-speaker sound system). In some embodiments, outputting the audio content in the first manner includes sending (and/or assigning) a first audio channel (e.g., as discussed above with respect to FIG. 3B) (e.g., left, right, center, bass, mid, and/or high) to a first audio device (e.g., 306, 308, and/or 310) of the multiple output devices. In some embodiments, outputting the audio content in the first manner includes sending (and/or assigning) a second audio channel (e.g., as discussed above with respect to FIG. 3B) (e.g., left, right, center, bass, mid, and/or high) to a second audio device (e.g., 306, 308, and/or 310) of the multiple output devices. In some embodiments, the multi-channel audio system includes the resident device and/or the respective device. In some embodiments, the multi-channel audio system does not include the respective device, but the respective device is able to control the multi-channel audio system. In some embodiments, the first audio channel is a single audio channel and/or a combination of multiple audio channels (e.g., the first audio device outputs a percentage of a left channel and a percentage of a height channel). In some embodiments, the first audio channel is sent to the first audio device based on the first audio device's capabilities, location, and/or predefined configuration within an area. In some embodiments, the second audio channel is separate (and/or different) from the first audio channel. In some embodiments, the second audio device is separate from the first audio device. In some embodiments, the second audio channel is a single audio channel and/or a combination of multiple audio channels (e.g., the second audio device outputs a percentage of a right channel and a percentage of a bass channel). In some embodiments, the second audio channel is sent to the second audio device based on the first audio device's capabilities, location, and/or predefined configuration within an area.

In some embodiments, the first audio channel is a left audio channel (e.g., as discussed above with respect to FIG. 3B) (and/or a right audio channel). In some embodiments, the second audio channel is a right audio channel (e.g., as discussed above with respect to FIG. 3B) (and/or a center audio channel). In some embodiments, the first audio channel is sent the left audio channel and/or the right audio channel due to the first audio device's capabilities, location, and/or predefined configuration within an area. In some embodiments, the second audio channel is sent the left audio channel and/or the right audio channel due to the second audio device's capabilities, location, and/or predefined configuration within an area.

In some embodiments, the first audio channel is a first surround channel (e.g., as discussed above with respect to FIG. 3B) (e.g., left, right, center, height, and/or bass). In some embodiments, the second audio channel is a second surround channel (e.g., as discussed above with respect to FIG. 3B) (e.g., left, right, center, height, and/or bass) separate (and/or different) from the first surround channel. In some embodiments, the first surround channel and/or the second surround channel is a single surround channel and/or a combination of multiple surround channels (e.g., a percentage of a left channel and a height channel and/or a percentage of a right channel and/or center channel) based on locality and/or configuration.

In some embodiments, the first audio channel includes a first configuration (e.g., as discussed above with respect to FIG. 3B) (e.g., a first set of predefined values across the audio spectrum and/or a first balancer setting spanning a range of audio frequencies). In some embodiments, the second audio channel includes a second configuration (e.g., as discussed above with respect to FIG. 3C) different from the first configuration. In some embodiments, the second configuration (e.g., a second set of predefined values across the audio spectrum and/or a second balancer setting spanning a range of audio frequencies) includes different levels of audio frequencies (e.g., as discussed above with respect to FIG. 3A) along the audio spectrum than the first configuration. In some embodiments, the different configurations for the first configuration and/or the second configurations are defined by a user and/or are dynamic based on the respective device (e.g., altering a configuration based on locality of the respective device and/or respective device that initiates playback).

In some embodiments, the multiple devices include the resident device (e.g., as discussed above with respect to FIG. 3B) (and/or the respective device).

In some embodiments, the multiple devices are external to (and/or separate from) the resident device (e.g., as discussed above with respect to FIG. 3B) (and/or the respective device). In some embodiments, the multiple devices are a configuration of audio output devices within an area (e.g., a set of speakers for a home theater system and/or a set of computer systems with a home).

In some embodiments, after (and/or while) outputting the audio content in the first manner, the resident device detects (e.g., via the resident device, the respective device, and/or the multiple output devices) that the respective device has moved from a first position (e.g., position of 304 at FIG. 3C) to a second position (e.g., position of 304 at FIG. 3D), wherein the second position is different from the first position. In some embodiments, the resident device is in communication with (and/or includes) one or more input devices (e.g., a camera, a depth sensor, a microphone, and/or an accelerometer). In some embodiments, the one or more input devices are part of the respective device and communicate to the resident device and/or the respective device communicates information from the one or more input devices to the resident device. In some embodiments, the resident device, the respective device, or the multiple output devices detects that the respective device has moved from the first position to the second position (e.g., detecting a signal strength change, detecting, via a camera, physical movement of the respective device, and/or detecting, via the respective device, that the respective device has moved from the first position to the second position). In some embodiments, detecting that the respective device has moved from the first position to the second position includes detecting that the respective device is located at the second position. In some embodiments, detecting that the respective device has moved from the first position to the second position includes detecting movement of the respective device. In some embodiments, the movement of the respective device is movement from a first position with an area to a second position within the area (e.g., different from the first position), a difference in position within an area (e.g., based on distance moved rather than position moved to and/or distance from a previous point), and/or movement to a different area with an environment (e.g., movement from a living room to a kitchen and/or movement from a living room to an upstairs bedroom). In some embodiments, in response to detecting that the respective device has moved from the first position to the second position, the resident device adjusts (e.g., as indicated by the difference of 306a, 308a, and/or 310a between FIG. 3C and FIG. 3D), via the multiple output devices, the output of the audio content. In some embodiments, adjusting the output of the audio content includes outputting the same audio content with one or more altered audio characteristics (e.g., a change in volume, channel, frequence, directionality, EQ, and/or surround type). In some embodiments, adjusting the output of the audio content includes removing one or more output devices from the multiple output devices and/or reassigning one or more output devices of the multiple output devices to a different configuration of output devices.

In some embodiments, after (and/or while) outputting the audio content in the first manner, the resident device detects (e.g., via the resident device, the respective device, and/or the multiple output devices) that an output device of the multiple output devices has moved from a third position (e.g., position of 310 at FIG. 3I) to a fourth position (e.g., position of 310 at FIG. 3J), wherein the third position is different from the fourth position. In some embodiments, the resident device is in communication with one or more input devices (e.g., a camera, a depth sensor, a microphone, and/or an accelerometer). In some embodiments, the one or more input devices are part of the respective device and communicate to the resident device and/or the respective device communicates information from the one or more input devices to the resident device. In some embodiments, the resident device, the respective device, the output device of the multiple output devices, and/or other devices of the multiple output devices detect the movement of the output device of the multiple output devices (e.g., detecting a signal strength change, detecting, via a camera, and/or physical movement of the output device of the multiple output devices). In some embodiments, detecting that the output device of the multiple output devices has moved from the third position to the fourth position includes detecting that the output device of the multiple output devices device is located at the fourth position. In some embodiments, detecting that the output device of the multiple output devices has moved from the third position to the fourth position includes detecting movement of the output device of the multiple output devices. In some embodiments, the movement of the output device of the multiple output devices is movement from a third position within an area to a fourth position within the area (e.g., different from the first position), a difference in position within an area (e.g., based on distance moved rather than position moved to and/or distance from a previous point), and/or movement to a different area within an environment (e.g., movement from a living room to a kitchen and/or movement from a living room to an upstairs bedroom). In some embodiments, movement of the output device of the multiple output devices includes movement of multiple output devices of the multiple output devices (e.g., each output device moved can affect the output of the audio content). In some embodiments, in response to detecting that the respective device has moved from the third position to the fourth position, in accordance with a determination that the output device is a first device (e.g., 306, 308, 310, and/or 314) of the multiple output devices, the resident device outputs, via the multiple output devices, the audio content in a fifteenth manner (e.g., as indicated by 306a, 308a, 310a, and/or 314a at FIG. 3I) different from the first manner. In some embodiments, outputting the audio content in the fifteenth manner includes altering one or more audio characteristics (e.g., volume, channel, frequence, directionality, EQ, and/or surround type) of the output of the audio content. In some embodiments, in response to detecting that the respective device has moved from the third position to the fourth position, in accordance with a determination that the output device is a second device (e.g., 306, 308, 310, and/or 314) of the multiple output devices, the resident device outputs, via the multiple output devices, the audio content in a sixteenth manner (e.g., as indicated by 306a, 308a, 310a, and/or 314a at FIG. 3J), wherein the second device is separate from the first device, and wherein the sixteenth manner is different from the fifteenth manner and the first manner. In some embodiments, outputting the audio content in the sixteenth manner includes maintaining output of the audio content (e.g., forgoing alteration of output of the audio content) and/or altering one or more audio characteristics (e.g., volume, channel, frequence, directionality, EQ, and/or surround type) of the output of the audio content.

In some embodiments, after (and/or while) outputting the audio content in the first manner, the resident device detects an input (e.g., 305g) (e.g., tap input and/or voice input) corresponding to (e.g., associated with and/or related to) a request to alter the playback of the audio content (e.g., as discussed above with respect to FIG. 3G) (e.g., reconfigure the output of the audio content). In some embodiments, the resident device detects, via one or more input devices (e.g., a touch sensitive surface and/or control), the input corresponding to the request to alter the playback of the audio content. In some embodiments, the respective device and/or the multiple output devices detect, via one or more input devices (e.g., one or more microphones of the multiple output devices and/or the respective device and/or a touch sensitive surface of the multiple output devices and/or the respective device), the input corresponding to the request to alter the playback of the audio content. In some embodiments, after the respective device and/or the multiple output devices detect the input corresponding to the request to alter the playback of the audio content, the respective device receives, via the respective device and/or the multiple output devices, the input corresponding to the request to alter the playback of the audio content. In some embodiments, in response to detecting the input corresponding to the request to alter the playback of the audio content, the resident device adjusts (e.g., as indicated by the difference of 306a, 308a, and/or 310a between FIG. 3G and FIG. 3H), via the multiple output devices, the output of the audio content. In some embodiments, adjusting the output of the audio content includes outputting the audio content with an altered set of one or more audio characteristics (e.g., altering one or more audio characteristics and/or reverting alteration of one or more audio characteristics), different from a previous set of one or more audio characteristics, such as volume level, directionality, frequence, EQ, channel, and/or surround type.

In some embodiments, while (and/or after) outputting the audio content in the second manner (and/or third manner), the resident device detects (e.g., via the first device, the second device, and/or the multiple devices) an audio characteristic (e.g., a volume level, an output quality, an output clarity, and/or an output interference) of the audio content (e.g., as discussed above with respect to FIG. 3J). In some embodiments, in response to detecting the audio characteristic of the audio content, in accordance with a determination that the audio characteristic satisfies a fifteenth set of one or more criteria, the resident device outputs, via the multiple devices, the audio content in a seventeenth manner (e.g., as indicated by 306a, 308a, 310a, and/or 314a) different from the second manner. In some embodiments, in response to detecting the audio characteristic of the audio content, in accordance with a determination that the audio characteristic satisfies a sixteenth set of one or more criteria, the resident device outputs, via the multiple devices, the audio content in an eighteenth manner (e.g., as indicated by 306a, 308a, 310a, and/or 314a) different from the seventeenth manner, wherein the sixteenth set of one or more criteria is different from the fifteenth set of one or more criteria. In some embodiments, the audio characteristic of the audio content is a difference in expected audio characteristics and/or an audio characteristic that deviates from an expected output (e.g., the audio content is muffled and not at a desired volume, the audio content is interfered by an object within an area, and/or the audio content is reflected by a material causing distortion of the audio content) In some embodiments, the audio characteristic satisfying the fifteenth set of one or more criteria includes the audio characteristic failing to align with an expected audio characteristic (e.g., an expected volume level, output quality, and/or output clarity). In some embodiments, outputting the audio content in the seventeenth manner includes altering one or more audio characteristics (e.g., volume, channel, frequence, directionality, EQ, and/or surround type) of the output of the audio content. In some embodiments, outputting the audio content in the eighteenth manner includes maintaining output of the audio content (e.g., forgoing alteration of output of the audio content) and/or altering one or more audio characteristics (e.g., volume, channel, frequence, directionality, EQ, and/or surround type) of the output of the audio content.

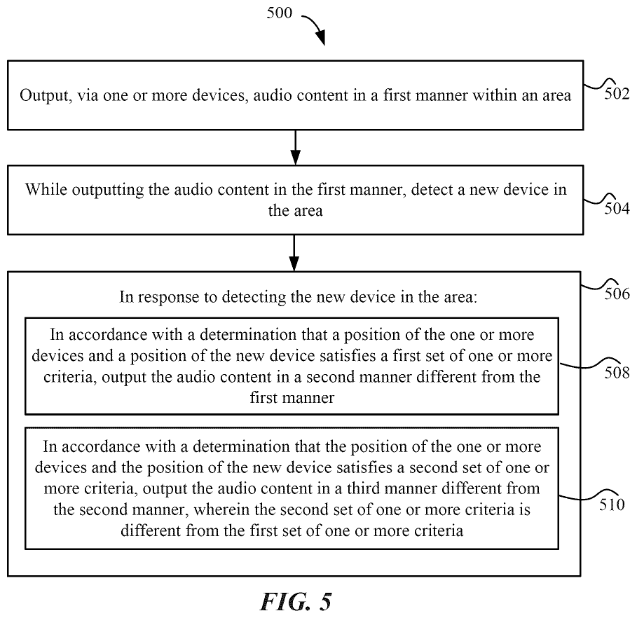

Note that details of the processes described above with respect to process 400 (e.g., FIG. 5) are also applicable in an analogous manner to other processes described herein. For example, process 500 optionally includes one or more of the characteristics of the various processes described above with reference to process 400. For example, the new device of process 500 can be the respective device of process 400. For brevity, these details are not repeated herein.

FIG. 5 is a flow diagram illustrating a process (e.g., process 500) for altering output of audio content based on positioning of devices in accordance with some embodiments. Some operations in process 500 are, optionally, combined, the orders of some operations are, optionally, changed, and some operations are, optionally, omitted.

As described below, process 500 provides an intuitive way for altering output of audio content based on positioning of devices. Process 500 reduces the cognitive burden on a user, thereby creating a more efficient human-machine interface. For battery-operated computing devices, enabling a user to interact with such devices faster and more efficiently conserves power and increases the time between battery charges.

In some embodiments, process 500 is performed at a resident device (e.g., 300) (e.g., a device that is permanently installed within a location and/or is part of a connected network at the location, a device that is actively connected to a network at a location and/or consistently part of a network at a location, an always-on device at a location, a permanent device, a connected-home device, a smart-home fixture, a core device, a home-hub device, a persistent device, a network device, an in-home node, an active device, a connected node, a local device, a resident node, a device that communicates with one or more accessory devices on behalf of one or more controller devices, a home-based device, a fixed-location device, and/or a device). In some embodiments, the resident device is a computer system, a watch, a phone, a tablet, a fitness tracking device, a processor, a head-mounted display (HMD) device, a communal device, a media device, a speaker, a television, an electronic device, and/or a personal computing device.

The resident device outputs (502), via one or more devices (e.g., 306, 308, and/or 310) (e.g., including or not including the resident device), audio content (e.g., as discussed above with respect to FIG. 3A) (e.g., a song, a movie, a podcast, and/or an audio recording) in a first manner (e.g., as indicated by 306a, 308a, and/or 310a) (e.g., with a first set of one or more audio characteristics and/or using a first set of devices within the area) within an area (e.g., 320 and/or 322). In some embodiments, before outputting the audio content in the first manner, the resident device receives (e.g., from a device of the one or more devices, from the one or more devices, from a device separate from the one or more devices, or from a server), information (e.g., location and/or position information) corresponding to a position of the one or more devices within the area. In some embodiments, the information includes information of a position within the area corresponding to each device of the one or more devices and/or position information corresponding to relative positions of the one or more devices within the area. In some embodiments, the one or more devices are a different type of device than the resident device. In some embodiments, the one or more devices includes a speaker, a smart speaker, a home theater system, a soundbar, a headphone, an earphone, an earbud, a television speaker, an augmented reality headset speaker, an audio jack, an optical audio output, a Bluetooth audio output, and/or a HDMI audio output. In some embodiments, the information is based on a relative position of each of the one or more devices to each of the one or more devices and/or the resident device, to a landmark within the area (e.g., a virtual landmark such as an area middle point, an area bound, and/or a fixed location within an area and/or physical landmark such as a corner of a structure within an area, a wall, floor, and/or ceiling within an area, and/or an opening within an area). In some embodiments, the information is based on absolute position of each of the one or more devices within the area (e.g., coordinate position and/or axis-based position within a set of bounds). In some embodiments, the information includes an identifier corresponding to the one or more devices and/or each device of the one or more devices. In some embodiments, the first manner is an initial manner, default manner, or manner corresponding to a configuration of the one or more devices. In some embodiments, outputting the audio content in the first manner includes outputting the audio content with a first set of one or more audio characteristics such as volume level, directionality, frequency, channel, and/or surround type.

While outputting the audio content in the first manner, the resident device detects (504) a new device (e.g., 314) in the area. In some embodiments, the new device was not detected within the area before detected the new device in the area. In some embodiments, detecting the new device in the area includes receiving, from the new device, a message. In some embodiments, the message includes an identification of the new device and/or a position of the new device. In some embodiments, the position of the new device is relative to one or more devices of the one or more devices and/or the resident device. In some embodiments, detecting the new device in the area includes receiving media (e.g., an image, a video, and/or audio) of the area that is used to identify a position of the new device. In some embodiments, the resident device locates the new device. In some embodiments, the new device locates the new device within the area. In some embodiments, a device of the one or more devices locates the new device within the area. In some embodiments, a server locates the new device within the area. In some embodiments, the resident device is in communication with and/or includes one or more input devices (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface) that are used to detect the new device in the area. In some embodiments, the new device includes and/or is a speaker, a smart speaker, a home theater system, a soundbar, a headphone, an earphone, an earbud, a television speaker, an augmented reality headset speaker, an audio jack, an optical audio output, a Bluetooth audio output, and/or a HDMI audio output. In some embodiments, before, as part of, and/or in conjunction with detecting the new device, the resident device receives, from the new device, a request to join a set of devices assigned to the area and/or detects a signal, sent by the new device, corresponding to a request to establish communication with the resident device and/or to join the set of devices.

In response to (506) detecting the new device in the area, in accordance with a determination that a first set of one or more criteria is satisfied, wherein the first set of one or more criteria includes a criterion that is satisfied based on a position (e.g., as discussed above with respect to FIG. 3H) of the one or more devices and a position (e.g., as discussed above with respect to FIG. 3H) of the new device, the resident device outputs (508) (e.g., via the one or more devices and/or the new device) the audio content in a second manner (e.g., as indicated by 306a, 308a, 310a, and/or 314a) (e.g., without outputting the audio content in the first manner) different from the first manner. In some embodiments, the criterion, of the first set of one or more criteria, that is satisfied based on the position of the new device and the position of the one or more devices is satisfied when: the new device and the one or more devices are in a first configuration (e.g., layout and/or relative positions); the new device and the one or more devices are within a first portion of the area (e.g., a subsection of the area and/or a quadrant of the area); and/or the new device and the one or more devices share a first positional relationship with the resident device (e.g., within a common locality, within a certain distance from the resident device, and/or in a common direction from the resident device). In some embodiments, outputting the audio content in the second manner includes outputting the audio content with a second set of one or more audio characteristics, different form the first set of one or more audio characteristics, such as volume level, directionality, frequency, channel, and/or surround type. In some embodiments, the second manner is different from the first manner in one or more audio characteristics.

In response to (506) detecting the new device in the area, in accordance with a determination that a second set of one or more criteria is satisfied, wherein the second set of one or more criteria includes a criterion that is satisfied based on the position of the one or more devices and the position of the new device, the resident device outputs (510) (e.g., via the one or more devices and/or the new device) the audio content in a third manner (e.g., as indicated by 306a, 308a, 310a, and/or 314a) (e.g., without outputting the audio content in the first manner and/or the second manner) different from the second manner, wherein the second set of one or more criteria is different from the first set of one or more criteria. In some embodiments, the third manner is the first manner. In some embodiments, the third manner is different from the first manner. In some embodiments, the third manner is the same as the first manner but includes the new device. In some embodiments, outputting the audio content in the third manner includes outputting the audio content with a third set of one or more audio characteristics (e.g., altering one or more audio characteristics and/or reverting alteration of one or more audio characteristics), different from the first set of one or more audio characteristics and/or the second set of one or more audio characteristics, such as volume level, directionality, frequence, EQ, channel, and/or surround type. In some embodiments, the criterion, of the second set of one or more criteria, that is satisfied based on the position of the new device and the position of the one or more devices is satisfied when: the new device and the one or more devices are in a second configuration (e.g., layout and/or relative positions) different from the first configuration; the new device and the one or more devices are within a second portion, different from the first portion, of the area (e.g., a subsection of the area and/or a quadrant of the area); and/or the new device and the one or more devices share a second positional relationship, different from the first positional relationship, with the resident device (e.g., within a common locality, within a certain distance from the resident device, and/or in a common direction from the resident device).

In some embodiments, in response to detecting the new device in the area, in accordance with a determination that a third set of one or more criteria is satisfied, wherein the third set of one or more criteria includes a criterion that is satisfied when the audio content is a first type of content (e.g., as discussed above with respect to FIG. 3B), the resident device outputs the audio content in a fourth manner (e.g., as indicated by 306a, 308a, 310a, and/or 314a) different from the first manner. In some embodiments, outputting the audio content in the fourth manner includes outputting the audio content with a second set of one or more audio characteristics, different form the first set of one or more audio characteristics, such as volume level, directionality, frequency, channel, and/or surround type. In some embodiments, the fourth manner is different from the first manner in one or more audio characteristics. In some embodiments, the third set of one or more criteria includes the first set of one or more criteria or the second set of one or more criteria. In some embodiments, in response to detecting the new device in the area, in accordance with a determination that a fourth set of one or more criteria is satisfied, wherein the fourth set of one or more criteria includes a criterion that is satisfied when the audio content is a second type of content (e.g., as discussed above with respect to FIG. 3C), the resident device outputs the audio content in a fifth manner (e.g., as indicated by 306a, 308a, 310a, and/or 314a) different from the fourth manner, wherein the third set of one or more criteria is different from the fourth set of one or more criteria, and wherein the second type of content is different from the first type of content. In some embodiments, the first type of content and/or the second type of content corresponds to a type of media (e.g., music, visual entertainment, and/or speech from a voice assistant) and/or audio channel (e.g., left, right, center, bass, mid, and/or high). In some embodiments, outputting the audio content in the fifth manner includes outputting the audio content with a new set of one or more audio characteristics (e.g., altering one or more audio characteristics and/or reverting alteration of one or more audio characteristics), different from the first set of one or more audio characteristics and/or the second set of one or more audio characteristics, such as volume level, directionality, frequence, EQ, channel, and/or surround type. In some embodiments, the fourth set of one or more criteria includes the first set of one or more criteria or the second set of one or more criteria.

In some embodiments, in response to detecting the new device in the area, in accordance with a determination that a fifth set of one or more criteria is satisfied, wherein the fifth set of one or more criteria includes a criterion that is satisfied when a respective locality (e.g., as described above with respect to process 400) of the new device within the area is a first locality (e.g., as discussed above with respect to FIG. 3H), the resident device outputs the audio content in a sixth manner (e.g., as indicated by 306a, 308a, 310a, and/or 314a) different from the first manner. In some embodiments, outputting the audio content in the sixth manner includes outputting the audio content with a second set of one or more audio characteristics, different from the first set of one or more audio characteristics, such as volume level, directionality, frequency, channel, and/or surround type. In some embodiments, the sixth manner is different from the first manner in one or more audio characteristics. In some embodiments, the fifth set of one or more criteria includes the first set of one or more criteria, the second set of one or more criteria, the third set of one or more criteria, or the fourth set of one or more criteria. In some embodiments, in response to detecting the new device in the area, in accordance with a determination that a sixth set of one or more criteria is satisfied, wherein the sixth set of one or more criteria includes a criterion that is satisfied when the respective locality of the new device within the area is a second locality (e.g., as discussed above with respect to FIG. 3I), the resident device outputs the audio content in a seventh manner (e.g., as indicated by 306a, 308a, 310a, and/or 314a) different from the sixth manner, wherein the sixth set of one or more criteria is different from the fifth set of one or more criteria, and wherein the second locality is different from the first locality. In some embodiments, the respective locality of the new device is the new device's position within the area and/or relative positioning of the new device in comparison to the resident device and/or the one or more devices. In some embodiments, the respective locality of the new device is a mapping of the new device's relationship with key points and/or locations within the area (e.g., boundaries, walls, furniture, and/or other devices). In some embodiments, outputting the audio content in the seventh manner includes outputting the audio content with a new set of one or more audio characteristics (e.g., altering one or more audio characteristics and/or reverting alteration of one or more audio characteristics), different from the first set of one or more audio characteristics and/or the second set of one or more audio characteristics, such as volume level, directionality, frequence, EQ, channel, and/or surround type. In some embodiments, the sixth set of one or more criteria includes the first set of one or more criteria, the second set of one or more criteria, the third set of one or more criteria, or the fourth set of one or more criteria.

In some embodiments, in response to detecting the new device in the area, in accordance with a determination that a seventh set of one or more criteria is satisfied, wherein the seventh set of one or more criteria includes a criterion that is satisfied when a respective locality (e.g., as discussed above with respect to FIG. 3A) of the one or more devices within the area (e.g., includes and/or not includes the new device) is a first locality (e.g., as discussed above with respect to FIG. 3H), the resident device outputs the audio content in an eighth manner (e.g., as indicated by 306a, 308a, 310a, and/or 314a) different from the first manner. In some embodiments, outputting the audio content in the eighth manner includes outputting the audio content with a second set of one or more audio characteristics, different form the first set of one or more audio characteristics, such as volume level, directionality, frequency, channel, and/or surround type. In some embodiments, the eighth manner is different from the first manner in one or more audio characteristics. In some embodiments, the seventh set of one or more criteria includes the first set of one or more criteria, the second set of one or more criteria, the third set of one or more criteria, the fourth set of one or more criteria, the fifth set of one or more criteria, or the sixth set of one or more criteria. In some embodiments, in response to detecting the new device in the area, in accordance with a determination that an eighth set of one or more criteria is satisfied, wherein the eighth set of one or more criteria includes a criterion that is satisfied when the respective locality of the one or more devices within the area is a second locality (e.g., as discussed above with respect to FIG. 3I), the resident device outputs the audio content in an ninth manner (e.g., as indicated by 306a, 308a, 310a, and/or 314a) different from the eighth manner, wherein the eighth set of one or more criteria is different from the seventh set of one or more criteria, and wherein the second locality is different from the first locality. In some embodiments, the respective locality of the one or more devices is each device of the one or more devices position within the area and/or relative positioning of each device of the one or more devices in comparison to the resident device and/or the one or more devices. In some embodiments, the respective locality of the one or more devices is a mapping of the one or more devices' relationship with key points and/or locations within the area (e.g., boundaries, walls, furniture, and/or other devices). In some embodiments, outputting the audio content in the ninth manner includes outputting the audio content with a new set of one or more audio characteristics (e.g., altering one or more audio characteristics and/or reverting alteration of one or more audio characteristics), different from the first set of one or more audio characteristics and/or the second set of one or more audio characteristics, such as volume level, directionality, frequence, EQ, channel, and/or surround type. In some embodiments, the eighth set of one or more criteria includes the first set of one or more criteria, the second set of one or more criteria, the third set of one or more criteria, the fourth set of one or more criteria, the fifth set of one or more criteria, or the sixth set of one or more criteria.

In some embodiments, in response to detecting the new device in the area, in accordance with a determination that a ninth set of one or more criteria is satisfied, wherein the ninth set of one or more criteria includes a criterion that is satisfied when a respective relationship (e.g., as discussed above with respect to FIG. 3H) (e.g., positionality, device type, assignment to a grouping and/or configuration of devices, and/or locality) between the new device and the one or more devices is a first relationship (e.g., as discussed above with respect to FIG. 3H), the resident device outputs the audio content in a tenth manner (e.g., as indicated by 306a, 308a, 310a, and/or 314a) different from the first manner. In some embodiments, outputting the audio content in the tenth manner includes outputting the audio content with a second set of one or more audio characteristics, different form the first set of one or more audio characteristics, such as volume level, directionality, frequency, channel, and/or surround type. In some embodiments, the tenth manner is different from the first manner in one or more audio characteristics. In some embodiments, the ninth set of one or more criteria includes the first set of one or more criteria, the second set of one or more criteria, the third set of one or more criteria, the fourth set of one or more criteria, the fifth set of one or more criteria, the sixth set of one or more criteria, the seventh set of one or more criteria, or the eighth set of one or more criteria. In some embodiments, in response to detecting the new device in the area, in accordance with a determination that a tenth set of one or more criteria is satisfied, wherein the tenth set of one or more criteria includes a criterion that is satisfied when the respective relationship between the new device and the one or more devices is a second relationship (e.g., as discussed above with respect to FIG. 3I), the resident device outputs the audio content in an eleventh manner (e.g., as indicated by 306a, 308a, 310a, and/or 314a) different from the tenth manner, wherein the tenth set of one or more criteria is different from the ninth set of one or more criteria, and wherein the second relationship is different from the first relationship. In some embodiments, the first relationship and/or the second relationship include positional relationships (e.g., to other devices and/or to key points within the area), device capability relationships (e.g., ability to output certain frequencies, ability to output audio in a certain direction, and/or ability to capture information through an input device), and/or device type relationships (e.g., speaker, computer system, and/or other media device such as a TV and/or projector). In some embodiments, outputting the audio content in the eleventh manner includes outputting the audio content with a new set of one or more audio characteristics (e.g., altering one or more audio characteristics and/or reverting alteration of one or more audio characteristics), different from the first set of one or more audio characteristics and/or the second set of one or more audio characteristics, such as volume level, directionality, frequence, EQ, channel, and/or surround type. In some embodiments, the tenth set of one or more criteria includes the first set of one or more criteria, the second set of one or more criteria, the third set of one or more criteria, the fourth set of one or more criteria, the fifth set of one or more criteria, the sixth set of one or more criteria, the seventh set of one or more criteria, or the eighth set of one or more criteria.

In some embodiments, before (and/or while) detecting the new device in the area, the resident device receives, from the one or more devices, respective visual media (e.g., as discussed above with respect to FIG. 3A). In some embodiments, the respective visual media includes raw image data, processed image data such as depth information, key point information, object recognition, and/or location recognition. In some embodiments, the resident device uses the image information to identify a locality of the one or more devices and the new device with the area. In some embodiments, the resident device identifies the locality corresponding to the one or more devices and the new device by compiling and/or processing the image information (e.g., building a 3D mapping of the multiple devices within an environment, recognizing positional relationships between devices, resident device, and/or objects within the environment, and/or mapping depth through a combination of image information). In some embodiments, the locality is a mapping of devices (e.g., location within 3D space and/or relative position within an environment) in relation to the resident device and/or key points within an environment (e.g., walls, furniture, other devices, and/or temporary objects). In some embodiments, in response to detecting the new device in the area, in accordance with a determination that an eleventh set of one or more criteria is satisfied, wherein the eleventh set of one or more criteria includes a criterion that is satisfied when the respective visual media is first visual media (e.g., as discussed above with respect to FIG. 3H), the resident device outputs the audio content in an twelfth manner (e.g., as indicated by 306a, 308a, 310a, and/or 314a) different from the first manner. In some embodiments, outputting the audio content in the twelfth manner includes outputting the audio content with a second set of one or more audio characteristics different form the first set of one or more audio characteristics, such as volume level, directionality, frequency, channel, and/or surround type. In some embodiments, the twelfth manner is different from the first manner in one or more audio characteristics. In some embodiments, the eleventh set of one or more criteria includes the first set of one or more criteria, the second set of one or more criteria, the third set of one or more criteria, the fourth set of one or more criteria, the fifth set of one or more criteria, the sixth set of one or more criteria, the seventh set of one or more criteria, the eighth set of one or more criteria, the ninth set of one or more criteria, or the tenth set of one or more criteria. In some embodiments, in response to detecting the new device in the area, in accordance with a determination that a twelfth set of one or more criteria is satisfied, wherein the twelfth set of one or more criteria includes a criterion that is satisfied when the respective visual media is second visual media (e.g., as discussed above with respect to FIG. 3I), the resident device outputs the audio content in a thirteenth manner (e.g., as indicated by 306a, 308a, 310a, and/or 314a) different from the twelfth manner, wherein the twelfth set of one or more criteria is different from the eleventh set of one or more criteria, and wherein the second visual media is different from the first visual media. In some embodiments, outputting the audio content in the thirteenth manner includes outputting the audio content with a new set of one or more audio characteristics (e.g., altering one or more audio characteristics and/or reverting alteration of one or more audio characteristics), different from the first set of one or more audio characteristics and/or the second set of one or more audio characteristics, such as volume level, directionality, frequence, EQ, channel, and/or surround type. In some embodiments, the twelfth set of one or more criteria includes the first set of one or more criteria, the second set of one or more criteria, the third set of one or more criteria, the fourth set of one or more criteria, the fifth set of one or more criteria, the sixth set of one or more criteria, the seventh set of one or more criteria, the eighth set of one or more criteria, the ninth set of one or more criteria, or the tenth set of one or more criteria.

In some embodiments, while (and/or before) receiving the respective visual media, the resident device receives, from the one or more devices, respective audio media (e.g., as discussed above with respect to FIG. 3A) (and/or information corresponding to audio detected on the one or more devices). In some embodiments, the respective audio media is raw audio data, data from processing the audio content, and/or one or more audio characteristics corresponding to the audio content (e.g., output level, directionality, and/or frequency). In some embodiments, in response to detecting the new device in the area, in accordance with a determination that a thirteenth set of one or more criteria is satisfied, wherein the thirteenth set of one or more criteria includes a criterion that is satisfied when the respective audio media is first audio media (e.g., as discussed above with respect to FIG. 3H), the resident device outputs the audio content in a fourteenth manner (e.g., as indicated by 306a, 308a, 310a, and/or 314a) different from the first manner. In some embodiments, outputting the audio content in the fourteenth manner includes outputting the audio content with a second set of one or more audio characteristics different from the first set of one or more audio characteristics, such as volume level, directionality, frequency, channel, and/or surround type. In some embodiments, the fourteenth manner is different from the first manner in one or more audio characteristics. In some embodiments, the thirteenth set of one or more criteria includes the first set of one or more criteria, the second set of one or more criteria, the third set of one or more criteria, the fourth set of one or more criteria, the fifth set of one or more criteria, the sixth set of one or more criteria, the seventh set of one or more criteria, the eighth set of one or more criteria, the ninth set of one or more criteria, the tenth set of one or more criteria, the eleventh set of one or more criteria, or the twelfth set of one or more criteria. In some embodiments, in response to detecting the new device in the area, in accordance with a determination that a fourteenth set of one or more criteria is satisfied, wherein the fourteenth set of one or more criteria includes a criterion that is satisfied when the respective audio media is second audio media (e.g., as discussed above with respect to FIG. 3I), the resident device outputs the audio content in a fifteenth manner (e.g., as indicated by 306a, 308a, 310a, and/or 314a) different from the fourteenth manner, wherein the fourteenth set of one or more criteria is different from the thirteenth set of one or more criteria, and wherein the second audio media is different from the first audio media. In some embodiments, the resident device utilizes both the respective audio media and image media to identify the locality corresponding to the one or more devices and/or the new device (e.g., using a magnitude of volume and/or a volume reference to determine distance to an output device, using audio patterns to determine characteristics of objects within the environment such as material, and/or using audio information and/or image information to check and/or correct missing information). In some embodiments, outputting the audio content in the fourteenth manner includes outputting the audio content with a new set of one or more audio characteristics (e.g., altering one or more audio characteristics and/or reverting alteration of one or more audio characteristics), different from the first set of one or more audio characteristics and/or the second set of one or more audio characteristics, such as volume level, directionality, frequence, EQ, channel, and/or surround type. In some embodiments, the fourteenth set of one or more criteria includes the first set of one or more criteria, the second set of one or more criteria, the third set of one or more criteria, the fourth set of one or more criteria, the fifth set of one or more criteria, the sixth set of one or more criteria, the seventh set of one or more criteria, the eighth set of one or more criteria, the ninth set of one or more criteria, the tenth set of one or more criteria, the eleventh set of one or more criteria, or the twelfth set of one or more criteria.

In some embodiments, after (and/or while) outputting the audio content in the second manner, the resident device detects (e.g., via the new device, the resident device, and/or the one or more devices) an input (e.g., 305g) (e.g., tap input and/or voice input) corresponding to (e.g., associated with and/or related to) a request to adjust the output of the audio content (e.g., as discussed above with respect to FIG. 3G). In some embodiments, the resident device detects, via one or more input devices (e.g., a touch sensitive surface and/or control), the input corresponding to the request to adjust the output of the audio content. In some embodiments, the new device and/or the one or more devices detect, via one or more input devices (e.g., one or more microphones of the one or more devices and/or the new device and/or a touch sensitive surface of the one or more devices and/or the new device), the input corresponding to the request to adjust the output of the audio content. In some embodiments, in response to detecting the input corresponding to the request to adjust the output of the audio content, the resident device adjusts (e.g., as indicated by the difference of 306a, 308a, and/or 310a between FIG. 3G and FIG. 3H), via the one or more devices (and/or the new device), the output of the audio content. In some embodiments, adjusting the output of the audio content includes outputting the audio content with an altered set of one or more audio characteristics (e.g., altering one or more audio characteristics and/or reverting alteration of one or more audio characteristics), different from a previous set of one or more audio characteristics, such as volume level, directionality, frequence, EQ, channel, and/or surround type.

In some embodiments, the input corresponding to the request to adjust the output of the audio content is detected by a device (e.g., 306, 308, 310, 312, and/or 314) of the one or more devices. In some embodiments, the device of the one or more devices sends, to the resident device, the input corresponding to the request to adjust the output of the audio content (e.g., a voice input detected by one or more devices within the area and/or a tap input on one of the one or more devices), and the resident device adjusts, via the one or more devices, the output of the audio content.

In some embodiments, the input corresponding to the request to adjust the output of the audio content is detected by the new device (e.g., as discussed above with respect to FIG. 3H). In some embodiments, the new device sends, to the resident device, the input corresponding to the request to adjust the output of the audio content (e.g., a voice input directed to the new device and/or a tap input on the new device), and the resident device adjusts, via the one or more devices, the output of the audio content.

In some embodiments, after detecting the new device within the area, the resident device outputs (e.g., via the new device and/or via the one or more devices) a prompt (e.g., as discussed above with respect to FIG. 3I) (e.g., a set of directions and/or a recommendation) corresponding to (e.g., including and/or related to) a recommended positioning (e.g., as discussed above with respect to FIG. 3I) of the one or more devices within the area. In some embodiments, the recommended positioning of the one or more devices within the area includes a position within the area that increases the efficiency of the one or more devices (e.g., ability to cover more of a sound stage and/or more of an audio spectrum), decreases occlusions and/or audio errors from the one or more devices (e.g., moving from behind an object and/or away from a material that vibrates), and/or to establish a speaker configuration (e.g., surround sound such as 2.1, 3.1, 7.1, and/or 9.1 surround sound).

In some embodiments, the recommended positioning of the one or more devices within the area is based on inclusion of the new device (e.g., as discussed above with respect to FIG. 3I). In some embodiments, the inclusion of the new device can include the new device's presence within an area, positioning within a predefined area, assignment to a set of speakers, and/or assignment to a channel and/or surround type of a speaker system. In some embodiments, the resident device recommends positions of one or more devices of the one or more devices based on the inclusion of the new device within the area by establishing a new speaker configuration based on the position of the new device, recommending movement of the one or more devices to a new position a certain distance away from the new device and/or to fit a certain layout based on the inclusion of the new device, and/or recommending a position of the one or more devices to establish a relationship with the new device. In some embodiments, the recommended positioning is of the one or more devices due to a subject declaring that the positioning of the new device is a desired positioning (e.g., adding the new device to a desired but not optimal position, based on the one or more devices, causes the one or more devices to be required to move for an optimal experience including the new device and the one or more devices).

In some embodiments, after detecting the new device within the area, the resident device outputs (e.g., via the new device and/or via the one or more devices) a prompt (e.g., as discussed above with respect to FIG. 3G) (e.g., a set of directions and/or a recommendation) corresponding to (e.g., including and/or related to) a recommended positioning (e.g., as discussed above with respect to FIG. 3G) of the new device within the area. In some embodiments, the recommended positioning of the new device within the area includes a position within the area that increases the efficiency of the new device (e.g., ability to cover more of a sound stage and/or more of an audio spectrum), decreases occlusions and/or audio errors from the new device (e.g., moving from behind an object and/or away from a material that vibrates), and/or to establish a speaker configuration (e.g., surround sound such as 2.1, 3.1, 7.1, and/or 9.1 surround sound). In some embodiments, the resident device determines the recommended positioning based on comparing potential positionings of the new device within the area through simulated (e.g., based on a generated mapping and/or environment through information detected by the one or more devices and/or the resident device) and/or physical testing (e.g., continuously testing one or more factors as the new device is moved within the area and/or moving across a set path and determining the best positioning across the path).

In some embodiments, the recommended positioning of the new device within the area is based on a relation (e.g., as discussed above with respect to FIG. 3G) of the new device to the one or more devices. In some embodiments, the resident device recommends a position for the new device based on a relationship between the new device and the one or more devices by establishing a new speaker configuration based on the position of the one or more devices (e.g., recommending a position for the new device to fit within a speaker configuration and/or to be added to an existing speaker configuration), recommending movement of the new device to a new position a certain distance away from the one or more devices and/or to fit a certain layout based on the one or more devices, and/or recommending a position of the new device to establish a new relationship with the one or more devices. In some embodiments, the resident device determines the recommended positioning based on comparing potential positionings of the device of the one or more devices within the area through simulated (e.g., based on a generated mapping and/or environment through information detected by the one or more devices and/or the resident device) and/or physical testing (e.g., continuously testing one or more factors as the device of the one or more devices is moved within the area and/or moving across a set path and determining the best positioning across the path).

In some embodiments, while outputting the audio content in the second manner, the resident device detects that the new device is no longer within the area (e.g., as discussed above with respect to FIG. 3H) (e.g., no longer detecting the new device within the area and/or detecting movement of the new device to a new area different from the area). In some embodiments, in response to detecting that the new device is no longer within the area, the resident device outputs, via the one or more devices (and/or the new device), the audio content in the first manner (e.g., without outputting the audio content in the second manner). In some embodiments, outputting the audio content in the first manner in response to detecting that the new device is no longer within the area includes adjusting the output of the audio content back to an initial manner before introduction of the new device (e.g., reverting back to an original output manner and/or reverting from an altered manner to the first manner).

In some embodiments, the new device is a first new device (e.g., 314). In some embodiments, the area is a first area. In some embodiments, while outputting the audio content in the second manner, the resident device detects a second new device (e.g., as discussed above with respect to FIG. 3H) within a second area (e.g., 320 and/or 322) different from the first area, wherein the second new device is different (and/or separate) from the first new device. In some embodiments, the second new device was not detected within the second area before detecting the second new device in the second area. In some embodiments, detecting the second new device in the area includes receiving, from the second new device, a message. In some embodiments, the message includes an identification of the second new device and/or a position of the second new device. In some embodiments, the position of the second new device is relative to one or more devices of the one or more devices, the first new device, and/or the resident device. In some embodiments, detecting the second new device in the second area includes receiving media (e.g., an image, a video, and/or audio) of the second area that is used to identify a position of the second new device. In some embodiments, the resident device locates the second new device. In some embodiments, the second new device locates the second new device within the second area. In some embodiments, a device of the one or more devices locates the second new device within the second area. In some embodiments, before, as part of, and/or in conjunction with detecting the second new device, the resident device receives, from the second new device, a request to join a set of devices assigned to the second area and/or detects a signal, sent by the second new device, corresponding to a request to establish communication with the resident device and/or to join the set of devices. In some embodiments, in response to detecting the second new device within the second area, the resident device maintains output (e.g., via the one or more devices and/or the first new device) of the audio content in the second manner (and/or first manner and/or third manner). In some embodiments, maintaining output of the audio content in the second manner includes forgoing adjusting the output of the audio content, forgoing output of the audio content via the second new device, and/or outputting the audio content via the one or more devices, the new device, and the second new device. In some embodiments, the output of the audio content, via the one or more devices, is not adjusted based on the addition of the second new device due to a difference in area (e.g., the first area and the second area are defined as separate portions of an environment and/or the first area and the second are physically separate from each other) between the one or more devices and the second new device (e.g., audio content is area dependent and/or separate areas require additional input to output across multiple areas).

In some embodiments, the second new device is the new device. In some embodiments, the area is a first area (e.g., 320). In some embodiments, while outputting the audio content in the second manner, the resident device detects that the second new device has moved (e.g., as discussed above with respect to FIG. 3E) from the first area to a second area (e.g., 322), wherein the second area is separate from the first area. In some embodiments, the resident device is in communication with one or more input devices (e.g., a camera, a depth sensor, a microphone, and/or an accelerometer). In some embodiments, the one or more input devices are part of the second new device and communicate to the resident device and/or the second new device communicates information from the one or more input devices to the resident device. In some embodiments, the resident device, the second new device, and/or the one or more devices that the second new device has moved from the first area to the second area (e.g., detecting a signal strength change, detecting, via a camera, physical movement of the second new device, and/or detecting, via the second new device, movement of the second new device). In some embodiments, an environment (e.g., a home and/or residence) is split into multiple areas artificially (e.g., user defined bounds, user defined localities, and/or defined speaker systems) and/or physically (e.g., rooms of a house and/or room types with a single physical room such as an open floor plan containing a living room, dining room, and/or kitchen). In some embodiments, detecting that the second new device has moved from the first area to the second area includes detecting that the second new device is located in the second area. In some embodiments, detecting that the second new device has moved from the first area to the second area includes detecting movement of the second new device. In some embodiments, in response to detecting that the second new device has moved from the first area to a second area, the resident device adjusts (e.g., as discussed above with respect to FIGS. 3E and 3F), via the one or more devices, the output of the audio content. In some embodiments, adjusting the output of the audio content includes outputting the audio content with an altered set of one or more audio characteristics (e.g., altering one or more audio characteristics and/or reverting alteration of one or more audio characteristics), different from a previous set of one or more audio characteristics, such as volume level, directionality, frequence, EQ, channel, and/or surround type.

In some embodiments, the one or more devices includes (and/or is) the resident device (e.g., as discussed above with respect to FIG. 3A) (and/or the new device).

In some embodiments, the one or more devices are external to (e.g., separate from and/or controlled by) the resident device (e.g., as discussed above with respect to FIG. 3H) (and/or the new device). In some embodiments, the one or more devices are separate computer systems from the resident device. In some embodiments, the one or more devices are audio output devices that require the resident device (e.g., the audio out devices cannot process inputs and/or retrieve media to be output).

In some embodiments, while (and/or after) outputting the audio content in the second manner (and/or third manner), the resident device detects (e.g., via the new device and/or the one or more devices) an audio characteristic (e.g., as discussed above with respect to FIG. 3J) (e.g., a volume level, an output quality, an output clarity, and/or an output interference) of the audio content. In some embodiments, in response to detecting the audio characteristic of the audio content, in accordance with a determination that the audio characteristic satisfies a fifteenth set of one or more criteria, the resident device outputs, via the one or more devices, the audio content in a sixteenth manner (e.g., as indicated by 306a, 308a, 310a, and/or 314a) different from the second manner. In some embodiments, in response to detecting the audio characteristic of the audio content, in accordance with a determination that the audio characteristic satisfies a sixteenth set of one or more criteria, the resident device outputs, via the multiple devices, the audio content in a seventeenth manner (e.g., as indicated by 306a, 308a, 310a, and/or 314a) different from the sixteenth manner, wherein the sixteenth set of one or more criteria is different from the fifteenth set of one or more criteria. In some embodiments, the audio characteristic of the audio content is a difference in expected audio characteristics and/or an audio characteristic that deviates from an expected output (e.g., the audio content is muffled and not at a desired volume, the audio content is interfered by an object within an area, and/or the audio content is reflected by a material causing distortion of the audio content). In some embodiments, the audio characteristic satisfying the fifteenth set of one or more criteria includes the audio characteristic failing to align with an expected audio characteristic (e.g., an expected volume level, output quality, and/or output clarity). In some embodiments, outputting the audio content in the sixteenth manner includes altering one or more audio characteristics (e.g., volume, channel, frequence, directionality, EQ, and/or surround type) of the output of the audio content. In some embodiments, outputting the audio content in the seventeenth manner includes maintaining output of the audio content (e.g., forgoing alteration of output of the audio content) and/or altering one or more audio characteristics (e.g., volume, channel, frequence, directionality, EQ, and/or surround type) of the output of the audio content.

Note that details of the processes described above with respect to process 500 (e.g., FIG. 5) are also applicable in an analogous manner to the processes described herein. For example, process 400 optionally includes one or more of the characteristics of the various processes described herein with reference to process 500. For example, the first set of one or more criteria of process 400 can include the first set of one or more criteria of process 500. For brevity, these details are not repeated herein.

The following figures are used to describe some techniques for remotely re-creating images without requiring transmission of the images. For example, a first device can capture an image of an environment and generate one or more representations of the image to be sent for use by a second device to re-create the image. In some embodiments, the second device uses the re-created image to identify information about the environment, such as depth information and/or different events occurring within the environment. In such embodiments, the information can be sent back to the first device and/or to one or more other devices for use to perform different operations. Some advantages of such techniques can include that the first device does not have to identify the information itself, some details of the image remain with the first device, privacy and/or security is improved, and/or the information can be identified about the environment by devices with more resources than the first device.

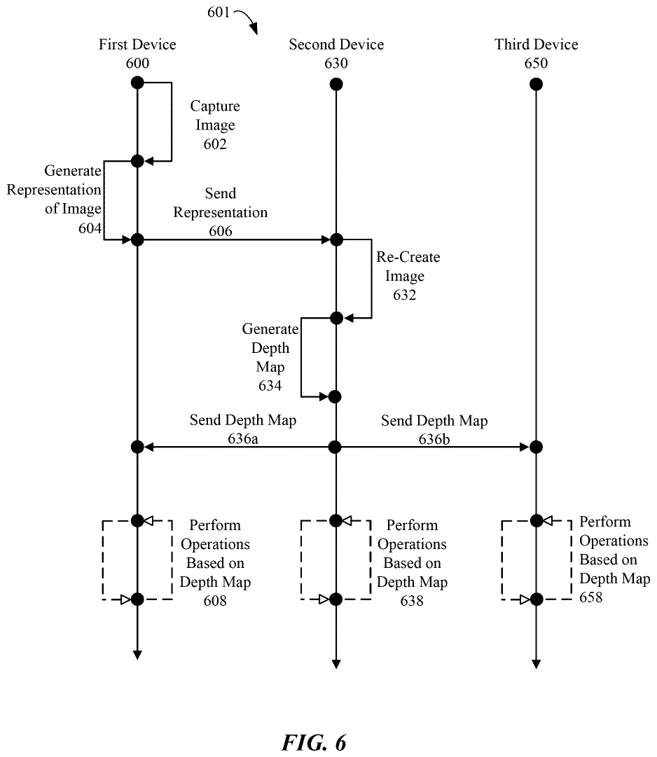

FIG. 6 is a swim-lane diagram of a process for performing an operation based on a generated depth map without requiring an image of an environment in accordance with some embodiments. The swim-line diagram is used to illustrate the processes described below, including the processes in FIG. 8.

As illustrated in FIG. 6, process 601 includes first device 600, second device 630, and third device 650. For discussion purposes, first device 600 is an accessory device, second device 630 is a server, and third device 650 is a personal device of a user. However, it should be recognized that more, less, and/or different types of devices can perform operations of process 601. For example, first device 600, second device 630, and/or third device 650 can be an accessory device, a resident device, a communal device, a mobile device, a smart phone, a smart watch, a laptop, a fitness tracking, and/or a stationary device. In some embodiments, first device 600 and third device 650 include and/or are in communication with one or more input components (e.g., a sensor, a camera, a lidar detector, a motion sensor, an infrared sensor, a touch-sensitive surface, a physical input mechanism, and/or a microphone). For example, first device 600 can be an accessory device, including a camera, such as a security camera, a smart doorbell, and/or a communal device and third device 650 can be a smart light, a fan, and/or a laptop.

In some embodiments, first device 600, second device 630, and/or third device 650 are part of an ecosystem of devices that provides control over, communication with, and/or information about devices within the ecosystem of devices. For example, second device 630 can be configured to check a network status of first device 600 and/or third device 650. For another example, second device 630 can issue one or more commands through a communication channel associated with the ecosystem of devices to first device 600 and/or third device 650. In some embodiments, the ecosystem of devices includes management devices (e.g., second device 630, servers, resident devices, routers, mesh nodes, and/or network switches), controller devices (e.g., third device 650, smartphones, laptops, and/or communal devices), and/or accessory devices (e.g., first device 600, lights, speakers, cameras, locks, and/or thermostats).

In some embodiments, at least some devices within the ecosystem of devices (e.g., first device 600, second device 630, and/or third device 650) are positioned within the environment. In such embodiments, the devices can communicate via a wired channel and/or a wireless channel (e.g., Bluetooth, Wi-Fi, Thread, and/or a peer-to-peer network). Examples of the environment can include a home, an office, and/or another location. In some embodiments, other devices within the ecosystem of devices can be positioned outside of the environment. In such embodiments, the other devices can communication with devices within the ecosystem of devices using a communication channel (e.g., a wired channel or a longer-range wireless channel, such as WiFi, cellular, or satellite) with a resident device within the environment. In some embodiments, second device 630 is the resident device.

Process 601 begins when first device 600 captures (602) an image of the environment. In some embodiments, the image is a full-resolution image (e.g., standard definition, high definition, and/or elevated resolutions such as 2K, 4K and/or 8K) from a camera of first device 600.

In some embodiments, first device 600 captures the image of the environment in response to detecting that an event occurred, such as first device 600 was restarted and/or turned on, first device 600 is being set up, a predefined time has expired since last capture, a request to capture the image has been received, and/or a perspective of the camera of first device 600 has changed since capturing a previous image. For example, in response to detecting that first device 600's perspective of environment 700 has changed using a gyroscope and/or an accelerometer of first device 600, first device 600 can capture the image of the environment. In other embodiments, first device 600 can capture the image for other purposes (e.g., as an on-going monitoring feature or based on some other trigger). In such embodiments, first device 600 can determine to proceed with process 601 in response to detecting that an event within the environment, such as one or more objects within the environment have moved and/or been added (e.g., a change in orientation of one or more pieces of furniture, movement of one or more other devices, addition of one or more new objects, and/or removal of one or more objects). In some embodiments, the event can include identifying that a person is located in the environment and/or performing some action.

FIG. 7A illustrates an example of the image of the environment described above. As illustrated in FIG. 7A, image 700a captures multiple objects, including lamp 702a, couch 704a, shelf 706a, and table 708a. It should be recognized that each object has different hatching to show color, texture, and/or detail captured by the camera of first device 600.

Returning to FIG. 6, after capturing the image, first device 600 processes (604) the image to generate a representation of the image. In some embodiments, processing the image includes reducing resolution of the image, obscuring information captured within the image, segmenting objects within the image, mapping features, edges, and/or bounds of objects within the image, and/or other image processing steps. For example, after capturing the image, first device 600 can reduce the resolution of the image to allow for less bandwidth usage and/or to provide less information from the image to improve privacy when sending information about the image to other devices (e.g., second device 630). For another example, after capturing the image, first device 600 obscures and/or blurs personal information (e.g., photos of people, address information, information displayed on another device, and/or text information corresponding to an individual) within the image. In some embodiments, the image itself is not sent outside of first device 600 at all and, instead, a representation of the image is sent as described further below.

FIG. 7B illustrates an example of a result of first device 600 processing image 700a. In particular, FIG. 7B illustrates segmentation image 700b (sometimes referred to as a segmentation mask) that includes identified segments within segmentation image 700b (e.g., segment 702b, segment 704b, segment 706b, and segment 708b). In some embodiments, each segment identified corresponds to an element within image 700a, such as different objects, a background, a floor, and/or a wall. In such embodiments, each object can include or not include an identification of such, the identification performed by first device 600. As illustrated in FIG. 7B, much of the detail of image 700a is not included in segmentation image 700b. For example, first device 600 can block in and/or bound objects recognized within image 700a without keeping full detail of such objects. Such segments can be filled with a color, as illustrated by the hatching in FIG. 7B. In some embodiments, segmentation image 700b provides location information corresponding to objects within the environment without perspective, color, and/or as much detail as compared to image 700a. In some embodiments, first device 600 uses segmentation image 700b to provide information about what objects are and/or where objects are without providing the image and/or additional information. It should be recognized that segmentation image 700b can take different forms, such as each segment identified as a specific color, a grayscale intensity level, and/or an integer value.

FIG. 7C illustrates another example of a result of first device 600 processing image 700a. In particular, FIG. 7C illustrates edge map 700c that includes outlining of lamp 702c, couch 704c, shelf 706c, and table 708c. In some embodiments, such outlining captures edges of elements within image 700a but with reduced visual characteristics. Specifically, edge map 700c does not include perspective, color, and/or as much detail as compared to image 700a. However, it should be recognized that edge map 700c retains edges of the objects within image 700a, providing information of the bounds and structure of the objects within image 700a without requiring the same level of resolution as compared to image 700a. It should also be recognized that, in some embodiments, some edges might not be captured in edge map 700c and/or not be detected when generating edge map 600c. In some embodiments, an amount of detail captured within edge map 700c can be adjusted based on different criteria, such as privacy and/or security requirements, allowing different less detail to be sent outside of a device.

It should be recognized that first device 600 can produce both segmentation image 700b and edge map 700c when processing image 700a and/or a single representation of image 700a that includes information from segmentation image 700b and edge map 700c. In some embodiments, first device 600 processes image 700a of the environment using one or more other steps to produce one or more additional representations and/or images of the environment.

Returning to process 601, after processing the image, first device 600 sends (606) the representation (and/or multiple, separate representations) of the image to second device 630. In some embodiments, the representation is sent to second device 630 without sending the image captured by first device 600.

After second device 630 receives the representation of the image from first device 600, second device 630 re-creates (632) the image (sometimes referred to below as the recreated image) based on the representation (e.g., segmentation image 700b and/or edge map 700c). In some embodiments, second device 630 re-creates the image using a stable diffusion process. In such embodiments, stable diffusion can be a generative process that uses a neural network that iteratively refines an image from random noise by reversing a learned noise process based on a conditioning input (e.g., a control net, a text prompt, a previously received representation, a previously created image, segmentation image 700b, and/or edge map 700c). For example, second device 630 can use segmentation image 700b to guide the semantic structure of the re-created image by associating labeled regions with specific object classes and edge map 700c to preserve object boundaries and structural integrity. For another example, second device 630 can use a text prompt describing environment 700 to guide the overall content and composition of the re-created image while edge map 700c can enforce original positioning of objects within the environment. In some embodiments, the re-created image is generated over multiple steps using denoising to predict clean image representations from partially noised inputs. For example, the process can begin with a noise vector and gradually transform the noise vector into a coherent image that aligns with the conditioning inputs.

In some embodiments, second device 630 separates generation of the re-created image into multiple stages such as a preprocessing stage, a conditioning stage, a denoising stage, and/or a post-processing stage. For example, during the preprocessing stage, second device 630 can resize or normalize segmentation image 700b and edge map 700c. During the conditioning stage, these inputs can be embedded into a latent space that aligns with a diffusion model. During the denoising stage, the diffusion model can iteratively generate images over multiple timesteps, reducing noise while respecting conditioning constraints (e.g., from the text prompt, segmentation image 700b, and/or edge map 700c). During the post-processing stage, second device 630 can enhance contrast, adjust color tones, and/or apply inpainting to improve visual coherence.

FIG. 7D illustrates an example of the re-created image described above. As illustrated in FIG. 7D, re-created image 700d resembles image 700a captured by the camera of first device 600. However, as illustrated by the different hatching, as compared to FIG. 7A, one or more visual aspects of re-created image 700d are different from image 700a. Such differences can be due to information that second device 630 input into the stable diffusion process (e.g., the text prompt, segmentation image 700b, and/or edge map 700c). Notably, second device 630 lacked image 700a, which inherently adds to potential variability present in generating re-created image 700d. In some embodiments, differences between re-created image 700d and image 700a include a loss of one or more fine details (e.g., fabric texture, furniture embellishments, stains, and/or blemishes), a change in color of one or more objects within environment 700, identifying information removed from image 700a, and/or a difference in light and/or shadows within environment 700. However, it should be recognized that re-created image 700d includes many of the same details of image 700a. For example, both images include similar objects at the same positions and can share a common image protocol, resolution, aspect ratio, and/or size.

Returning to process 601, after re-creating the image, second device 630 generates (634) a depth map using the re-created image. The depth map is for the environment to identify distances of points in the environment. In some embodiments, the depth map is a two-dimensional array and/or representation that includes values corresponding to distances from first device 600 (e.g., a camera of first device 600). For example, closer points to first device 600 can be represented by lower numerical values and farther points by higher numerical values. In other embodiments, the depth map includes values corresponding to distances between objects in the environment and/or from key points in the environment so as to be able to identify where objects are located in the environment. In contrast to FIGS. 7B and 7C, the depth map provides spatial distance information that enables geometric reasoning about the environment. For example, devices (e.g., first device 600, second device 630, and/or third device 650) can use the depth map for occlusion handling or physical measurement, whereas segmentation image 700b can be used for classification tasks and scene labeling.

After generating the depth map, second device 630 sends the depth map to first device 600 (636a) and/or third device 650 (636b). It should be recognized that second device 630 can send the depth map to more, less, or different devices, such as other devices that control and/or are located in the environment. For example, second device 430 can send the depth map to every accessory device in the environment so that the accessory devices can have information about positions within the environment. In some embodiments, the depth map includes identification of objects within the environment and/or other information about the environment, such as information included in and/or determined by segmentation image 700b and/or edge map 700c.

In some embodiments, in conjunction with (e.g., before, after, while, and/or as part of) sending the depth map to first device 600 and third device 650, second device 630 sends one or more commands to first device 600 and/or third device 650. For example, second device 630 can command first device 600 and/or third device 650 to restart and/or reinitialize (e.g., to recover from an error and/or to reestablish one or more settings). For another example, second device 630 can command first device 600 to move via one or more movement components of first device 600 (e.g., to be centered on a different point within the environment and/or to provide a different perspective of environment 700). For another example, second device 630 can command first device 600 and/or third device 650 to update one or more settings based on the depth map such as distance to the floor of the environment and/or position within the environment 700. Such updates can enable better object and/or location detection within the environment. For another example, second device 630 can command first device 600 and/or third device 650 to assign a parameter to a zone and/or portion of the environment (e.g., assigning a tag to a door, window, and/or component of the environment and/or setting a device as a default device for detecting subjects within the portion of the environment).

After receiving the depth map from second device 630, first device 600 can perform (608) one or more operations based on (and/or using) the depth map. For example, first device 600 can update one or more device settings based on the depth map (e.g., distance to a portion of the environment and/or objects within the environment, focus point of one or more input components of first device 600, and/or location of one or more zones within the environment). For another example, first device 600 can send subsequent communications to second device 630, third device 650, and/or other devices within the ecosystem of devices (e.g., updating a location of another device, confirming one or more inferences about the environment, and/or confirming receipt of the depth map and/or the one or more commands). For another example, first device 600 can reclassify one or more objects and/or distances to the one or more objects based on the depth map. For another example, first device 600 can identify a location of a person within the environment using the depth map in conjunction with another image captured of the environment at the same perspective as the image described above, the other image including the person. In such an example, the location of the person can be determined in a privacy-preserving way (e.g., without capturing an outline of the person and/or sending an image of the person to another device). In particular, with the depth map, first device 600 can calculate a height of first device 600 above a floor and, after, calculate a homography map between the floor and a camera plane of first device 600. Using the homography map, first device 600 can determine the location of the person by identifying a location of feet of the person.

After receiving the depth map from second device 630, third device 650 can perform (658) one or more operations based on (and/or using) the depth map. For example, if third device 650 includes and/or is in communication with a display and/or speaker, third device 650 can output a suggestion to reposition first device 600 and/or third device 650 (e.g., a subsequent turn and/or movement to a different position within the environment). For another example, if third device 650 is a personal device and/or a device associated with a user, third device 650 can reconfigure one or more audio settings based on third device 650's location as compared to one or more speakers within the environment (e.g., based on the depth map). For another example, if third device 650 includes and/or is in communication with a display, third device 650 can update one or more visual characteristics of currently playing content based on the depth map (e.g., updating a size of a user interface, control, and/or text for readability). For another example, if third device 650 includes and/or is in communication with a speaker, third device 650 can update one or more audio characteristics based on the depth map (e.g., updating a position of a surround point, altering a setting corresponding to a speaker, and/or altering a speaker assignment).

After (and/or while) sending the depth map to first device 600 and/or third device 650, second device 630 can perform (638) one or more operations based on (and/or using) the depth map. For example, second device 630 can reassign one or more devices (e.g., first device 600, third device 650, and/or other devices within the ecosystem of devices) to different locations and/or groupings of devices (e.g., devices assigned to monitor and/or participate in automations based on different locations within the environment, such as a living room, a kitchen, and/or a bedroom). For another example, second device 630 can assign one or more devices (e.g., first device 600, third device 650, and/or other devices within the ecosystem of devices) to automations (e.g., person detection corresponding to a location of the environment, such as a driveway and/or an entryway and/or engaging locks at certain times based on location within the environment) based on the depth map. For another example, if second device 630 includes and/or is in communication with a display and/or speaker, second device 630 can output a suggestion to reconfigure one or more devices (e.g., provide a suggested additional move of a device based on a determination that the current location is not optimal based on the depth map).

In some embodiments, process 601 is repeated and/or continuous. For example, first device 600 captures an image (and initiates process 601) repeatedly every threshold amount of time (e.g., once a day, every hour, once a minute, and/or other intervals of time). For another example, a device (e.g., first device 600 and/or new devices added to the ecosystem of devices) capture an image (and initiates process 601) upon initialization, initial setup, and/or powering on. For another example, first device 600 captures an image (and initiates process 601) in response to detecting a threshold amount of change of environment 700 (e.g., a threshold amount of movement, repositioning of objects within environment 700, and/or detection of additional people within environment 700).

FIG. 8 is a flow diagram illustrating a process (e.g., process 800) for remotely generating a depth map in accordance with some embodiments. Some operations in process 800 are, optionally, combined, the orders of some operations are, optionally, changed, and some operations are, optionally, omitted.

As described below, process 800 provides an intuitive way for remotely generating a depth map in accordance with some embodiments. Process 800 reduces the cognitive burden on a user, thereby creating a more efficient human-machine interface. For battery-operated computing devices, enabling a user to interact with such devices faster and more efficiently conserves power and increases the time between battery charges.

In some embodiments, process 800 is performed at a first device (e.g., an accessory device, a camera, an accessory device that includes a camera, and/or a first computer system) (e.g., 600) that is in communication (e.g., wired communication and/or wireless communication) with (and/or includes) one or more input components (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface). In some embodiments, the first device is a watch, a phone, a tablet, a fitness tracking device, a processor, a head-mounted display (HMD) device, a communal device, a media device, a speaker, a television, an electronic device, and/or a personal computing device. In some embodiments, the first device is an accessory device (e.g., a device dependent on another device and/or controllable through another device) such as a camera accessory device or accessory device that includes the one or more input components.

The first device captures (802) (e.g., 602), via the one or more input components, an image (e.g., an image and/or scan) (e.g., 700a) of an environment. In some embodiments, the first device captures the image of the environment in response to detecting a change to the environment (e.g., presence and/or movement of a subject, adjustment of an object and/or component of the environment such as furniture, and/or a change in status of the environment such as activation of lights and/or loss of environmental light) and/or detecting a change to the first device (e.g., movement of the first device within the environment, repositioning of the first device to a different view of the environment, and/or change in status such as resetting, plugging in, and/or activation). In some embodiments, the first device captures the image of the environment as part of an initial setup procedure (e.g., when the first device is paired to a network and/or able to communicate with other devices). In some embodiments, the first device captures the image of the environment periodically (e.g., occurrence of a certain event and/or every that that a threshold amount of time has passed). In some embodiments, capturing the image of the environment includes locally storing visual data corresponding to the environment based on the first device's field of view of the environment. In some embodiments, capturing the image of the environment includes producing a digital representation of the environment. In some embodiments, the image of the environment is a full resolution image. In some embodiments, the image is a scan of the environment. In some embodiments, the environment is a locality and/or portion of a home, office, and/or public place. In some embodiments, the environment is a physical location. In some embodiments, the environment has one or more virtual and/or defined bounds (e.g., detection zones, zones to disregard, and/or sections).

In response to (804) (or after) capturing the image of the environment, the first device processes (806) (e.g., 604) the image to generate a first representation (and/or a first set of representations) (e.g., 700b, and/or 700c) of the environment (e.g., a filtered image of the environment, a lower resolution image of the environment, and/or a processed image of the environment). In some embodiments, processing the image to generate the first representation of the environment includes utilizing one or more computer vision techniques to provide information about the image without providing the image itself. In some embodiments, the one or more computer vision techniques include image segmentation, edge detection, object detection, and/or other mapping algorithms that provide a computer system the ability to make inferences about an image without having the image. In some embodiments, image segmentation is a process of partitioning an image into multiple regions or segments, often based on pixel characteristics like color, texture, or intensity, to simplify analysis and object recognition. In some embodiments, edge detection is a process that identifies boundaries or edges by finding abrupt changes in image intensity. In some embodiments, object detection is a process that identifies and localizes objects by recognizing one or more boundaries of an object and labelling the object. In some embodiments, the first representation of the environment is a set of one or more representations of the environment (e.g., a first representation is created through a first technique and a second representation, separate from the first representation, is created through a second technique different from the first technique).

In response to (804) capturing the image of the environment, the first device sends (808) (e.g., 606), to a second device (e.g., a communal device, a resident device, a hub device, a server, a second computer system, and/or a remote computer system) (e.g., 630) separate from the first device, the first representation of the environment (e.g., with or without sending the image). In some embodiments, the second device is a phone, a tablet, a communal device, a server, a remote computer system, a media device, a television, an electronic device, and/or a personal computing device. In some embodiments, the first device and the second device are connected to a common communication channel (e.g., a local wireless network and/or mesh network such as a thread network). In some embodiments, sending the first representation of the environment includes sending, to the second device through a local communication channel, the first representation of the environment. In some embodiments, the second device is remote from the first device (e.g., a remote server and/or computer system). In some embodiments, sending the first representation of the environment includes sending, to the second device through a remote communication channel, the first representation of the environment.

After sending the first representation of the environment, the first device receives (810) (e.g., 636a), from the second device, a second representation (e.g., the depth map, as described above with respect to FIG. 6) of the environment (and/or a depth map of the environment) different from the first representation of the environment. In some embodiments, the second representation is a processed image (e.g., a depth map and/or other form of mapping of the environment) of the environment that can be used to make inferences about the environment. In some embodiments, the second representation (and/or a depth map) represents distances from a particular field of view (e.g., view of the first device while capturing the image of the environment and/or from a first location of the first device) to multiple points within the environment. In some embodiments, the second representation is based on the first representation. In some embodiments, the second representation includes a portion of the first representation. In some embodiments, the second representation includes a portion that is based on but different from the first representation.

In response to (or after) receiving the second representation of the environment, the first device performs (812) (e.g., 608), based on the second representation of the environment, one of more operations (e.g., update operations, recognition operations, and/or detection operations). In some embodiments, performing the one or more operations includes updating one or more parameters of the first device (e.g., distance to an object and/or point within the environment such as a floor and/or a wall), initiating one or more processes (e.g., a setup process and/or tuning process), performing one or more recognition operations (e.g., attempting to detect a subject and/or point of interest within the environment), and/or performing one or more detection operations (e.g., redefining one or more bounds within the environment, redefining a location of one or more items within the environment, and/or redefining one or more preexisting zones within the environment).

In some embodiments, the image of the environment is a first image. In some embodiments, after capturing the first image, the first device captures, via the one or more input components, a second image (e.g., an image and/or scan) (e.g., as described above with respect to FIG. 6) of the environment. In some embodiments, the first device captures the second image of the environment in response to detecting a change (and/or another change) to the environment (e.g., presence and/or movement of a subject, adjustment of an object and/or component of the environment such as furniture, and/or a change in status of the environment such as activation of lights and/or loss of environmental light) and/or detecting a change (and/or another change) to the first device (e.g., movement of the first device within the environment, repositioning of the first device to a different view of the environment, and/or change in status such as resetting, plugging in, and/or activation). In some embodiments, the first device captures the second image of the environment after a threshold amount of time has passed since capturing the first image of the environment. In some embodiments, capturing the second image of the environment includes locally storing visual data corresponding to the environment based on the first device's field of view of the environment. In some embodiments, capturing the second image of the environment includes producing a digital representation of the environment. In some embodiments, the second image of the environment is a full resolution image. In some embodiments, the second image is a scan of the environment. In some embodiments, in response to (or after) capturing the second image of the environment, the first device processes the second image to generate a third representation (and/or a first set of representations) of the environment (e.g., a filtered image of the environment, a lower resolution image of the environment, and/or a processed image of the environment) (e.g., as described above with respect to FIG. 6). In some embodiments, processing the second image to generate the third representation of the environment includes utilizing the one or more computer vision techniques to provide information about the second image without providing the second image itself. In some embodiments, the third representation of the environment is a set of one or more representations of the environment (e.g., a first representation is created through a first technique and a second representation, separate from the third representation, is created through a second technique different from the first technique). In some embodiments, in response to capturing the second image of the environment, the first device sends, to the second device, the third representation of the environment (e.g., with or without sending the second image) (e.g., as described above with respect to FIG. 6). In some embodiments, sending the third representation of the environment includes sending, to the second device through a local communication channel, the third representation of the environment. In some embodiments, sending the third representation of the environment includes sending, to the second device through a remote communication channel, the third representation of the environment. In some embodiments, after sending the third representation of the environment, the first device receives, from the second device, a fourth representation of the environment (and/or a depth map of the environment) different from the third representation of the environment (e.g., as described above with respect to FIG. 6). In some embodiments, the fourth representation is a processed image (e.g., a depth map and/or other form of mapping of the environment) of the environment that can be used to make inferences about the environment. In some embodiments, the fourth representation (and/or a depth map) represents distances from a particular field of view (e.g., view of the first device while capturing the image of the environment and/or from a first location of the first device) to multiple points within the environment. In some embodiments, the fourth representation is based on the third representation. In some embodiments, the fourth representation includes a portion of the third representation. In some embodiments, the fourth representation includes a portion that is based on but different from the third representation. In some embodiments, in response to (or after) receiving the fourth representation of the environment, the first device performs, based on the fourth representation of the environment, one of more additional operations different from the one or more operations (e.g., update operations, recognition operations, and/or detection operations) (e.g., as described above with respect to FIG. 6). In some embodiments, performing the one or more additional operations includes updating one or more parameters of the first device (e.g., distance to an object and/or point within the environment such as a floor and/or a wall), initiating one or more processes (e.g., a setup process and/or tuning process), performing one or more recognition operations (e.g., attempting to detect a subject and/or point of interest within the environment), and/or performing one or more detection operations (e.g., redefining one or more bounds within the environment, redefining a location of one or more items within the environment, and/or redefining one or more preexisting zones within the environment).

In some embodiments, the image of the environment is captured in response to detecting a change (e.g., adding, removing, and/or modifying an object and/or subject within the environment such as a user walking through a field of view of the first device, movement of a piece of furniture, and/or reconfiguring of one or more devices) in the environment (e.g., as described above with respect to FIG. 6). In some embodiments, before capturing the image of the environment, the first device detects a change in the environment and/or a change of a threshold amount within the environment as compared to a previous image and/or scan of the environment. In some embodiments, the first device detects the change in the environment by continuously sampling the environment (e.g., continuously comparing points within the environment between captured images and/or scans).

In some embodiments, detecting the change in the environment includes detecting, via the one or more input components, movement of the first device (e.g., a change in field of view of one or more input components of the first device, an angular change of the first device, and/or positional change of the first device within the environment) (e.g., as described above with respect to FIG. 6). In some embodiments, the first device detects the movement of the first device by a sensor and/or internal component such as an accelerometer and/or position sensor. In some embodiments, the first device detects the movement of the first device based on information from the environment (e.g., the first device detects that a current field of view is different from a previous field of view by detecting one or more differences between points within the environment). In some embodiments, the first device detects the movement of the first device by receiving, from another device, information for determining that the first device has been moved.

In some embodiments, detecting the change in the environment includes detecting, via the one or more input components, movement of one or more objects (e.g., furniture, devices, and/or items such as lights, books, and/or other moveable items) within the environment (e.g., as described above with respect to FIG. 6). In some embodiments, the first device detects the movement of the one or more objects through one or more input components (e.g., depth sensor, camera, and/or IR sensor). In some embodiments, the first device detects the movement of the one or more objects by comparing distances of the one or more objects (e.g., from the first device and/or from another device) against previously detected distances (e.g., from the first device and/or from another device). In some embodiments, the one or more objects do not include the first device.

In some embodiments, the image of the environment is captured while setting up the first device (e.g., during an initial setup and/or after a device reset) (e.g., as described above with respect to FIG. 6). In some embodiments, the first device utilizes the image of the environment within the setup process (e.g., the first device utilizes the image of the environment and/or the second representation of the environment to establish a position with the environment and/or to configure one or more device settings).

In some embodiments, the first representation of the environment has a first resolution (e.g., a reduced resolution, a lower resolution, and/or a partial resolution) (e.g., as described above with respect to FIGS. 6 and/or 700a). In some embodiments, the image of the environment has a second resolution (e.g., a full resolution and/or a raw resolution) (e.g., as described above with respect to FIG. 6, 700b, and/or 700c). In some embodiments, the first resolution is less than (e.g., is reduced from and/or is partially) the second resolution. In some embodiments, the reduced resolution of the first resolution as compared to the second resolution allows the first device to save on bandwidth in sending the first representation to the second device as compared to sending the image. In some embodiments, the first device uses the first representation in place of the image to provide increased privacy (e.g., only providing necessary information and/or providing abstracted and/or non-identifying information).

In some embodiments, the first representation of the environment includes identification of one or more discrete segments within the image of the environment (e.g., as described above with respect to FIGS. 6 and/or 700b). In some embodiments, the first representation of the environment includes a segmentation image. In some embodiments, the segmentation image represents regions, objects, surfaces, and/or aspects of the environment through the one or more discrete segments. In some embodiments, the one or more discrete segments provide identification of objects and/or isolation of areas of interest and/or include labels to provide recognition of objects. In some embodiments, the first representation of the environment is a two-dimensional image without perspective (e.g., segments of the first representation of the environment are separated and/or segmented from each other but the first representation loses resolution and/or detail as compared to the image of the environment).

In some embodiments, the first representation includes identification of one or more edges detected within the image of the environment (e.g., as described above with respect to FIGS. 6 and/or 700c). In some embodiments, the first representation of the environment is a two-dimensional image without perspective. In some embodiments, the first representation of the environment is an edge map (e.g., an image that provides an indication of edges detected within the image of the environment and/or a mapping of changes in direction of components of objects within the environment as viewed from the first device). In some embodiments, the edge map provides highlights and/or indications of structures, objects, and/or changes (e.g., sharp changes and/or changes over a threshold) within the environment.

In some embodiments, the first representation of the environment includes identification (e.g., label, bound, and/or tag) of one or more objects within the image of the environment (e.g., as described above with respect to FIG. 6, 700b, and/or 700c). In some embodiments, the first representation of the environment is a mapping of the one or more objects recognized within the image of the environment (e.g., visualized as bounds and/or tags corresponding to locations within the environment without including representations of the one or more objects). In some embodiments, the first device identifies the one or more items within the image of the environment through an object recognition process (e.g., a process that tags and/or recognizes objects based on a threshold score that the object matches a known item).

In some embodiments, the first representation of the environment includes multiple, separate representations of the environment (e.g., as described above with respect to FIG. 6, 700b, and/or 700c). In some embodiments, the first device processes the image of the environment through multiple processes and/or image processing methods. In some embodiments, the multiple, separate representations of the environment are separate products of different processing types. In some embodiments, the multiple, separate representations of the environment provide different information corresponding to the environment (e.g., the multiple, separate representations of the environment provide different basis for generating inferences about the environment).

In some embodiments, the second representation of the environment is a depth map (e.g., as described above with respect to FIG. 6) of the environment. In some embodiments, the depth map of the environment is a representation of distances from the first device to a plurality of points within the environment from the perspective of the first device (and/or a field of view of the one or more input components of the first device). In some embodiments, the first device uses the depth map of the environment to understand the first device's position (and/or position of one or more objects within the environment) in three-dimensional space as compared to the points of the environment.

In some embodiments, performing the one or more operations include updating a location corresponding to the first device (e.g., reassigning the first device to a new location within a locality such as a home and/or office and/or adjusting an established location to match a repositioning of the first device) (e.g., as described above with respect to FIG. 6), detecting a location of a user within the environment (e.g., as described above with respect to FIG. 6), updating a location corresponding to another device (e.g., sending to the other device a distance between the other device and the first device and/or the other device and a point within the environment to allow the other device to reconfigure its known location) (e.g., as described above with respect to FIG. 6), assigning one or more zones within the environment (e.g., defining bounds and/or areas of a locality such as floors, walls, ceilings, and/or other aspects of the environment) (e.g., as described above with respect to FIG. 6), adjusting one or more device settings of the first device (e.g., as described above with respect to FIG. 6), or any combination thereof. In some embodiments, detecting the location of the user within the environment includes detecting an activity of the user within the environment such as interacting with an object, surface, and/or structure within the environment. In some embodiments, adjusting the one or more device setting of the first device includes adjusting device configurations such as high, distance from another device, and/or distance from a hub and/or resident device. In some embodiments, adjusting the one or more device settings includes adjusting a setting of one or more of the one or more input components (e.g., altering a reference point, adjusting exposure of a camera, and/or adjusting a focus point).

In some embodiments, the first device is an accessory device (e.g., a dependent device and/or a device of an ecosystem of devices) including a camera. In some embodiments, the accessory device is a device that depends on a connection to another device to provide its fully functionality (e.g., a mobile phone to communicate to remote devices and/or a more powerful device to process information and/or make inferences based on captured information). In some embodiments, the accessory device is part of an ecosystem of devices (e.g., a set of devices that share an account, network, and/or protocol) configured to communicate with other devices within the ecosystem of devices.

In some embodiments, the second device is a resident device (e.g., a more powerful device, a local computing device, and/or a communal device). In some embodiments, the resident device is a device that is affixed to a position within the environment (e.g., mounted to a wall, positioned within a kitchen, and/or setup at a point within a home). In some embodiments, the resident device is configured to manage an ecosystem of devices (e.g., a set of accessory devices connected to the resident device through a communication channel such as a Thread network, mesh network, and/or wireless network).

In some embodiments, the second device is a (e.g., locally within the environment, and/or remotely hosted, away from the environment) server. In some embodiments, the second device provides for communication between devices of an ecosystem of devices. In some embodiments, the second device hosts an application server that provides connected devices additional functionality (e.g., additional computing resources and/or access to models and/or resources stored on the server).

Note that details of the processes described above with respect to process 800 (e.g., FIG. 8) are also applicable in an analogous manner to other processes described herein. For example, process 900 optionally includes one or more of the characteristics of the various processes described above with reference to process 800. For example, the first device of process 800 can be the second device of process 800. For brevity, these details are not repeated herein.

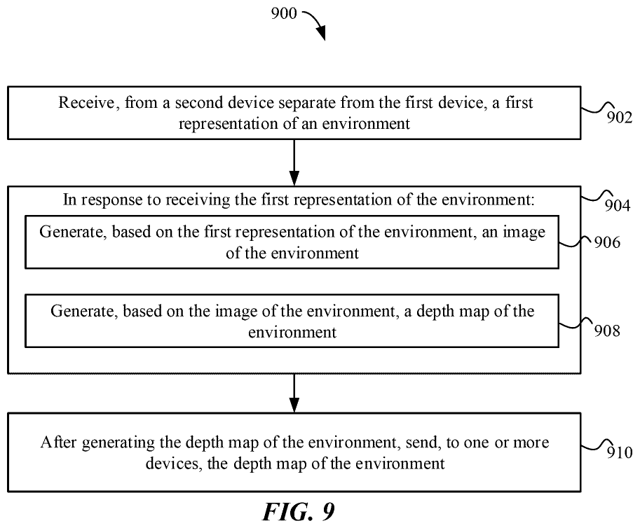

FIG. 9 is a flow diagram illustrating a process (e.g., process 900) for re-creating an image in accordance with some embodiments. Some operations in process 900 are, optionally, combined, the orders of some operations are, optionally, changed, and some operations are, optionally, omitted.

As described below, process 900 provides an intuitive way for re-creating an image in accordance with some embodiments. Process 900 reduces the cognitive burden on a user, thereby creating a more efficient human-machine interface. For battery-operated computing devices, enabling a user to interact with such devices faster and more efficiently conserves power and increases the time between battery charges.

In some embodiments, process 900 is performed at a first device (e.g., a first computer system, a resident device, a hub device, a communal device, and/or a server) (e.g., 630). In some embodiments, the first device is a phone, a tablet, a communal device, a server, a remote computer system, a media device, a television, an electronic device, and/or a personal computing device.

The first device receives (902) (e.g., 606), from a second device (e.g., a second computer system, a remote computer system, a camera, an accessory device that includes a camera, and/or an accessory device) (e.g., 600) separate (e.g., different and/or remote) from the first device, a first representation (e.g., a reduced resolution image and/or preprocessed image) (e.g., 700a, 700b, and/or 700c) of an environment (and/or a set of one or more representations of the environment). In some embodiments, the second device is a watch, a phone, a tablet, a fitness tracking device, a processor, a head-mounted display (HMD) device, a communal device, a media device, a speaker, a television, an electronic device, and/or a personal computing device. In some embodiments, the second device is an accessory device (e.g., a device dependent on another device and/or controllable through another device) such as a camera accessory device or accessory device that includes the one or more input components. In some embodiments, the first device and the second device are connected to a common communication channel (e.g., a local wireless network and/or mesh network such as a thread network). In some embodiments, receiving the first representation of the environment includes receiving, from the second device through a local communication channel, the first representation of the environment. In some embodiments, the second device is remote from the first device (e.g., a remote server and/or computer system). In some embodiments, receiving the first representation of the environment includes receiving, from the second device through a remote communication channel, the first representation of the environment. In some embodiments, the first representation of the environment is a processed representation of the environment (e.g., as discussed above with respect to process 800). In some embodiments, the first representation of the environment is a set of one or more representations of the environment (e.g., one representation is created through a first technique and another representation is created through a second technique different from the first technique).

In response to (904) (and/or after) receiving the first representation of the environment, the first device generates (906) (e.g., via one or more image generation models stored on the first device and/or accessible by the first device such as stable diffusion and/or another available ML model) (e.g., 632), based on (and/or using) the first representation of the environment, an image (e.g., 700d) of the environment. In some embodiments, generating the image of the environment includes inputting, to an image generation model (e.g., a latent diffusion model and/or generative adversarial network), the first representation of the environment and/or one or more other parameters (e.g., a descriptive prompt and/or one or more other variable to refine generation). In some embodiments, the image generation model is locally stored on the first device and/or accessible by the first device through a communication channel and/or service. In some embodiments, after inputting the first representation of the environment, the first device, using the image generation mode, generates a series of one or more images (e.g., a predefined number of steps and/or until an image that scores a threshold clarity is generated) by generating an initial noise image then selectively adds noise and denoises each image to add detail and/or quality until a final image is denoised. In some embodiments, the final image is the image of the environment.

In response to (904) receiving the first representation of the environment, the first device generates (908) (e.g., 634), based on the image of the environment, a depth map (e.g., as described above with respect to FIG. 6) of the environment. In some embodiments, the depth map of the environment is a processed image of the environment that can be used to make inferences about the environment (e.g., orientation of a device based on distance from one or more points of the environment and/or positioning with respect to one or more objects within the environment). In some embodiments, the depth map represents distances from a particular field of view (e.g., view of the second device while capturing the image of the environment and/or from a first location of the second device) to multiple points within the environment.

After generating the depth map of the environment, the first device sends (910) (e.g., 636a and/or 636b), to one or more devices (e.g., that includes and/or does not include the second device), the depth map of the environment. In some embodiments, the first device sends the depth map of the environment through a local communication channel (e.g., a local wireless network and/or mesh network) or a remote communication channel. In some embodiments, the one or more devices includes the second device. In some embodiments, the one or more devices are separate from the second device. In some embodiments, the one or more devices are accessory devices in communication with the first device (e.g., through a local communication channel such as a wireless network and/or mesh network and/or remote communication channel). In some embodiments, the one or more devices are within an ecosystem of devices (e.g., that includes the first device and/or the second device). In some embodiments, the first device sends the depth map to all devices within an ecosystem of devices (e.g., devices previously paired to a mesh network of devices and/or devices that are associated with a common account and/or control application). In some embodiments, the depth map is sent to the one or more devices at once. In some embodiments, the depth map is different to different devices included in the one or more devices at different times, such as when such devices come online or request the depth map.

In some embodiments, the one or more devices includes the second device. In some embodiments, sending the depth map of the environment includes sending, to the second device, the depth map of the environment. In some embodiments, the first device sends the depth map of the environment to all connected devices and/or all devices associated with an ecosystem of devices (e.g., devices associated with a resident device and/or an account shared between devices).

In some embodiments, the one or more devices includes a third device (e.g., another device and/or a device in communication with the first device) (e.g., 650) different from the second device. In some embodiments, the third device and the second device are different in location within the environment. In some embodiments, the third device and the second device are different in type of device (and/or type of accessory device). In some embodiments, the third device and the second device are different in included components (e.g., one or more different input components and/or other components). In some embodiments, the third device is different from the first device.

In some embodiments, the one or more devices does not include the second device. In some embodiments, the one or more devices are separate from the second device. In some embodiments, the one or more devices and the second device share a common connection to the first device (and/or each other through an ecosystem of devices). In some embodiments, the first device communicates to the second device and the one or more device through separate and/or different communication channels (e.g., a Thread network, a remote connection, a mesh network, or a wireless connection).

In some embodiments, the first representation of the environment has a first resolution (e.g., a reduced resolution, a lower resolution, and/or a partial resolution) (e.g., as described above with respect to FIG. 6, 700b, and/or 700c). In some embodiments, the image of the environment has a second resolution (e.g., a full resolution and/or a raw resolution) (e.g., as described above with respect to FIGS. 6 and/or 700d). In some embodiments, the first resolution is less than (e.g., is reduced from and/or is partially) the second resolution. In some embodiments, the reduced resolution of the first resolution as compared to the second resolution allows the first device to save on bandwidth in sending the first representation to the second device as compared to sending the image. In some embodiments, the first device uses the first representation in place of the image to provide increased privacy (e.g., only providing necessary information and/or providing abstracted and/or non-identifying information).

In some embodiments, the first representation of the environment includes identification of one or more discrete segments within the image of the environment (e.g., as described above with respect to FIGS. 6 and/or 700b). In some embodiments, the first representation of the environment includes a segmentation image. In some embodiments, the segmentation image represents regions, objects, surfaces, and/or aspects of the environment through the one or more discrete segments. In some embodiments, the one or more discrete segments provide identification of objects and/or isolation of areas of interest and/or include labels to provide recognition of objects. In some embodiments, the first representation of the environment is a two-dimensional image without perspective (e.g., segments of the first representation of the environment are separated and/or segmented from each other but the first representation loses resolution and/or detail as compared to the image of the environment).

In some embodiments, the first representation includes identification of one or more edges detected within the image of the environment (e.g., as described above with respect to FIGS. 6 and/or 700c). In some embodiments, the first representation of the environment is a two-dimensional image without perspective. In some embodiments, the first representation of the environment is an edge map (e.g., an image that provides an indication of edges detected within the image of the environment and/or a mapping of changes in direction of components of objects within the environment as viewed from the first device). In some embodiments, the edge map provides highlights and/or indications of structures, objects, and/or changes (e.g., sharp changes and/or changes over a threshold) within the environment.

In some embodiments, the first representation of the environment includes identification (e.g., label, bound, and/or tag) of one or more objects within the image of the environment (e.g., as described above with respect to FIGS. 6 and/or 700b). In some embodiments, the first representation of the environment is a mapping of the one or more objects recognized within the image of the environment (e.g., visualized as bounds and/or tags corresponding to locations within the environment without including representations of the one or more objects). In some embodiments, the first device identifies the one or more items within the image of the environment through an object recognition process (e.g., a process that tags and/or recognizes objects based on a threshold score that the object matches a known item).

In some embodiments, the first representation of the environment includes multiple, separate representations of the environment (e.g., as described above with respect to FIG. 6, 700b, and/or 700c). In some embodiments, the first device processes the image of the environment through multiple processes and/or image processing methods. In some embodiments, the multiple, separate representations of the environment are separate products of different processing types. In some embodiments, the multiple, separate representations of the environment provide different information corresponding to the environment (e.g., the multiple, separate representations of the environment provide different basis for generating inferences about the environment). In some embodiments, the first device combines the multiple, separate representations of the environment to generate the image of the environment. In some embodiments, the first device utilizes different representations of the multiple, separate representations of the environment to provide different aspects for generating the image of the environment (e.g., utilizing the different representations to provide corresponding inferences about the environment such as segmentation to provide bounds of objects, edge mapping to provide structure of objects, and/or object identification to add context of the environment).

In some embodiments, in conjunction with (e.g., before, while, with, or after) sending the depth map of the environment, the first device sends (e.g., 608 and/or 658), to the one or more devices, one or more commands (and/or requests) (e.g., as described above with respect to FIG. 6) to be completed by the one or more devices. In some embodiments, the first device sends the one or more commands within a message that includes the depth map and the one or more commands. In some embodiments, the first device sends the one or more commands separately from the depth map (e.g., through a different communication channel and/or at a different point in time). In some embodiments, the first device sends a common command to the one or more devices. In some embodiments, the first device sends different and/or separate commands to the one or more devices (e.g., sending commands based on information corresponding to a particular device and/or sending commands to address a particular change within the environment).

In some embodiments, the one or more commands include updating a location corresponding to a device of the one or more devices (e.g., reassigning the device to a new location within a locality such as a home and/or office and/or adjusting an established location to match a repositioning of the device) (e.g., as described above with respect to FIGS. 6, 608, and/or 658), detecting a location of a user within the environment, updating a location corresponding to a device of the one or more devices (e.g., sending to the other device a distance between the other device and the device and/or the other device and a point within the environment to allow the other device to reconfigure its known location) (e.g., as described above with respect to FIGS. 6, 608, and/or 658), assigning one or more zones within the environment (e.g., defining bounds and/or areas of a locality such as floors, walls, ceilings, and/or other aspects of the environment) (e.g., as described above with respect to FIGS. 6, 608, and/or 658), adjusting one or more device settings of to a device of the one or more devices (e.g., as described above with respect to FIGS. 6, 608, and/or 658), or any combination thereof. In some embodiments, detecting the location of the user within the environment includes detecting an activity of the user within the environment such as interacting with an object, surface, and/or structure within the environment. In some embodiments, adjusting the one or more device setting of the device of the one or more devices includes adjusting device configurations such as high, distance from another device, and/or distance from a hub and/or resident device. In some embodiments, adjusting the one or more device settings of the device of the one or more devices includes adjusting a setting of one or more of the one or more input components of the device (e.g., altering a reference point, adjusting exposure of a camera, and/or adjusting a focus point).

In some embodiments, after sending the depth map of the environment, the first device reconfigures (e.g., alters one or more device settings of, removes one or more devices of, reassigns one or more devices of, and/or reinitializes one or more devices of) (e.g., 638) the one or more devices (and/or a device of the one or more devices). In some embodiments, adjusting the one or more device setting of the device of the one or more devices includes adjusting device configurations such as high, distance from another device, and/or distance from a hub and/or resident device. In some embodiments, adjusting the one or more device settings of the device of the one or more devices includes adjusting a setting of one or more of the one or more input components of the device (e.g., altering a reference point, adjusting exposure of a camera, and/or adjusting a focus point). In some embodiments, reassigning the one or more devices includes altering a location corresponding to the one or more devices, adjusting an automation and/or process to include a different set of devices of the one or more devices, and/or remapping a set of devices of the one or more devices to a control (e.g., an action to be carried out by the set of devices such as turning on lights, arming security cameras, and/or one or more actions carried out by accessory devices).

In some embodiments, the first device is a resident device (e.g., a more powerful device, a local computing device, and/or a communal device). In some embodiments, the resident device is a device that is affixed to a position within the environment (e.g., mounted to a wall, positioned within a kitchen, and/or setup at a point within a home). In some embodiments, the resident device is configured to manage an ecosystem of devices (e.g., a set of accessory devices connected to the resident device through a communication channel such as a Thread network, mesh network, and/or wireless network).

In some embodiments, the second device is an accessory device (e.g., a dependent device and/or a device of an ecosystem of devices) including a camera. In some embodiments, the accessory device is a device that depends on a connection to another device to provide its fully functionality (e.g., a mobile phone to communicate to remote devices and/or a more powerful device to process information and/or make inferences based on captured information). In some embodiments, the accessory device is part of an ecosystem of devices (e.g., a set of devices that share an account, network, and/or protocol) configured to communicate with other devices within the ecosystem of devices.

In some embodiments, the one or more devices are part of an ecosystem of devices (e.g., a set of devices that share an account, network, and/or protocol configured to communicate with other devices within the ecosystem of devices). In some embodiments, the ecosystem of devices is established through a local communication channel such as Wi-Fi, Thread, and/or other accessory device communication protocols. In some embodiments, the ecosystem of devices is managed and/or enabled through a controlling device (e.g., a service, resident device, communal device, and/or hub device). In some embodiments, the one or more devices are managed by another device of the ecosystem of devices (e.g., the one or more devices carry out commands and/or provide information for the other devices of the ecosystem of devices).

Note that details of the processes described above with respect to process 900 (e.g., FIG. 9) are also applicable in an analogous manner to the processes described herein. For example, process 800 optionally includes one or more of the characteristics of the various processes described herein with reference to process 900. For example, the first representation of process 900 can be the first representation of the environment of process 800. For brevity, these details are not repeated herein.

In some embodiments, one or more of processes 400, 500, 800, and 900 (FIGS. 4, 5, 8, and 9) is performed at a first computer system (as described herein) via a system process (e.g., an operating system process and/or a server system process) that is different from one or more applications executing and/or installed on the first computer system.

In some embodiments, one or more of processes 400, 500, 800, and 900 (FIGS. 4, 5, 8, and 9) is performed at a first computer system (as described herein) by an application that is different from a system process.

In some embodiments, the instructions of the application, when executed, control the first computer system to perform one or more of processes 400, 500, 800, and 900 (FIGS. 4, 5, 8, and 9) by calling an application programming interface (API) provided by the system process. In some embodiments, the application performs at least a portion of one or more of processes 400, 500, 800, and 900 (FIGS. 4, 5, 8, and 9) without calling the API.

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, the application is an application that is pre-installed on the first computer system at purchase (e.g., a first party application). In some embodiments, the application is an application that is provided to the first computer system via an operating system update file (e.g., a first party application). In some embodiments, the application is an application that is provided via an application store. In some embodiments, the application store is pre-installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform one or more of processes 400, 500, 800, and 900 (FIGS. 4, 5, 8, and 9) by calling an application programming interface (API) provided by the system process using one or more parameters.

In some embodiments, at least one API is a software module (e.g., a collection of computer-readable instructions) that provides an interface that allows a different set of instructions (e.g., API calling instructions) to access and use one or more functions, processes, procedures, data structures, classes, and/or other services provided by a set of implementation instructions of the system process. The API can define one or more parameters that are passed between the API calling instructions and the implementation instructions.

As described above, in some embodiments, an application controls a computer system to perform processes 400, 500, 800, and 900 (FIGS. 4, 5, 8, and 9) by calling an application programming interface (API) provided by a system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, API 176 defines a first API call that can be provided by API calling instructions 174, wherein the definition for the first API call specifies call parameters described above with respect to processes 400, 500, 800, and 900 (FIGS. 4, 5, 8, and 9).

In some embodiments, API 176 defines a first API call response that can be provided to an application by API calling instructions 174, wherein the first API call response includes parameters described above with respect to processes 400, 500, 800, and 900 (FIGS. 4, 5, 8, and 9).

In some embodiments, the set of implementation instructions is a system software module (e.g., a collection of computer-readable instructions) that is constructed to perform an operation in response to receiving an API call via the API. In some embodiments, the set of implementation instructions is constructed to provide an API response (via the API) as a result of processing an API call.

In some embodiments, the set of implementation instructions is included in the device (e.g., 168) that runs the application. In some embodiments, the set of implementation instructions is included in an electronic device that is separate from the device that runs the application.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the techniques and their practical applications. Others skilled in the art are thereby enabled to best utilize the techniques and various examples with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

In some embodiments, content is automatically generated by one or more computer systems in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly, a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example, when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other embodiments, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some embodiments, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

As described above, one aspect of the present technology is the gathering and use of data available from various sources to improve how a device alters the output of audio content. The present disclosure contemplates that in some instances, this gathered data can include personal information data that uniquely identifies or can be used to locate a specific person. Such personal information data can include demographic data, location-based data, telephone numbers, email addresses, home addresses, or any other identifying information.

The present disclosure recognizes that the use of such personal information data, in the present technology, can be used to the benefit of users. For example, the personal information data can be used to determine how a device alters the output of audio content. Accordingly, use of such personal information data enables better user experiences. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of image capture, the present technology can be configured to allow users to select to “opt in” or “opt out” of participation in the collection of personal information data during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, audio content can be altered by inferring location based on non-personal information data or a bare minimum amount of personal information, such as the playback of audio content being initiated by the device associated with a user or other non-personal information.

What is claimed is:

1. A method, comprising:
at a resident device:
receiving, from a respective device, an input corresponding to a request to initiate playback of audio content; and
in response to receiving the input corresponding to the request to initiate playback of the audio content:
in accordance with a determination that a first set of one or more criteria is satisfied, wherein the first set of one or more criteria includes a criterion that is satisfied when the respective device is a first device, outputting, via multiple output devices, the audio content in a first manner; and
in accordance with a determination that a second set of one or more criteria is satisfied, wherein the second set of one or more criteria includes a criterion that is satisfied when the respective device is a second device, outputting, via the multiple output devices, the audio content in a second manner different from the first manner, wherein the second device is different from the first device, and wherein the second set of one or more criteria is different from the first set of one or more criteria.

2. The method of claim 1, further comprising:
before receiving the input corresponding to the request to initiate playback of the audio content, receiving, from the multiple output devices, visual media;
after receiving the visual media, identifying, based on the visual media, a respective locality corresponding to the multiple output devices, wherein the first set of one or more criteria includes a criterion that is satisfied based on the respective locality corresponding to the multiple output devices; and
in response to receiving the input corresponding to the request to initiate playback of the audio content:
in accordance with a determination that a third set of one or more criteria is satisfied, wherein the third set of one or more criteria includes a criterion that is satisfied when the respective locality corresponding to the multiple output devices is a first locality, outputting, via the multiple output devices, the audio content in a third manner different from the first manner; and
in accordance with a determination that a fourth set of one or more criteria is satisfied, wherein the fourth set of one or more criteria includes a criterion that is satisfied when the respective locality corresponding to the multiple output devices is a second locality, outputting, via the multiple output devices, the audio content in a fourth manner different from the third manner, wherein the third set of one or more criteria is different from the fourth set of one or more criteria, and wherein the second locality is different from the first locality.

3. The method of claim 2, further comprising:
before receiving the input corresponding to the request to initiate playback of the audio content, receiving, from the multiple output devices, audio media, wherein the third set of one or more criteria includes a criterion that is satisfied when the audio media aligns with a first audio pattern, and wherein the fourth set of one or more criteria includes a criterion that is satisfied when the audio media aligns with a second audio pattern different from the first audio pattern.

4. The method of claim 1, further comprising:
in response to receiving the input corresponding to the request to initiate playback of the audio content:
in accordance with a determination that a fifth set of one or more criteria is satisfied, wherein the fifth set of one or more criteria includes a criterion that is satisfied when a respective locality of the respective device within an area is a first locality, outputting, via the multiple output devices, the audio content in a fifth manner different from the first manner; and
in accordance with a determination that a sixth set of one or more criteria is satisfied, wherein the sixth set of one or more criteria includes a criterion that is satisfied when the respective locality of the respective device within the area is a second locality, outputting, via the multiple output devices, the audio content in a sixth manner different from the fifth manner, wherein the fifth set of one or more criteria is different from the sixth set of one or more criteria, and wherein the second locality is different from the first locality.

5. The method of claim 4, wherein the respective locality of the respective device within the area is the first locality when a relationship between the respective device and the multiple output devices aligns with a first relationship, and wherein the respective locality of the respective device within the area is the second locality when the relationship between the respective device and the multiple output devices aligns with a second relationship different from the first relationship.

6. The method of claim 1, further comprising:
in response to receiving the input corresponding to the request to initiate playback of the audio content:
in accordance with a determination that a seventh set of one or more criteria is satisfied, wherein the seventh set of one or more criteria includes a criterion that is satisfied when a respective locality of the resident device is a first locality, outputting, via the multiple output devices, the audio content in a seventh manner different from the first manner; and
in accordance with a determination that an eighth set of one or more criteria is satisfied, wherein the eight set of one or more criteria includes a criterion that is satisfied when the respective locality of the resident device is a second locality, outputting via the multiple output devices, the audio content in an eight manner different from the seventh manner, wherein the seventh set of one or more criteria is different from the eighth set of one or more criteria, and wherein the second locality is different from the first locality.

7. The method of claim 1, further comprising:
in response to receiving the input corresponding to the request to initiate playback of the audio content:
in accordance with a determination that a ninth set of one or more criteria is satisfied, wherein the ninth set of one or more criteria includes a criterion that is satisfied when a total number of devices within an area is greater than a threshold number of devices, outputting, via the multiple output devices, the audio content in a ninth manner different from the first manner; and
in accordance with a determination that an tenth set of one or more criteria is satisfied, wherein the tenth set of one or more criteria includes a criterion that is satisfied when the total number of devices within the area is less than the threshold number of devices, outputting via the multiple output devices, the audio content in an tenth manner different from the ninth manner, wherein the ninth set of one or more criteria is different from the tenth set of one or more criteria.

8. The method of claim 1, further comprising:
in response to receiving the input corresponding to the request to initiate playback of the audio content:
in accordance with a determination that an eleventh set of one or more criteria is satisfied, wherein the eleventh set of one or more criteria includes a criterion that is satisfied when the respective device is a first type of device, outputting, via the multiple output devices, the audio content in an eleventh manner different from the first manner; and
in accordance with a determination that a twelfth set of one or more criteria is satisfied, wherein the twelfth set of one or more criteria includes a criterion that is satisfied when the respective device is a second type of device, outputting via the multiple output devices, the audio content in an twelfth manner different from the eleventh manner, wherein the eleventh set of one or more criteria is different from the twelfth set of one or more criteria, and wherein the second type of device is different from the first type of device.

9. The method of claim 1, further comprising:
in response to receiving the input corresponding to the request to initiate playback of the audio content:
in accordance with a determination that a thirteenth set of one or more criteria is satisfied, wherein the thirteenth set of one or more criteria includes a criterion that is satisfied when the audio content is a first type of content, outputting, via the multiple output devices, the audio content in a thirteenth manner different from the first manner; and
in accordance with a determination that a fourteenth set of one or more criteria is satisfied, wherein the fourteenth set of one or more criteria includes a criterion that is satisfied when the audio content is a second type of content, outputting via the multiple output devices, the audio content in a fourteenth manner different from the thirteenth manner, wherein the thirteenth set of one or more criteria is different from the fourteenth set of one or more criteria, and wherein the second type of content is different from the first type of content.

10. The method of claim 1, wherein outputting the audio content in the first manner includes separating the audio content into a first audio channel and a second audio channel separate from the first audio channel.

11. The method of claim 1, wherein the multiple output devices are configured as a multi-channel audio system, and wherein outputting the audio content in the first manner includes:
sending a first audio channel to a first audio device of the multiple output devices; and
sending a second audio channel to a second audio device of the multiple output devices, wherein the second audio channel is separate from the first audio channel, and wherein the second audio device is separate from the first audio device.

12. The method of claim 11, wherein the first audio channel is a left audio channel, and wherein the second audio channel is a right audio channel.

13. The method of claim 11, wherein the first audio channel is a first surround channel, and wherein the second audio channel is a second surround channel separate from the first surround channel.

14. The method of claim 11, wherein the first audio channel includes a first configuration, wherein the second audio channel includes a second configuration different from the first configuration, and wherein the second configuration includes different levels of audio frequencies along an audio spectrum than the first configuration.

15. The method of claim 1, wherein the multiple output devices include the resident device.

16. The method of claim 1, wherein the multiple output devices are external to the resident device.

17. The method of claim 1, further comprising:
after outputting the audio content in the first manner, detecting that the respective device has moved from a first position to a second position, wherein the second position is different from the first position; and
in response to detecting that the respective device has moved from the first position to the second position, adjusting, via the multiple output devices, the output of the audio content.

18. The method of claim 1, further comprising:
after outputting the audio content in the first manner, detecting that an output device of the multiple output devices has moved from a third position to a fourth position, wherein the third position is different from the fourth position; and
in response to detecting that the respective device has moved from the third position to the fourth position:
in accordance with a determination that the output device is a first device of the multiple output devices, outputting, via the multiple output devices, the audio content in a fifteenth manner different from the first manner; and
in accordance with a determination that the output device is a second device of the multiple output devices, outputting, via the multiple output devices, the audio content in a sixteenth manner, wherein the second device is separate from the first device, and wherein the sixteenth manner is different from the fifteenth manner and the first manner.

19. The method of claim 1, further comprising:
after outputting the audio content in the first manner, detecting an input corresponding to a request to alter the playback of the audio content; and
in response to detecting the input corresponding to the request to alter the playback of the audio content, adjusting, via the multiple output devices, the output of the audio content.

20. The method of claim 1, further comprising:
while outputting the audio content in the second manner, detecting an audio characteristic of the audio content:
in response to detecting the audio characteristic of the audio content:
in accordance with a determination that the audio characteristic satisfies a fifteenth set of one or more criteria, outputting, via the multiple output devices, the audio content in a seventeenth manner different from the second manner; and
in accordance with a determination that the audio characteristic satisfies a sixteenth set of one or more criteria, outputting, via the multiple output devices, the audio content in an eighteenth manner different from the seventeenth manner, wherein the sixteenth set of one or more criteria is different from the fifteenth set of one or more criteria.

21. A non-transitory computer-readable storage medium storing one or more programs configured to be executed by one or more processors of a resident device, the one or more programs including instructions for:
receiving, from a respective device, an input corresponding to a request to initiate playback of audio content; and
in response to receiving the input corresponding to the request to initiate playback of the audio content:
in accordance with a determination that a first set of one or more criteria is satisfied, wherein the first set of one or more criteria includes a criterion that is satisfied when the respective device is a first device, outputting, via multiple output devices, the audio content in a first manner; and
in accordance with a determination that a second set of one or more criteria is satisfied, wherein the second set of one or more criteria includes a criterion that is satisfied when the respective device is a second device, outputting, via the multiple output devices, the audio content in a second manner different from the first manner, wherein the second device is different from the first device, and wherein the second set of one or more criteria is different from the first set of one or more criteria.

22. A resident device, comprising:
one or more processors; and
memory storing one or more programs configured to be executed by the one or more processors, the one or more programs including instructions for:
receiving, from a respective device, an input corresponding to a request to initiate playback of audio content; and
in response to receiving the input corresponding to the request to initiate playback of the audio content:
in accordance with a determination that a first set of one or more criteria is satisfied, wherein the first set of one or more criteria includes a criterion that is satisfied when the respective device is a first device, outputting, via multiple output devices, the audio content in a first manner; and
in accordance with a determination that a second set of one or more criteria is satisfied, wherein the second set of one or more criteria includes a criterion that is satisfied when the respective device is a second device, outputting, via the multiple output devices, the audio content in a second manner different from the first manner, wherein the second device is different from the first device, and wherein the second set of one or more criteria is different from the first set of one or more criteria.
